(19) United States
(12) Patent Application Publication
(10) Pub. No.: US 2004/0168100 A1
(43) Pub. Date: Aug. 26, 2004

(54) Fault detection and prediction for management of computer networks

(76) Inventors: Marina K. Thottan, Troy, NY (US); Chuanyi Ji, Troy, NY (US)

Correspondence Address: Dickstein Shapiro, Morin & Oshinsky, 2101 L Street NW, Washington, DC, 20037-1526, US

(21) Appl. No.: 10/433,459

(22) PCT Filed: Dec. 4, 2001
(86) PCT No.: PCT/US01/45378

(30) Foreign Application Priority Data
Dec. 4, 2000 (US) 60250478

(51) Int. Cl. H04L 1/22

(52) U.S. Cl. 714/4

(57) ABSTRACT

An improved system and method for network fault and anomaly detection is provided based on the statistical behavior of the management information base (MIB) variables. The statistical and temporal information at the variable level is obtained from the sensors associated with the MIB variables. Each sensor performs sequential hypothesis testing based on the Generalized Likelihood Ratio (GLR) test. The ouputs of the individual sensors are combined using a fusion center, which incorporates the interdependencies of the MIB variables. The fusion center provides temporally correlated alarms that are indicative of network problems. The detection scheme relies on traffic measurement and is independent of specific fault descriptions.

### BACKGROUND OF THE INVENTION

1. Field of the Invention

The present invention relates generally to the field of network management. More specifically, this invention relates to a system for network fault detection and prediction utilizing statistical behavior of Management Information Base (MIB) variables.

2. Description of Prior Art

Prediction of network faults, anomalies and performance degradation form an important component of network management. This feature is essential to provide a reliable network along with real-time quality of service (QoS) guarantees. The advent of real-time services on the network creates a need for continuous monitoring and prediction of network performance and reliability. Although faults are rare events, when they do occur, they can have enormous consequences. Yet the rareness of network faults makes their study difficult. Performance problems occur more often and in some cases may be considered as indicators of an impending fault. Efficient handling of these performance issues may help eliminate the occurrence of severe faults.

Most of the work done in the area of network fault detection can be classified under the general area of alarm correlation. Several approaches have been used to model alarm sequences that occur during and before fault events. The goal behind alarm correlation is to obtain fault identification and diagnosis. The sequence of alarms obtained from the different points in the network are modeled as the states of a finite state machine. The transitions between the states are measured using prior events. The difficulty encountered in using this method is that not all faults can be captured by a finite sequence of alarms of reasonable length. This causes the number of states required to explore as a function of the number and complexity of faults modeled. Furthermore, the number of parameters to be learned increases, and these parameters may not remain constant as the network evolves. Accounting for this variability would require extensive off-line learning before the scheme can be deployed on the network. More importantly, there is an underlying assumption that the alarms obtained are true. No attempt is made to generate the individual alarms themselves.

Another method of generating alarms is the trouble ticketing system used by several of the commercial network management packages. A trouble ticket is a qualitative description of the symptoms of a fault or performance problem as perceived by a user or a network manager. In this method there is no guarantee of the accuracy of the temporal information. Also, the user may not be able to describe all aspects of the problem accurately enough to initiate appropriate recovery methods.

Syslog messages are also widely used as sources of alarms. However, these messages are difficult to comprehend and synthesize. There are also large volumes of syslog messages generated in any given network and they are often reactive to a network problem. This reactive nature precludes the use of these messages for predictive alarm generation.

Early work in the area of fault detection was based on expert systems. In expert systems an exhaustive database containing the rules of behavior of the faulty system is used to determine if a fault occurred. These rule-based systems rely heavily on the expertise of the network manager. The rules are dependent on prior knowledge about the fault conditions on the network and do not adapt well to the evolving network environment. Thus, it is possible that entirely new faults may escape detection. Furthermore, even for a stable network, there are no guarantees that an exhaustive database has been created.

In contrast, case-based reasoning is an extension of rule-based systems and it differs from detection based on expert systems in that, in addition to just rules, a picture of the previous fault scenarios is used to make the decisions. A picture in this sense refers to the circumstances or events that led to the fault. These descriptions of the fault cases also suffer from the heavy dependence on past information. In order to adapt the scheme to the changing network environment, adaptive learning techniques are used to obtain the functional dependence of relevant criteria such as network load, collision rate, etc, to previous trouble tickets available in the database. But using any functional approximation scheme, such as back propagation, causes an increase in computation time and complexity. The identification of relevant criteria for the different faults will in turn require a set of rules to be developed. The number of functions to be learned also increases with the number of faults studied.

Another method is the adaptive thresholding scheme which is the basis of most commercially available online network management tools. Thresholds are set to adapt to the changing behavior of network fault. These methods are primarily based on the second-order statistics (mean and variance) of the traffic. However, network traffic has been shown to have complex patterns and it is becoming increasingly clear that the second-order statistics alone may not be sufficient to capture the traffic behavior over long periods of time. These methods can, at best, detect only severe failures or performance issues such as a broken link or a significant loss of link capacity. Hence, using adaptive thresholding based on second-order statistics, the changes in traffic behavior that are indicative of impending network problems (e.g., file server crashes) cannot be detected, precluding the possibility of prediction. In adaptive thresholding, the challenge is to identify the optimal settings of the threshold in the presence of evolving network traffic whose characteristics are intrinsically heterogeneous and stochastic.

Further, there are some inherent difficulties encountered when working in the area of network fault detection. The evolving nature of IP networks, both in terms of the size and also the variety of network components and services, makes it difficult to fully understand the dynamics of the traffic on the network. Network traffic itself has been shown to be composed of complex patterns. Vast amounts of information need to be collected, processed, and synthesized to provide a meaningful understanding of the different network functions. These problems make it hard for a human system administrator to manage and understand all of the tasks that go into the smooth operation of the network. The skills learned from any one network may prove insufficient in managing a different network thus making it difficult to generalize the knowledge gained from any given network.

As described above, one of the common shortcomings of the existing fault detection schemes is that the identification of faults depends upon symptoms that are specific to a particular manifestation of a fault. Examples of these symptoms are excessive utilization of bandwidth, number of open TCP connections, total throughput exceeded, etc. Further, there are no accurate statistical models for normal network traffic and this makes it difficult to characterize the statistical behavior of abnormal traffic patterns. Also, there is no single variable or metric that captures all aspects of network function. This also presents the problem of synthesizing information from metrics with widely differing statistical properties. Also, one of the major constraints on the development of network fault detection algorithms is the need to maintain a low computational complexity to facilitate online implementation. Hence, what is needed is a system which is independent of such symptom-specific information, and wherein faults are modeled in terms of the changes they effect on the statistical properties of network traffic. Further, what is needed is a system which is easily implemented.

### SUMMARY OF THE INVENTION

The present invention provides an improved method and system for generation of temporally correlated alarms to detect network problems, based solely on the statistical properties of the network traffic. The system generates alarms independent of subjective criteria which are useful only in predicting specific network fault events. The system monitors abrupt changes in the normal traffic to provide potential indicators of faults. The present system overcomes the requirement of accurate models for normal traffic data and instead focuses on possible fault models.

The system provides a theoretical frame-work for the problem of network fault prediction through aggregate network traffic measurements in the form of the Management Information Base (MIB) variables. The statistical changes in the MIB variables that precede the occurrence of a fault are characterized and used to design an algorithm to achieve real-time prediction of network performance problems. A subset of the 171 MIB variables is first identified as relevant for prediction purposes. This step reduces the dimensionality and the complexity of the algorithm. The relevant MIB variables are processed to provide variable-level abnormality indicators (which indicate abrupt change points in the traffic measured by the variable). The algorithm accounts for the spatial relationships between the input MIB variables using a fusion center. The algorithm is successfully implemented on data obtained from two production networks that differ from each other significantly with respect to their size and their nature of traffic. The alarms obtained using the system are predictive with respect to the existing management schemes. The prediction time is sufficiently long to initiate potential recovery mechanisms for an automated network management system.

### BRIEF DESCRIPTION OF THE DRAWINGS

The foregoing and other advantages and features of the invention will become more apparent from the detailed description of preferred embodiments of the invention given below with reference to the accompanying drawings in which:

FIG. 1 depicts a distributed processing scheme for a Wide Area Network;

FIG. 1a depicts the components of the intelligent agent processing of the present invention;

FIG. 2 depicts a typical raw MIB variable implemented as a counter;

FIG. 3 depicts a time series data obtained by differencing the MIB counter data;

FIG. 4 depicts Case Diagrams for the MIB variables at the if and the ip layers;

FIG. 5 depicts a key to understand the Case Diagram;

FIG. 6 depicts a use of Case Diagrams to capture relationships between MIB variables;

FIG. 7 depicts a simplified Case Diagram showing the 5 chosen MIB variables;

FIG. 8 depicts a time series data for ifInOctets at 15 sec polling;

FIG. 9 depicts a time series data for ifOutOctets at 15 sec polling;

FIG. 10 depicts a time series data for ipInReceives at 15 sec polling;

FIG. 11 depicts a time series data for ipInDelivers at 15 sec polling;

FIG. 12 depicts a time series data for ipOutRequests at 15 sec polling;

FIG. 13 depicts a scatter plot of inInOctets and inOutOctets showing high degree of scatter;

FIG. 14 depicts a scatter plot of IpInReceives and ipInDelivers showing very low correlation;

FIG. 15 depicts a scatter plot of ipInReceives and ipOutRequests showing very low correlation;

FIG. 16 depicts a scatter plot of ipInDelivers and ipOutRequests showing stronger correlation only at large increments;

FIG. 17 depicts a local distributed processing at the router;

FIG. 18 depicts a trace of ifIO before fault;

FIG. 19 depicts a trace of ifOO before fault;

FIG. 20 depicts a trace of ipIR before fault;

FIG. 21 depicts a trace of ipIDe before fault;

FIG. 22 depicts a trace of ipOR before fault;

FIG. 23 depicts correlated abrupt changes observed in the ip Level MIB Variables;

FIG. 24 depicts an auto-correlation of ipIO showing hyperbolic decay;

FIG. 25 depicts an auto-correlation of ifOO showing hyperbolic decay;

FIG. 26 depicts an auto-correlation of ipIR showing hyperbolic decay;

FIG. 27 depicts an auto-correlation of ipIDe showing hyperbolic decay;

FIG. 28 depicts an auto-correlation of ipOR showing exponential decay;

FIG. 29 depicts an agent processing;

FIG. 30 depicts an alarm declaration at the fusion center;

FIG. 31 depicts a trace of if and ip variables around fault period denoted by asterisks;

FIG. 32 depicts a trace of if and ip variables around fault period denoted by asterisks;

FIG. 33 depicts histograms of the differenced MIB data;

FIG. 34 depicts a scheme for online learning showing sequential positions of the learning and test windows;

FIG. 35 depicts contiguous piecewise stationary windows, L(t): Learning Window, S(t): Test Window;

FIG. 36 depicts an agent processing;

FIG. 37 depicts an auto-correlation of residuals of MIB data: ifIO, ipOO, ipIR, ipIDe, ipOR;

FIG. 38 depicts a Quantile—Quantile Plot of ifIO Residuals;

FIG. 39 depicts a Quantile—Quantile Plot of ifOO Residuals;

FIG. 40 depicts a Quantile—Quantile Plot of ipIR Residuals;

FIG. 41 depicts a Quantile—Quantile Plot of ipIDe Residuals;

FIG. 42 depicts a Quantile—Quantile Plot of ipOR Residuals;

FIG. 43 depicts a detection of abrupt changes in the ifIO variable at the sensor level;

FIG. 44 depicts a detection of abrupt changes in the ifOO Variable at the sensor level;

FIG. 45 depicts a detection of abrupt changes in the ifIR variable at the sensor level;

FIG. 46 depicts a detection of abrupt changes in the ifIDe variable at the sensor level;

FIG. 47 depicts a detection of abrupt changes in the ifOR variable at the sensor level;

FIG. 48 depicts a Campus Network;

FIG. 49 depicts a Fusion Center to incorporate dependencies between variable level-indicators;

FIG. 50 depicts a transitions of abrupt changes between MIB variables;

FIG. 51 depicts a fault vector and the problem domain for the ip agent;

FIG. 52 depicts an average abnormality indicators for the ip layer;

FIG. 53 depicts a fault vectors and problem domain for the if agent;

FIG. 54 depicts an average abnormality indicator for the if layer;

FIG. 55 depicts a persistence of abnormality;

FIG. 56 depicts a lack of persistence in normal situations;

FIG. 57 depicts an experimental network;

FIG. 58 depicts a summary of analytical results for CPU utilization;

FIG. 59 depicts a summary of experimental results for CPU utilization;

FIG. 60 depicts a CPU utilization;

FIG. 61 depicts a summary of results for theoretical values of network utilization;

FIG. 62 depicts a configuration of the monitored campus network;

FIG. 63 depicts a configuration of the monitored enterprise network;

FIG. 64 depicts an average abnormality at the router;

FIG. 65 depicts an abnormality indicator of ipIR;

FIG. 66 depicts an abnormality indicator of ipIDe;

FIG. 67 depicts an abnormality indicator of ipOR;

FIG. 68 depicts an abnormality at Subnet;

FIG. 69 depicts an abnormality of ifIO;

FIG. 70 depicts an abnormality of ifOO;

FIG. 71 depicts an average abnormality at the router;

FIG. 72 depicts an abnormality indicator of ipIR;

FIG. 73 depicts an abnormality indicator of ipIDe;

FIG. 74 depicts an abnormality indicator of ipOR

FIG. 75 depicts an average abnormality at subnet;

FIG. 76 depicts an abnormality indicator of ifIO;

FIG. 77 depicts an abnormality indicator of ifOO;

FIG. 78 depicts an average abnormality at the router;

FIG. 79 depicts an abnormality indicator of ipIR;

FIG. 80 depicts an abnormality indicator of ipIDe;

FIG. 81 depicts an abnormality indicator of ipOR;

FIG. 82 depicts an average abnormality at subnet;

FIG. 83 depicts an abnormality indicator of ifIO;

FIG. 84 depicts an abnormality indicator of ifOO;

FIG. 85 depicts an average abnormality at the router;

FIG. 86 depicts an abnormality indicator of ipIR;

FIG. 87 depicts an abnormality indicator of ipIDe;

FIG. 88 depicts an abnormality indicator of ipOR;

FIG. 89 depicts an average abnormality at subnet;

FIG. 90 depicts an abnormality indicator of ifIO;

FIG. 91 depicts an abnormality indicator of ifOO;

FIG. 92 depicts a quantities used in performance analysis;

FIG. 93 depicts the prediction and detection of file server failures at the internal router with τ=3;

FIG. 94 depicts the prediction and detection of file server failures at the interface of subnet 2 with the internal router with τ=3;

FIG. 95 depicts the prediction and detection of file server failures at the router with τ=3103;

FIG. 96 depicts the prediction and detection of file server failures at subnet 26, with τ=3104;

FIG. 97 depicts the prediction and detection of network access problems at the router with τ=3;d

FIG. 98 depicts the prediction and detection of network access problems at subnet 26 with τ=3;

FIG. 99 depicts the prediction and detection of protocol implementation error at subnet 21 and router with τ=3;

FIG. 100 depicts the prediction and detection of a runaway process at subnet 26 and router with τ=3;

FIG. 101 depicts a flow chart for implementation of the algorithm; and

FIG. 102 depicts a classification of network faults.

### DETAILED DESCRIPTION OF PREFERRED EMBODIMENTS

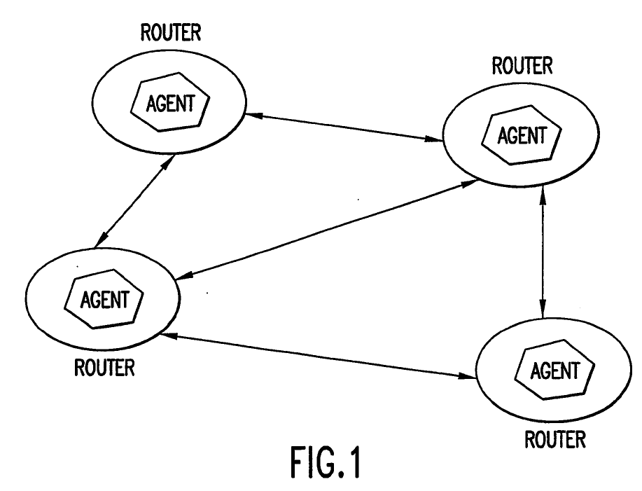

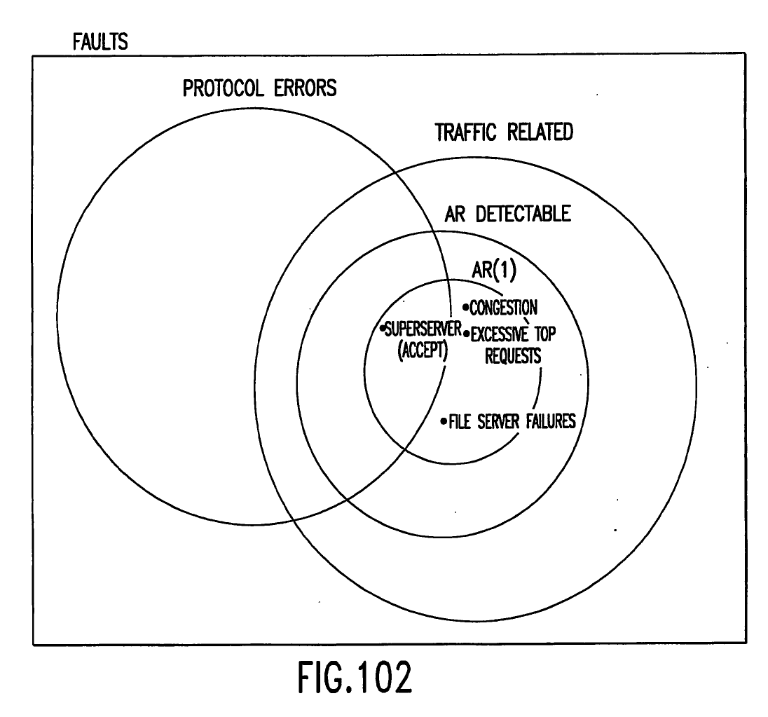

The present invention will be described in connection with exemplary embodiments illustrated in FIGS. 1-102. Other embodiments may be realized and other changes may be made to the disclosed embodiments without departing from the spirit or scope of the present invention.

System Level Design

A frame-work in which fault and performance problem detection can be performed is provided. The selection criteria used to determine the relevant management protocol and the variables useful for the prediction of traffic-related network faults is discussed. The implementation of the approach developed is also presented.

Frame-Work for Fault and Performance Problem Detection

The primary concerns of real-time fault detection is scalability to multiple nodes 5. The scalability of the management scheme can be addressed by local processing at the nodes 5. Agents 3 are developed that are amenable to distributed implementation. The agents 3 use local information to generate temporally correlated alarms about abnormalities perceived at the different network nodes 5. For example, as shown in FIG. 1, a system 100 for a distributed processing scheme is provided. The information available at the router 1 is the aggregate of the information from all the subnets connected to that router 1. The router 1, which is a network-layer device, processes the ip layer information which is a multiplexing of traffic from all of the interfaces. Therefore, the output parameter of the agents implemented at the router provides the local view of network health. Thus, local processing at the nodes, only processed information is passed on by each device as opposed to the raw data. The alarms obtained at these individual components can then be correlated by using standard alarm correlation techniques. The system provides an intelligent agent at the level of the network node.

Referring now to FIG. 1b, the components of the intelligent agent processing are described. The data processing unit 29 acquires MIB data 9. The change detector or sensor 33 produces a series of alarms 35 corresponding to change points observed in each individual MIB variables based upon processed data 31. These variable-level alarms 35 are candidate points for fault occurrences. In the fusion center 13, the variable-level alarms 35 are combined using a priori information about the relationships between these MIB variables 9. Time correlated alarms 37 corresponding to the anomalies were obtained as the output of the fusion center. These alarms 37 are indicative of the health of the network and help in the decisions made by the network components such as routers, thus making it possible to provides better QoS guarantees.

Since the intelligent agent uses statistical signal processing methods to obtain alarms, it is independent of the specific manifestation of the anomalies. This method therefore encompasses a larger subset of anomalies and is independent of the specific scenario that caused them.

Choice of Management Protocol

The network management discipline has several protocols in place which provide information about the traffic on the network. One of these protocols is selected as the data collection tool in order to study network traffic. The criteria used in the selection of the protocol is that the protocol support variables which correspond to traffic statistics at the device level. An exemplary management protocol is the Simple Network Management Protocol (SNMP).

Simple Network Management Protocol—SNMP

The SNMP works in a client-server paradigm. The SNMP manager is the client and the SNMP agent providing the data is the server. The protocol provides a mechanism to communicate between the manager and the agent. Very simple commands are used within SNMP to set, fetch, or reset values. A single SNMP manager can monitor hundreds of SNMP agents. SNMP is implemented at the application layer and runs over the User Datagram Protocol (UDP). The SNMP manager has the ability to collect management data that is provided by the SNMP agent, but does not have the ability to process this data. The SNMP server maintains a database of management variables called the Management Information Base (MIB) variables. The MIB variables are arranged in a tree structure following a structuring convention called the Structure of Management Information (SMI) and contains different variable types such as string, octet, and integer. These variables contain information pertaining to the different functions performed at the different layers by the different devices on the network. Every network device has a set of MIB variables that are specific to its functionality. The MIB variables are defined based on the type of device and also on the protocol level at which it operates. For example, bridges which are data link-layer devices contain variables that measure link-level traffic information. Routers which are network-layer devices contain variables that provide network-layer information. The advantage of using SNMP is that it is a widely deployed protocol and has been standardized for all different network devices. The MIB variables are easily accessible and provide traffic information at the different layers.

Choice of Management Variables

The SNMP protocol maintains a set of counters known as the Management Information Base (MIB) variables. A subset of these variables is chosen to aid in the detection of traffic-related faults. The variables were chosen based on their ability to capture the traffic flow into and out of the device. This process can be performed by a central processing unit.

Management Information Base Variables

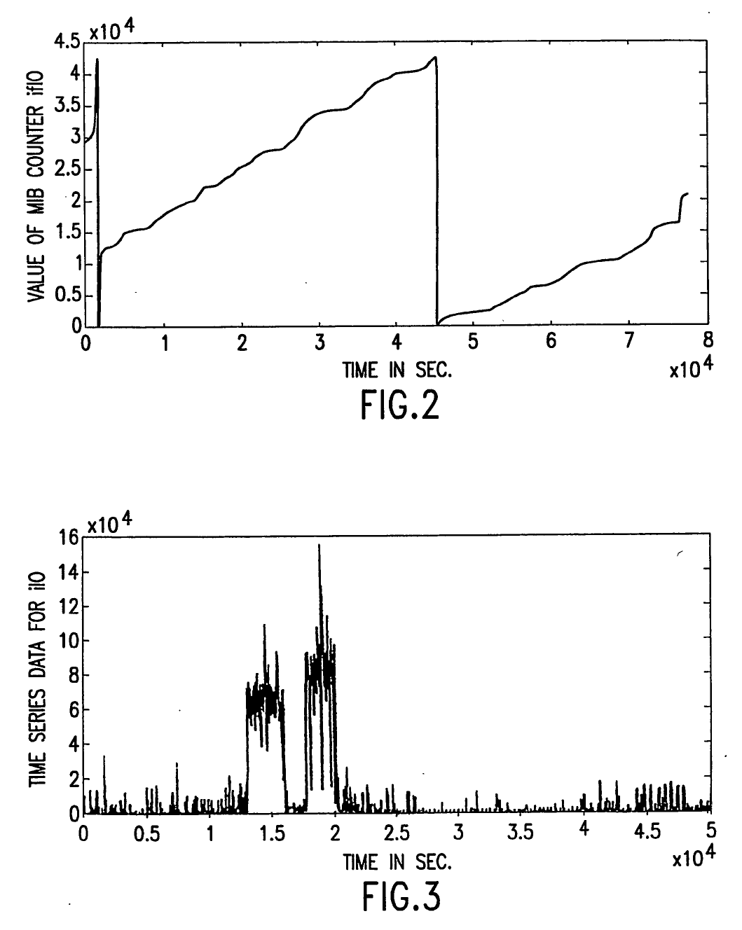

The Management Information Base maintains 171 variables which is maintained in the SNMP server. These variables fall into the following groups: System, Interfaces (if), Address Translation (at), Internet Protocol(ip), Internet Control Message Protocol (icmp), Transmission Control Protocol (tcp), User Datagram Protocol (udp), Exterior Gateway Protocol (egp), and Simple Network Management Protocol (snmp). Each group of variables describes the functionality of a specific protocol of the network device. Depending on the type of node monitored, an appropriate group of variables was considered. These variables are user defined. Here, the node being monitored is the router and therefore if and the ip group of variables are investigated. The if group of variables describe the traffic characteristics at a particular interface of the router and the ip variables describe the traffic characteristics at the network layer. The MIB variables are implemented as counters as shown in FIG. 2 (the counter resets at a value of 4294967295). The variables have to be further processed in order to obtain an indicator on the occurrence of network problems. Time series data for each MIB variable is obtained by differencing the MIB variables (the differenced data is illustrated in FIG. 3).

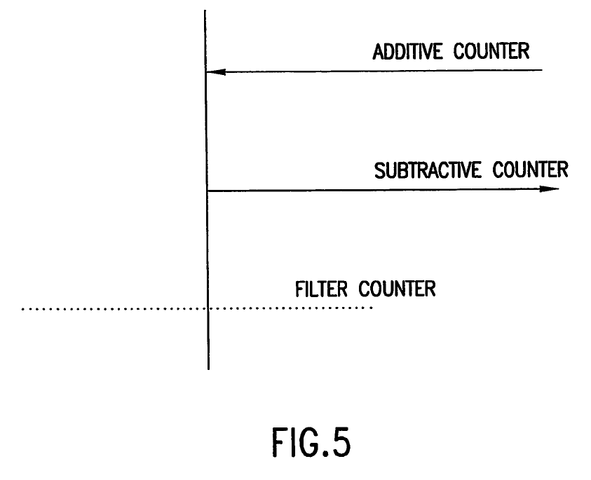

The relationships between the MIB variables of a particular protocol group can be represented using a Case Diagram. Case Diagrams are used to visualize the flow of management information in a protocol layer and thereby mark where the counters are incremented. The Case diagram for the if and ip variables flow between the lower and upper network layers. A key to the understanding of the Case Diagram is shown in FIG. 5. An additive counter counts the number of traffic units that enter into a specific protocol layer and a subtractive counter counts the number of traffic units that leave the protocol layer. The variables that are depicted in the Case Diagram by a dotted line are called filter counters. A filter counter is a MIB variable that measures the level of traffic at the input and at the output of each layer.

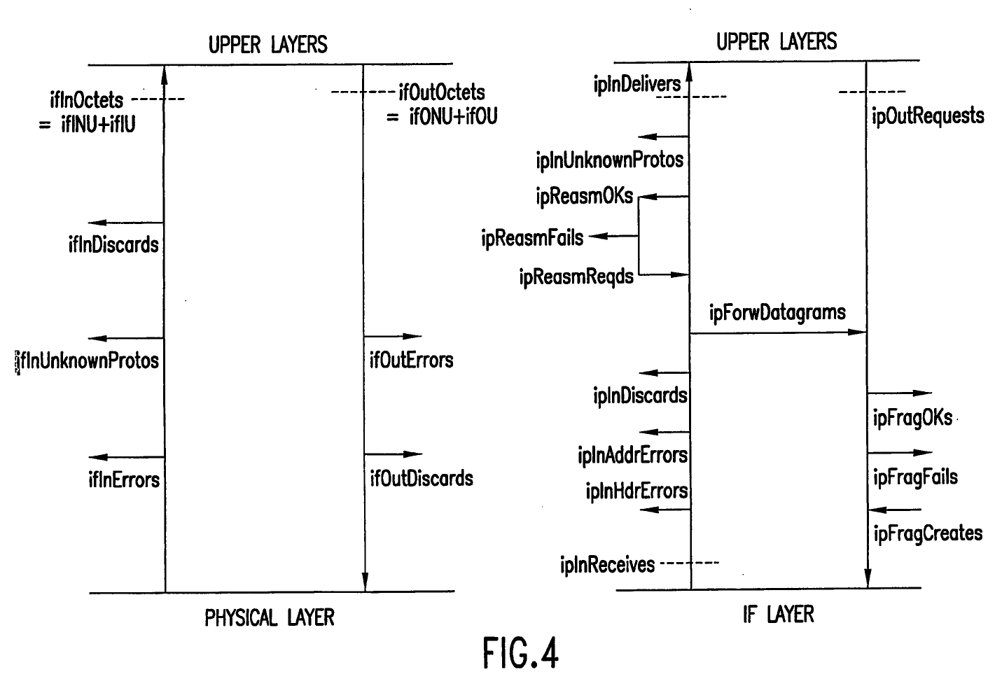

In FIG. 4 variables such as ifInDiscards and ifOutDiscards are subtractive counters while variables such as ipFragCreates are additive counters. A simple example to illustrate the use of these diagrams is the number of ip datagams that failed at reassembly (ipReasmFails) which is given by,

ipReasmFails=ipReasmReqds−ipReasmOks

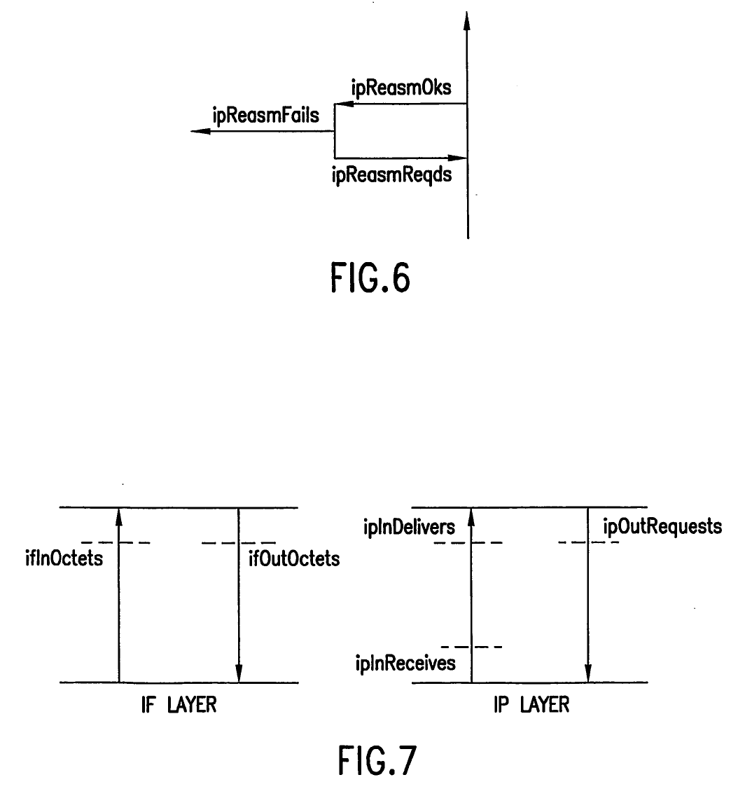

This relationship is represented in the Case Diagram and emphasized in FIG. 6.

Selection of a Relevant Set of MIB Variables

The choice of a relevant set of MIB variables that are relevant to the detection of traffic-related problems helps reduce the computational complexity by reducing the dimensionality of the problem. This step can be user defined. Within a particular MIB group there exists some redundancy. For example, the variables interface Out Unicast packets (ifOU), interface Out Non Unicast packets (ifONU) and interface Out Octets (ifOO). The ifOO variable contains the same traffic information as that obtained using both ifOU and ifONU.

In order to simplify the problem, such redundant variables are not considered. Some of the variables, by virtue of their standard definition, are not relevant to the detection of traffic-related faults, e.g., ifIndex (which is the interface number) is excluded. MIB variables that show specific protocol implementation information, such as fragmentation and reassembly errors, are also not included. For example, the variable ifIE (which represents the number of errored bytes that arrived at a particular interface) is not considered. In current networks such errors are corrected by the protocols themselves using retransmission schemes. Fault situations of interest (i.e., faults which arise due to increased traffic, transient failure of network devices, and software related problems) may not be reflected in these error variables.

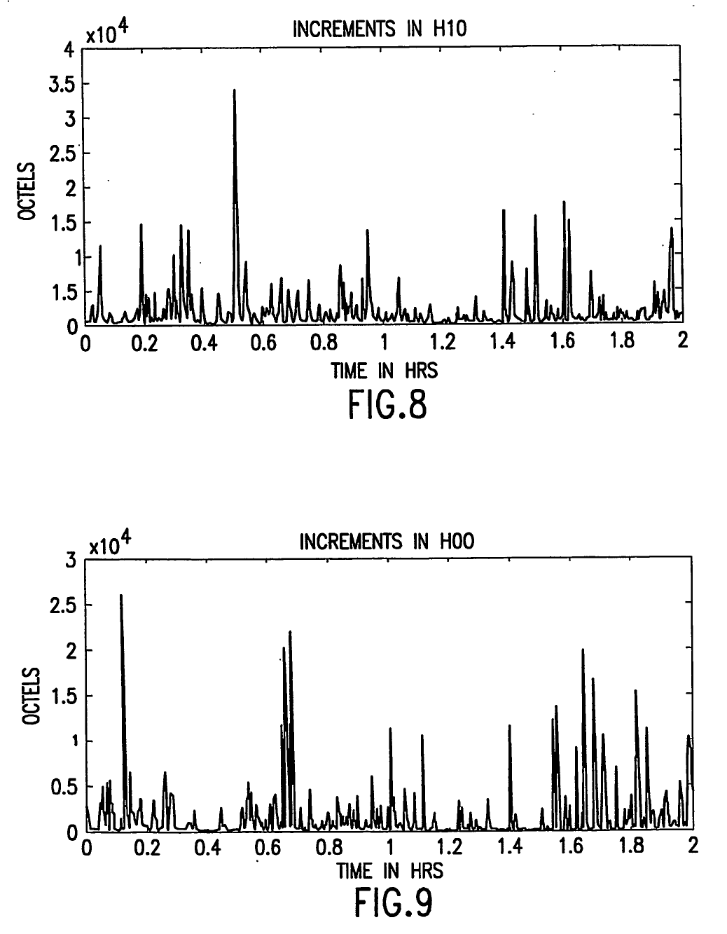

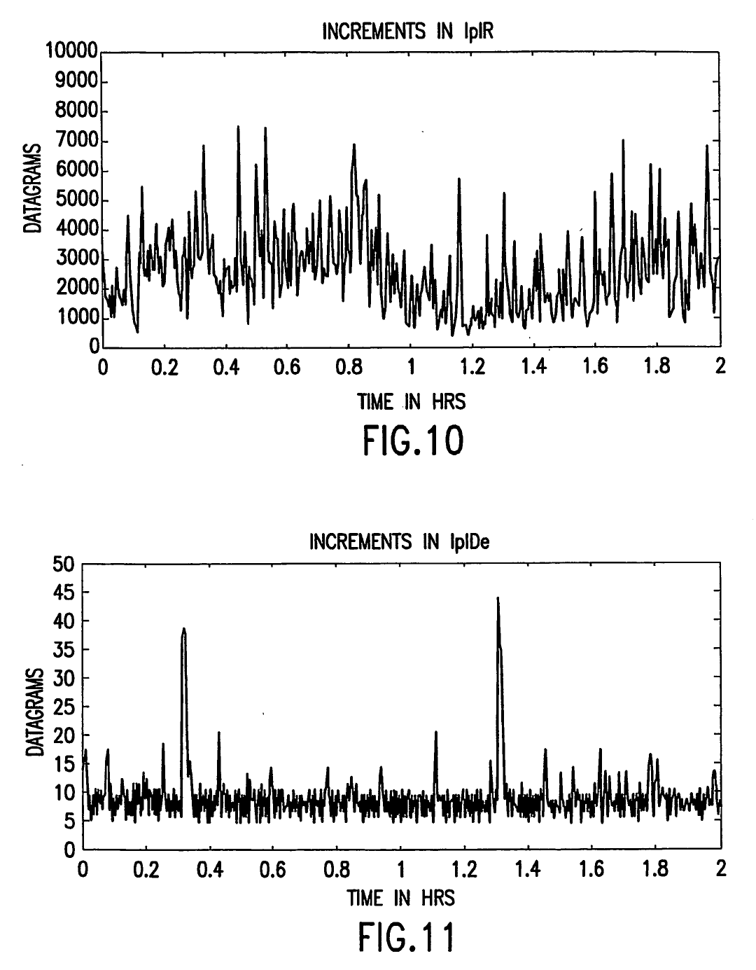

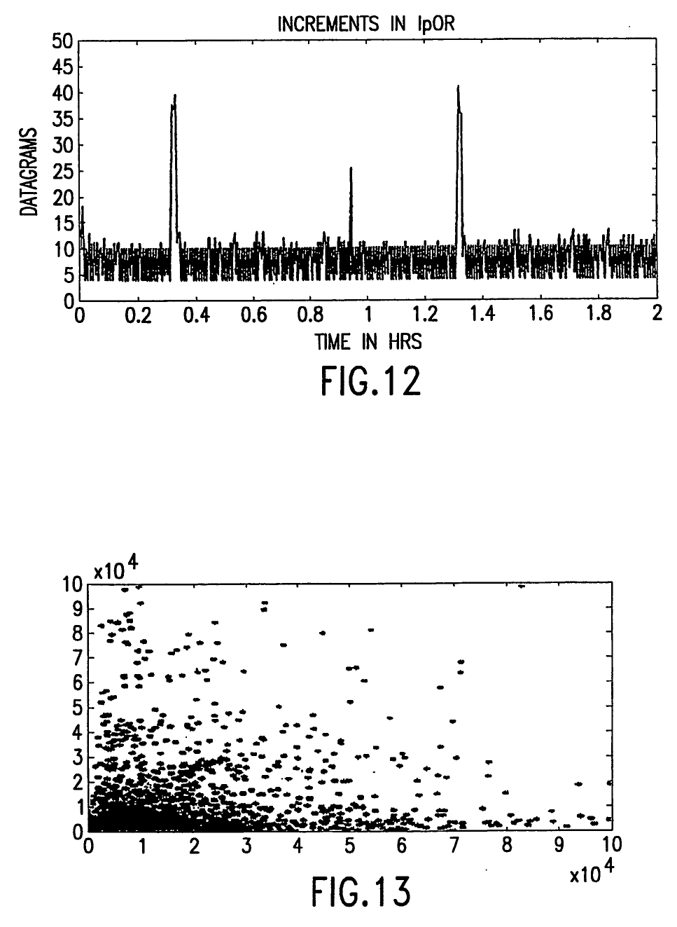

There is no single variable that is capable of capturing all network anomalies or all manifestations of the same network anomaly. Therefore, five MIB variables are selected. In the if layer, the variables ifIO (In Octets) and ifOO (Out Octets) are used to describe the characteristics of the traffic going into and out of that interface from the router. Similarly in the ip layer, three variables are used. The variable ipIR (In Receives), represents the total number of datagrams received from all interfaces of the router. IpIDe (In Delivers), represents the number of datagrams correctly delivered to the higher layers as this node was their final destination. IpOR (Out Requests), represents the number of datagrams passed on from the higher layers of the node to be forwarded by the ip layer. The ip variables sufficiently describe the functionality of the router. The ip layer variables help to isolate the problem to the finer granularity of the subnet level. The chosen variables are depicted in FIG. 7 by a dotted line. These variables are not redundant and represent cross sections of the traffic at different points in the protocol stack. They correspond to the filter counters in FIG. 4. Typical trace of each of these variables over a two hour period is shown in FIGS. 8 through 12. The if variables are obtained in terms of bytes or octets. These variables correspond to the traffic that goes into and out of an interface and therefore show bursty behavior. The traffic is measured by the sensor 33 of FIG. 1b. The ip level variables are obtained as datagrams. The ipIR variable measures the traffic that enters the network layer at a particular router and therefore shows bursty behavior. The ipIDe and ipOR variables are less bursty since they correspond to traffic that leaves or enters the network layer to or from the transport layer of the router. The traffic associated with these variables comprises only a fraction of the entire network traffic. However, in the case of fault detection these are relevant variables since the router does some processing of the routing tables in fault instances in order to update the routing metrics.

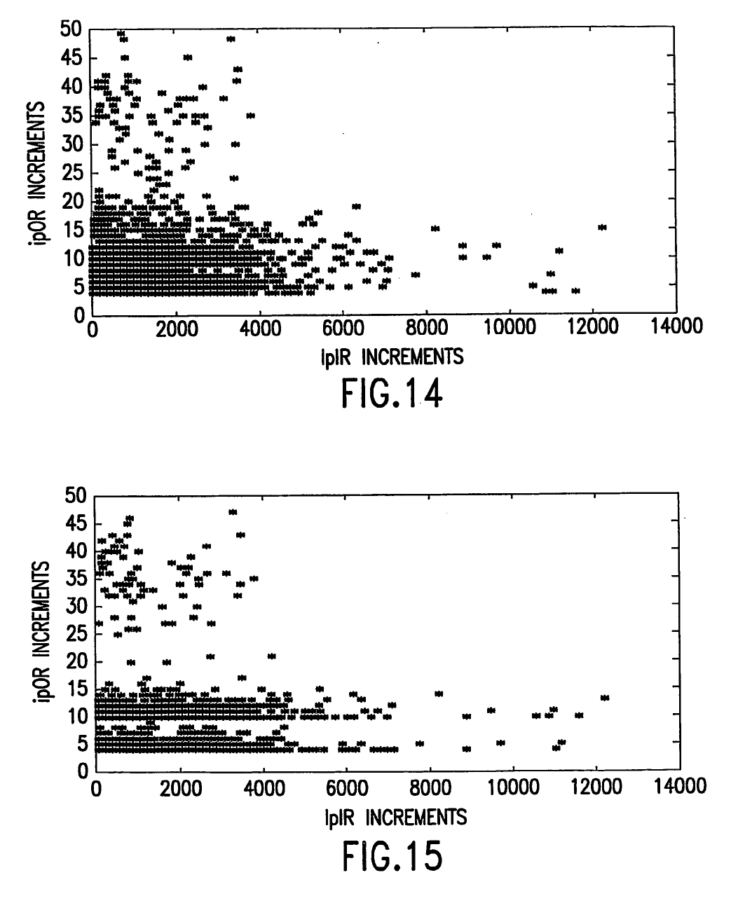

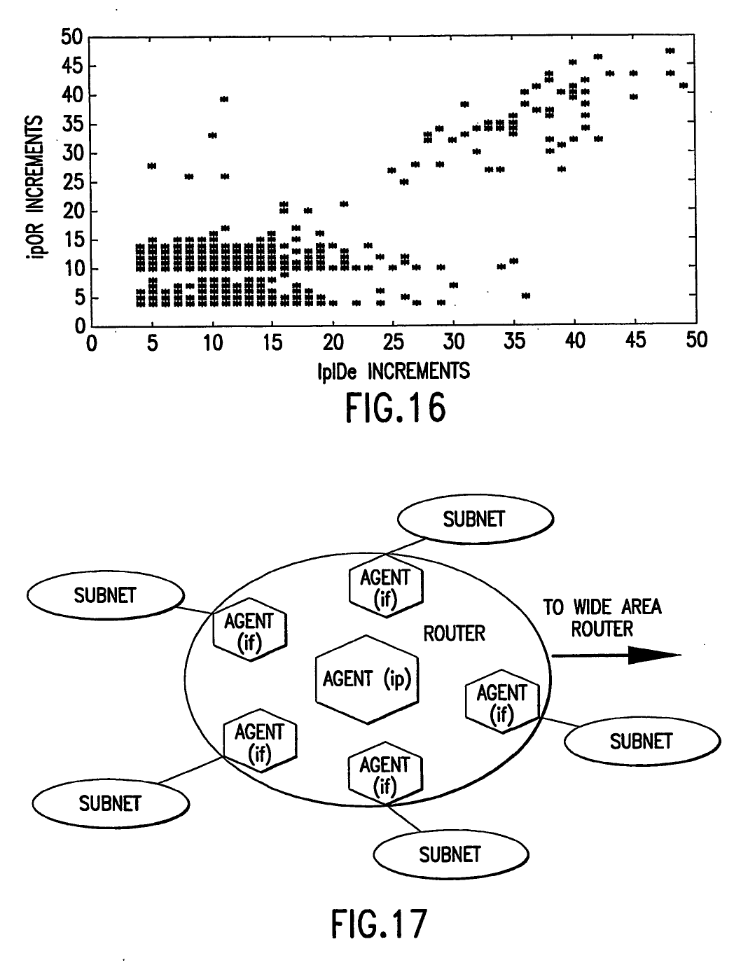

The five MIB variables chosen are not strictly independent. However, the relationships between these variables are not obvious. These relationships depend on parameters of the traffic such as source and destination of the packet, processing speed of the device, and the actual implementation of the protocol. The extent of relationships between the chosen variables is shown with the help of scatter plots in FIGS. 13 to 16. In FIG. 13 although the increments in the ifIO and the ifOO counters show some correlation, these correlations are very small as seen from the high degree of scatter. The average cross correlation between these two variables is 0.01. In FIGS. 14 and 15 the variables ipIDe and ipOR have no obvious relationship with ipIR. The average correlation of ipIR with ipIDe is 0.08 and with ipOR is 0.05. In FIG. 16 there is some significant correlation in the ipOR and ipIDe variables at large increments. The average cross correlation between ipOR and ipIDe is 0.32. The cross correlations are computed using normal data over a period of 4 hours.

One of the limitations in the choice of the specific MIB variables is that the isolation and diagnosis of the problem is restricted to the subnet level. Further isolation to the application level will require that additional MIB variables be included.

The Intelligent Agent and Implementation Scheme

Here, intelligent agents have been designed to perform the task of detecting network faults and performance degradations in real time. Intelligent agents are software entities that process the raw MIB data obtained from the devices to provide a real-time indicator of network health. These agents can be deployed in a distributed fashion across the different network nodes.

The agent 3 processing at each node 5 is separated into smaller units dealing with each specific protocol layer. In the case of the router 1, the interface layer information (ip) and the network (ip) layer information is processed independently (see FIG. 17, 3a, 3b). This separation of tasks allows the agent 3 to scale easily for any number of interfaces that a router 1 may have. The interface layer processing or the if agent yields an indicator that measures the health of the specific subnet connected to a particular interface of the router 1. However, the if agent 3b alarms would be unable to detect problems at another interface port. Using all the if variables at a router 1, the intelligent agent should be able to detect network problems that occur in all the subnets 7. The processing at the network layer or the ip agent provides an indicator for the network health as perceived by the router. However, without the ip variables, problems at the router 1 would not get detected promptly, and the propagation of the fault through the network would not be observed. Therefore using the distributed scheme shown in FIG. 17, a problem at a router 1 can be further isolated to the subnet 7 level.

Proposed Model for Network Faults

Faults refer to circumstances where correction is beyond the normal functional range of network protocols and devices. Faults affect network availability immediately or indicate an impending adverse effect. Network faults and performance problems can be broadly classified as either predictable or non-predictable faults. Predictable faults are preceeded by indications that allow inference of an impending fault. The opposite is true in the case of non-predictable faults. Non-predictable faults correspond to events in which these adverse effects occur simultaneously with their indications.

Predictable and Non-Pedictable Faults

Examples of predictable faults are: file server failures, paging across the network, broadcast storms and a babbling node. These faults affect the normal traffic load patterns in the network. For example, in the case of file server failures such as a web server, it is observed that prior to the fault event there is an increase in the number of ftp requests to that server. Network paging occurs when an application program outgrows the memory limitations of the work station and begins paging to a network file server. This may not affect the individual user but affects others on the network by causing a shortage of network bandwidth. Broadcast storms refer to situations where broadcasts are heavily used to the point of disabling the network by causing unnecessary traffic. A babbling node is a situation where a node sends out small packets in an infinite loop in order to check for some information such as status reports. This fault only manifests itself when the average network utilization is low since it has a negligible contribution to heavy traffic volumes. Congestion at short time scales is an example of a performance problem that can be predicted by closely monitoring the network traffic characteristics. Here, predictability is defined with respect to any existing indications such as syslog messages. The primary cause for predictable faults can be either hardware (such as a faulty interface card) or software related.

An example of a non-predictable fault is a link break, i.e., when a functioning link has been accidentally disconnected. Such faults cannot be predicted. On the other hand, non-predictable faults such as protocol implementation errors can result in increased traffic load characteristics thus allowing for detection. For example, the presence of an accept protocol error in a super server (inetd), results in reduced access to the network which in turn affects network traffic loads. The symptom thus observed in the traffic loads can then be detected as an indication of a fault.

Here, both predictable and non-predictable faults that are traffic related are examined. It is possible to identify traffic-related faults by the effect they cause in normal network behavior. The definition of normal network behavior is dependent on the dynamics involved in the network in terms of the traffic volume, the type of applications running on the network, etc. Since network traffic exhibits fractal behavior, there are no analytically simple models that can be used to learn the normal behavior. To circumvent the problem of accurate traffic models, the present sytem models network fault behavior as opposed to normal behavior.

Deviations from normal network behavior that occur before or during fault events can be associated with transient signals caused by the performance degradation. Therefore, it is premised that faults can be identified by transient signals that are produced by a performance degradation prior to or during a full blown failure.

Experimental Study of the Structure of Network Faults Using MIB Variables

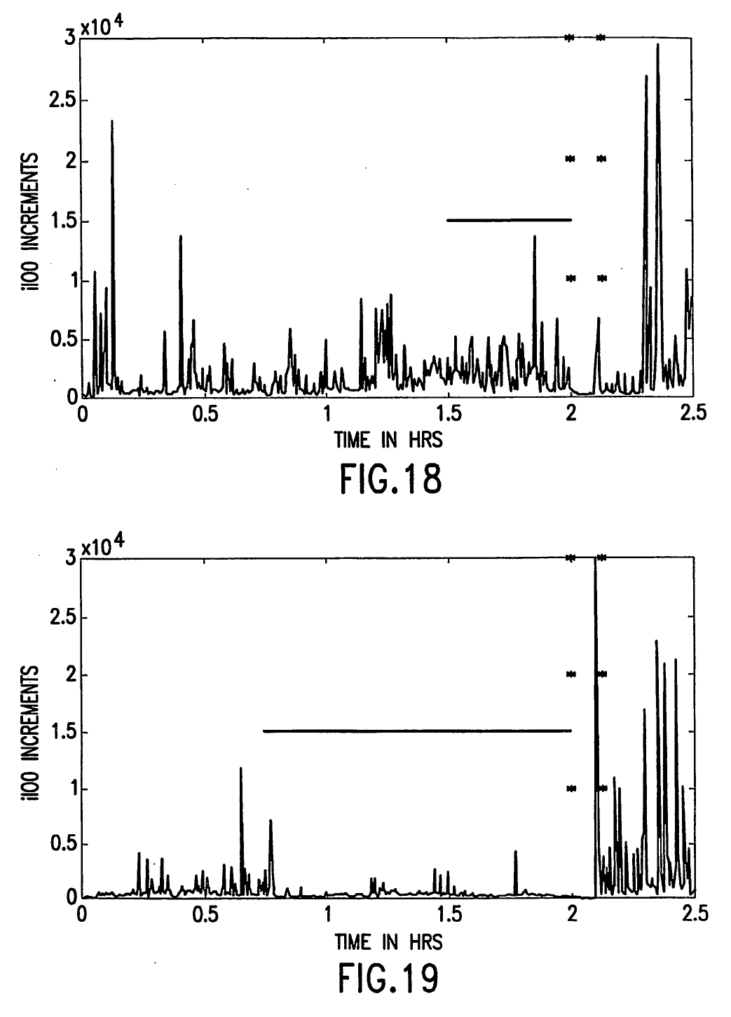

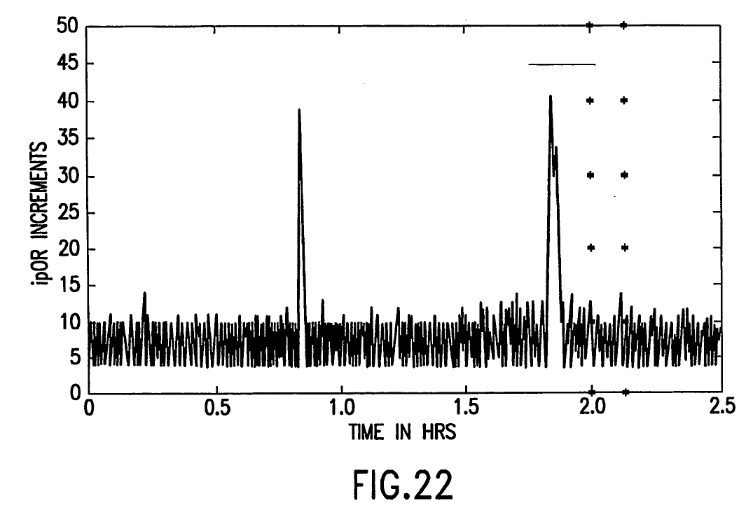

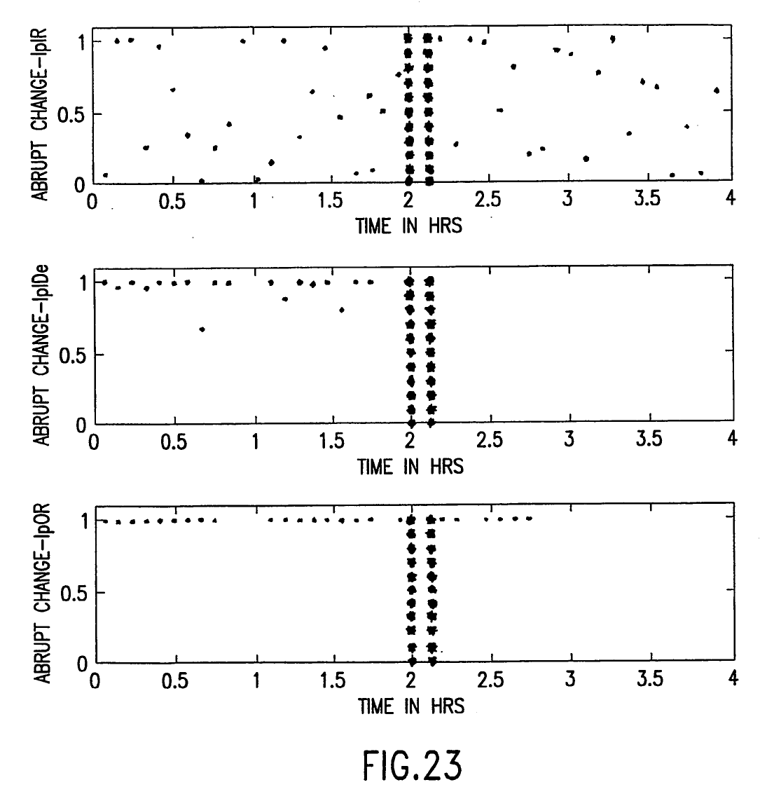

In general, network traffic can be measured in terms of the network load such as packet transmission rate. However, to obtain a finer resolution at the different nodes on the network it is beneficial to use the traffic-related Management Information Base (MIB) variables. To better define network faults, a specific fault manifestation is discussed. This particular fault occurred on a campus LAN network and corresponded to a file server failure that was reported by 36 machines of which 12 were located on the same subnet as the file server. The fault lasted for a duration of seven minutes. FIGS. 18 through 22 show the trace of the different traffic-related MIB variables at the ip layer, 2 hours before the fault was observed by the existing mechanisms such as syslog messages. The fault was observed (by detecting changes in the statistics of the traffic data) in the syslog messages generated by the machines experiencing faulty conditions. This particular fault is a good illustrative case as the deviations from normal network behavior are more easily observable in the traffic traces. The extent of deviation from normal behavior is different for different variables and also varies based on the manifestation of the fault. In the case discussed there is a significant change in the mean level of traffic observed in the ifOO variable as compared to the ifIO variable. The situation observed in the ifOO variable is one extreme case. In the ip level variables the changes observed in the ipIDe and ipOR variables are much more subtle than the changes in the ipIR variable. Therefore, more sophisticated methods are required to detect these subtle changes. The detection results obtained in the case of the ip variables are shown in FIG. 23.

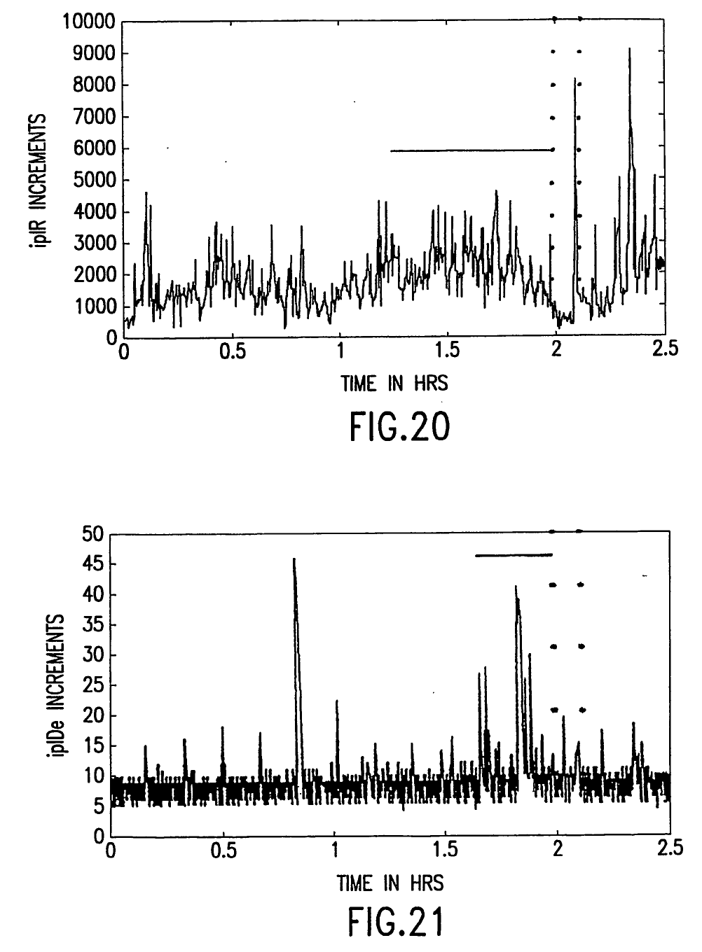

Another important aspect to be noted is that the subtle abrupt changes associated with the fault events occur in a correlated fashion across the different MIB variables of a particular protocol layer. Note in FIGS. 20 through 22 that there are abrupt changes observed in all the three ip level variables less than one half hour before the fault occurred. Results showing correlated abrupt changes for this specific fault under discussion are shown in FIG. 23. The Y axis represents the magnitude of the abrupt changes. Note that abrupt changes are detected in all of these MIB variables prior to the fault. This is found to be true in the case of the if level variables as well.

Non-Stationarity in MIB Data

It is found that some of the MIB variables are non-stationary. Since the non-stationary (long-range dependent) variables do not have accurate models, a more sophisticated method of distinguishing the deviations from normal network behavior is required. Adaptive learning methods are used to address the problem of non stationarity.

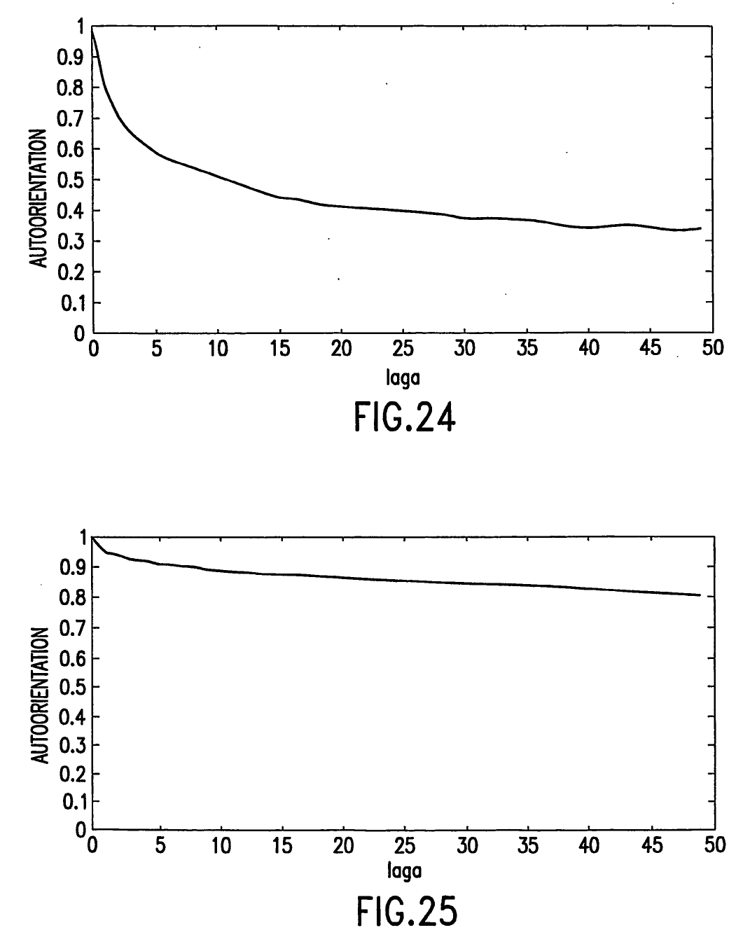

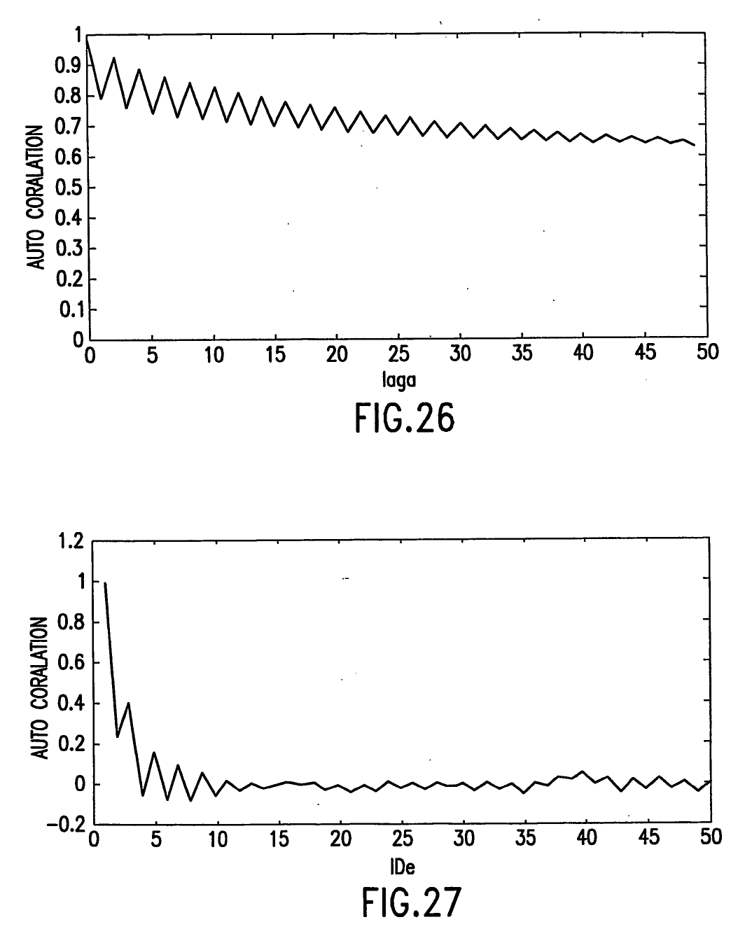

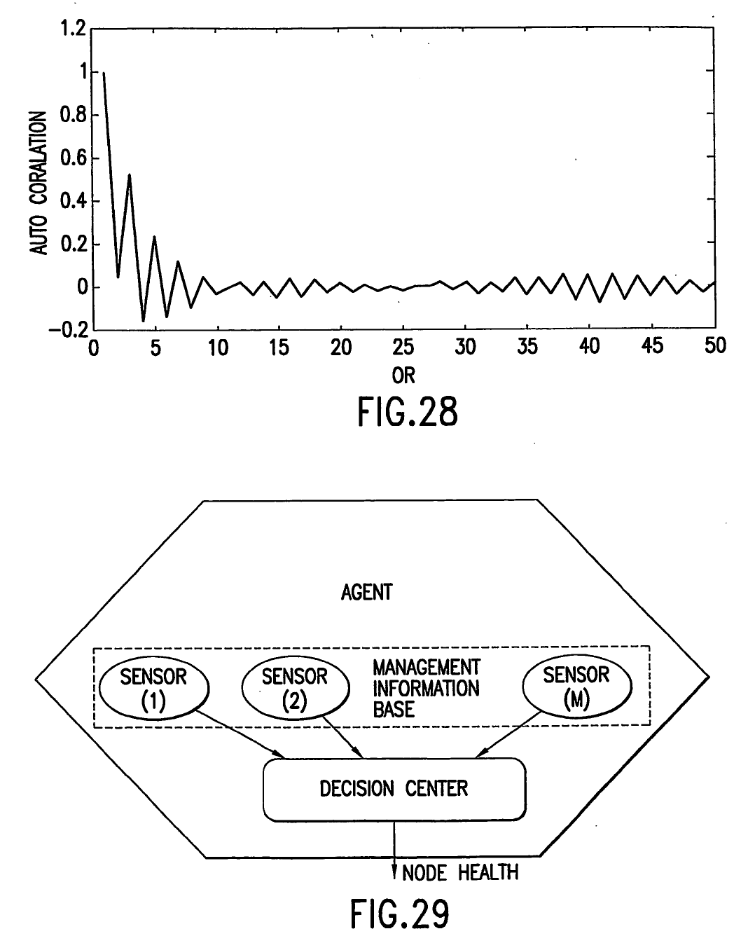

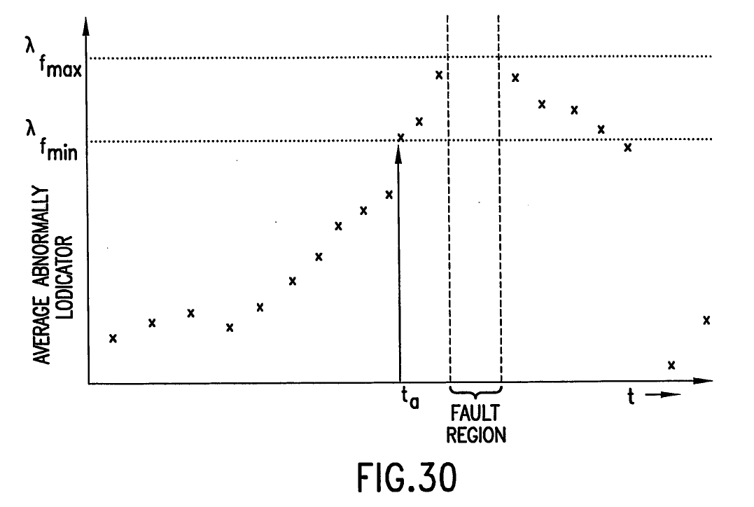

An accurate estimation of the Hurst Parameter for the MIB variables is difficult due to the lack of high resolution data. Therefore, the long-range dependent behavior of the MIB variables is observed in terms of the autocorrelation functions (see FIGS. 24-28). For the ifIO, ifOO, and ipIR variables, (see FIGS. 24, 25, and 26) the autocorrelation is significantly high even at very large lags. At 50 lags (12.5 mins) the ifIO variable has an autocorrelation value of 0.3, the ifOO variable has an autocorrelation value of 0.81, and the ipIR variable has an autocorrelation value of 0.6. There is a slow decay in the auto correlation function thus giving rise to a hyperbolic rather than an exponential decay. This observation is indicative of long range dependence. In FIGS. 27 and 28 the autocorrelation for the variables ipIDe and ipOR decays exponentially, showing that these variables are not fractal in nature. The variables ifIO, ifOO, and ipIR relate to actual traffic traces and have long-range dependence. Thus, in the case of the ifIO, ifOO and ipIR variable the normal MIB data is long-range dependent. For the variables inIDe and ipOR the normal MIB data are short-range dependent.

Proposed Model of Network Faults

It is proposed that faults can be modeled as correlated transient (short-range dependent) signals that are embedded in background MIB data. The transient signals manifest themselves as abrupt changes. An abrupt change is any change in the parameters of a signal that occurs on the order of the sampling period of the measurement of the signal. Here, the sampling period was 15 seconds. Therefore, an abrupt change is defined as a change that occurs in the period of approximately 15 seconds. The transient changes can be expressed mathematically using the average autocorrelation. In the case of a purely long-range dependent process we have that the autocorrelation r(k) satisfies the property,

$${\sum }_{k} r ( k ) = ∞$$

where r(k)˜k^{2H-2} as k→∞. k is the number of lags and H which satisfies H>0.5 is the Hurst Parameter. This results in the hyperbolic curve of the correlogram as seen in FIGS. 24 through 26. However, in the case of transient signals that cause the correlogram to decay exponentially we have,

$$0 < {\sum }_{k} r ( k ) < ∞$$

where, r(k)˜ρ^{k} as k→∞ and the correlation coefficient ρ satisfies |ρ|≦1.

The abrupt changes can be modeled using an Auto-Regressive (AR) process. Since these abrupt changes propagate through the network, they can be traced as correlated events among the different MIB variables. This correlation property distinguishes abrupt changes intrinsic to fault situations from those random changes of the system which are related to the network's normal function. In conclusion, traffic-related faults of interest can be defined by their effect on network traffic such that before or during a fault occurrence, traffic-related MIB variables undergo abrupt changes in a correlated fashion.

Problem Statement and Algorithm

Using the above model for network faults, the fault detection problem can be posed such that given a sequence of traffic-related MIB variables 9 sampled at a fixed interval, a network health function can be generated that can be used to declare alarms corresponding to network fault events. The fault model is used to develop a detection scheme to declare an alarm at some time tₐ which corresponds to an impending fault situation or an actual fault event. The steps involved are described below and depicted pictorially in FIG. 29.

Step (1): The statistical distribution of the individual MIB variables 9 are significantly different thus making it difficult to do joint processing of these variables 9. Therefore, sensors 11 are assigned individually for each MIB variable 9. The abrupt changes in the characteristics of the MIB variables 9 are captured by these sensors 11. The sensors 11 perform a hypothesis test based on the Generalized likelihood Ratio (GLR) test and provide an abnormality indicator that is scaled between 0 and 1. The abnormality indicators are collected to form \vec{ψ}(t)₁bnormality vector. The a\vec{ψ}(t)mality vector is a measure of the abrupt changes in normal network behavior. This measure is obtained in a time-correlated fashion.

Step (2): The fusion center 13 incorporates the spatial dependencies between the abrupt changes in the individual MIB variables 9 into the abnormality vector by using a linear operator A. In particular the quadratic functional:

ƒ(\vec{ψ}(t))=\vec{ψ}(t)A\vec{ψ} (t),

is used to generate a continuous scalar indicator 15 of network health. This network health indicator 15 is interpreted as a measure of abnormality in the network as perceived by the specific node. The network health indicator 15 is bounded between 0 and 1 by a transformation of the operator A. A value of 0 represents a healthy network and a value of 1 represents maximum abnormality in the network.

Step (3): The operator matrix A is an M×M matrix (M is the number of sensors). In order to ensure orthogonal eigenvectors which form a basis for R^{M} and real eigenvalues, the matrix A is designed to be symmetric. Thus it will have M orthogonal eigenvectors with M real eigenvalues. A subset of these eigenvectors are identified that correspond to fault states in the network. Let λ_{fmin} and λ_{fmax} be the minimum and maximum eigenvalues that correspond to these fault states. The problem of alarm generation by the agent 3 can then be expressed as:

tₐ=inƒ{t:λ_{fmin}≦ƒ(\vec{ψ}(t))≦λ_{fmax}}

where tₐ is the earliest time at which the functional ƒ(_{ψ}(t)) exceeds λ_{fmin}. (see FIG. 3.13). Each time the condition is satisfied, there is a potential alarm. In order to declare alarms that correspond to a fault situation, persistence criteria is further imposed on the potential alarm conditions.

Detection of Abrupt Changes in Management Information Base Variables

It has been experimentally shown that changes in the statistics of traffic data can in general be used to detect faults. According to the present fault model, network faults manifest themselves as abrupt changes in the traffic-related MIB variables. Since the MIB variables have different statistical distributions, some of which are non-Gaussian, joint processing is not possible. Hence, for each individual MIB variable a sensor is designed to detect the abrupt changes. Since the MIB variables are not strictly independent, they have non-zero cross correlations. These correlations are time varying and are accounted for when the variable level sensor outputs are combined at the fusion center. This method of incorporating the correlations is an advantage in terms of reducing the complexity of the algorithm.

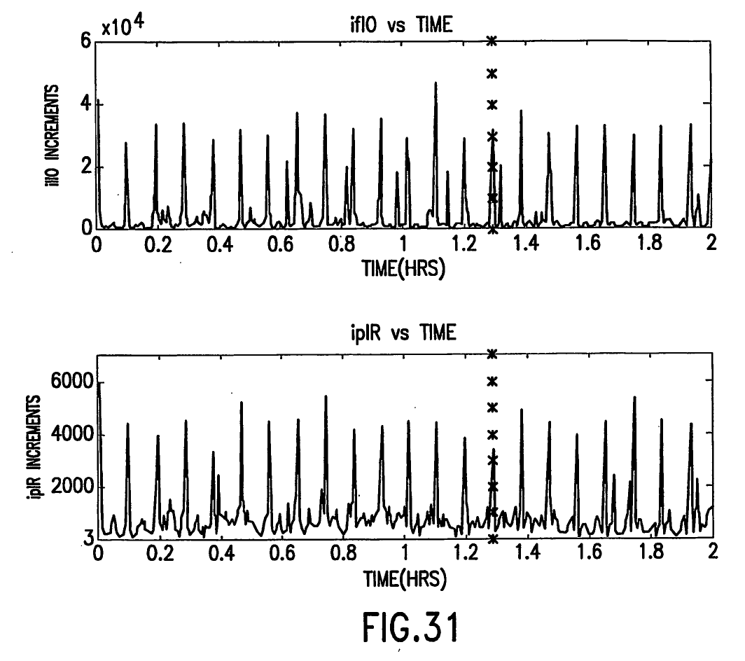

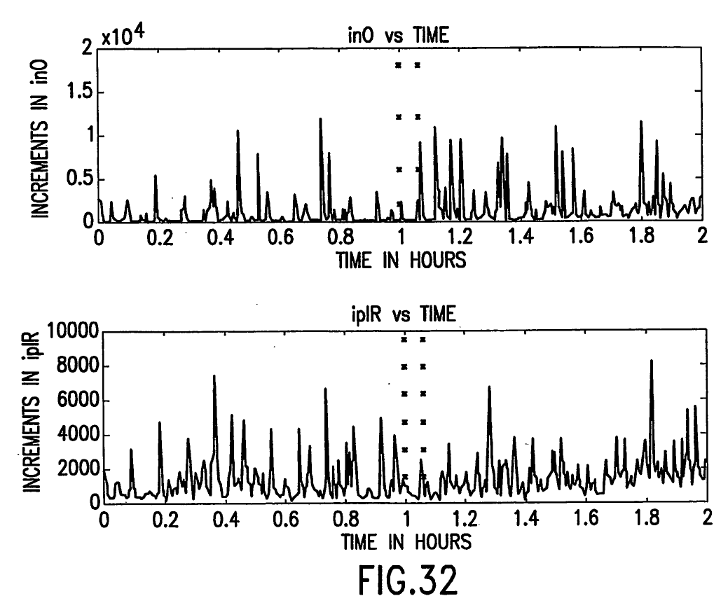

Faults produce abrupt changes in network traffic that require more sophisticated methods than second-order statistics in order to be detected. FIGS. 31 and 32 illustrate the behavior of the MIB variables around the fault region in two different cases. The column of asterisks and dots in the figures indicate when a network fault occurred. Note that there does not seem to be a drastic change in the overall behavior (1 hour) of the data trace before a fault occurs. In FIG. 31, the periodicities inherent to the network traffic dominate the trace since the mean traffic level was low during the early hours (2 am) of the day when this particular fault occurred.

Change Detection

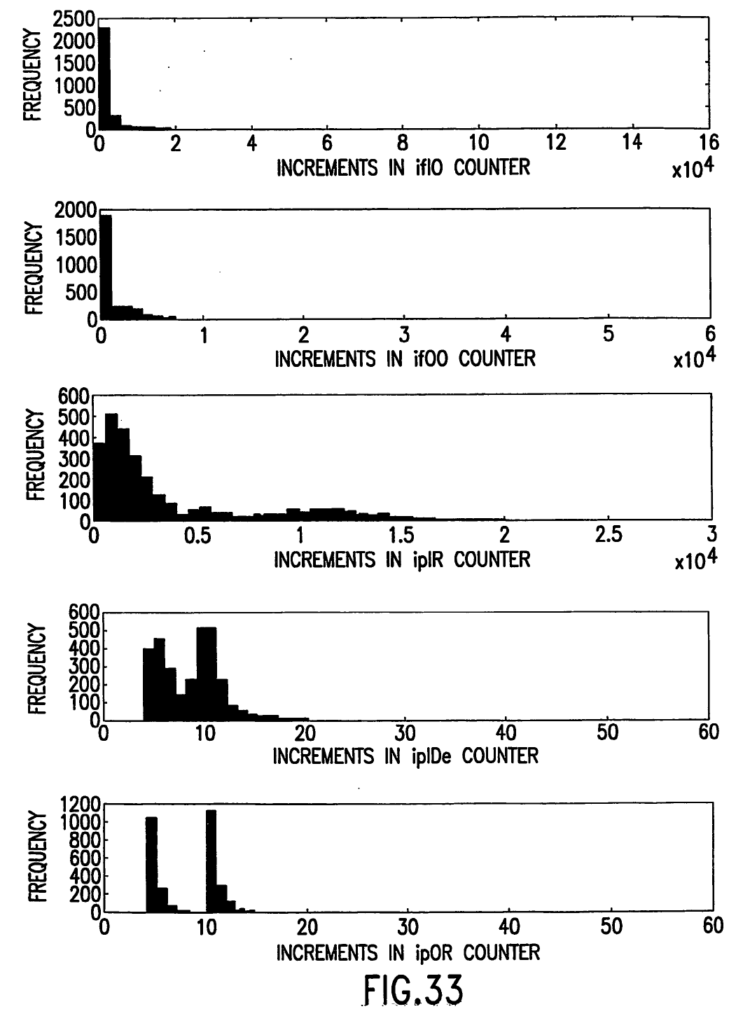

In most problems with multiple input variables a simple multivariate hypothesis test is employed to perform detection using parametric procedures. However, multivariate hypothesis testing requires knowledge of the joint statistics of the input variables as well as some assumptions of stationarity. Since the MIB variables are highly non-stationary and there is no prior information available about the statistics of the normal traffic as well as the alternate fault hypothesis, multivariate hypothesis testing is not amenable. The histogram of the differenced time series corresponding to each MIB variable is presented in FIG. 33. The histogram of the data is shown to provide a sense of the distribution of these variables.

Online Learning/Detection

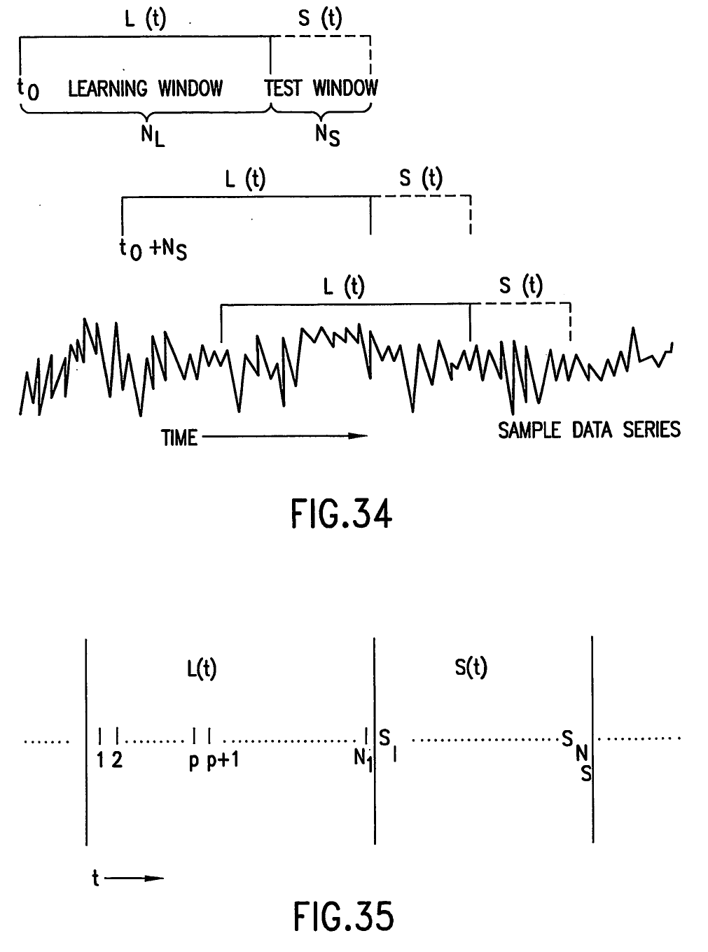

The time series data obtained from the MIB variables are non-stationary, thus an adaptive learning algorithm to account for the normal drifts in the traffic is required. Hypothesis testing is performed by comparing two adjacent non-overlapping windows of the time series, the learning window L(t) and the test window S(t). The length of these windows is chosen so that the time series data within these windows could be considered piecewise stationary. As time increments, these windows slide across the time series as depicted in FIG. 34.

Hypothesis Testing using Generalized Likelihood Ratio

A sequential hypothesis test is performed to determine whether a change has occurred going from the learning window to the test window. Since faults are manifested as abrupt changes, the piecewise stationary segments of the data (learning and test windows) are modeled using an AR process of order p. The hypothesis test based on the power of the residual signals in the segments is performed to determine if a change has occurred.

Consider a learning window L(t) and test window S(t) of lengths N_{L} and Nₛ respectively as in FIG. 35. First, consider the learning window L(t):

L(t)={l₁(t), l₂(t), . . . , l_{N}_{_{L}}(t)}

We can express any lᵢ(t) as \overline{l}ᵢ(t) where \overline{l}ᵢ(t)=lᵢ(t)−μ and is the mean of the segment L(t). Now \overline{l}ᵢ(t) is modeled as an AR order p process with a residual error εᵢ

$${ε}_{i} ( t ) = {\sum }_{k = 0}^{p} {α}_{k} {\overline{l}}_{i} ( t - k ) ,$$

where α_{L}={α₁ α₂, . . . , αₚ} and α₀=1 are the AR parameters.

Assuming that each residual time sample is drawn from an N(0, σ_{L}²) distribution, the joint likelihood of the residual time series is obtained as

where σ_{L}² is the variance of the segment L(t), and N′_{L}, N_{L}−p, and \hat{σ}_{L}²

$$p ( {ε}_{p + 1} , … , {ε}_{{N}_{L}} / {α}_{1} , … , {α}_{p} ) = {( \frac{1}{\sqrt{2 {πσ}_{L}^{2}}} )}^{{N}_{L}^{′}} exp ( \frac{- {N}_{L}^{′} {\hat{σ}}_{L}^{2}}{2 {σ}_{L}^{2}} ) ,$$

is the covariance estimate of σ_{L}². A similar expression can be obtained for the test window Segment S(t). Now the joint likelihood ν of the two segments L(t) and S(t) is given as,

$$𝓋 = {( \frac{1}{\sqrt{2 {πσ}_{L}^{2}}} )}^{{N}_{L}^{′}} {( \frac{1}{\sqrt{2 {πσ}_{S}^{2}}} )}^{{N}_{S}^{′}} exp ( \frac{- {N}_{L}^{′} {\hat{σ}}_{L}^{2}}{2 {σ}_{L}^{2}} ) exp ( \frac{- {N}_{L}^{′} {\hat{σ}}_{S}^{2}}{2 {σ}_{S}^{2}} )$$

where σ_{S}² is the variance of the segment S (t), and N_{S}=Nₛ−p, and \hat{σ}_{S}² is the covariance estimate of σ_{S}². The expression for ν is a sufficient statistic and is used to perform a binary hypothesis test based on the Generalized Likelihood Ratio. The two hypotheses are H₀, implying that no change is observed between the learning and the test segments, and H₁, implying that a change is observed. Under the hypothesis H₀ we have,

α_{L}=α_{S},

σ_{L}²=σ_{S}²=σₚ².

where σ_is the pooled variance of the combined learning and test segments. Therefore under hypothesis H₀ the likelihood μ₀ becomes,

$${𝓋}_{0} = {( \frac{1}{\sqrt{2 {πσ}_{P}^{2}}} )}^{{N}_{L}^{′} + {N}_{S}^{′}} exp ( \frac{- ( {\dot{N}}_{L} + {\dot{N}}_{S} ) {\hat{σ}}_{P}^{2}}{2 {σ}_{P}^{2}} )$$

Under hypothesis H₁ we have,

α_{L}≠α_{S},

σ_{L}²≠σ_{S}².

implying that a change is observed between the two windows. Hence the likelihood ν₁ under H₁ becomes,

ν₁=ν

In order to obtain a value for the generalized likelihood ratio 77 that is bounded between 0 and 1, we define 77 as follows,

$$η = \frac{{𝓋}_{1}}{{𝓋}_{1} + {𝓋}_{0}}$$

Furthermore, on using the maximum likelihood estimates for the variance terms we get;

$$η = \frac{{\hat{σ}}_{L}^{- {\dot{N}}_{L}} {\hat{σ}}_{S}^{- {\dot{N}}_{S}}}{{\hat{σ}}_{L}^{- {\dot{N}}_{L}} {\hat{σ}}_{S}^{- {\dot{N}}_{S}} + {\hat{σ}}_{P}^{- ( {\dot{N}}_{L} + {N}_{S} )}}$$

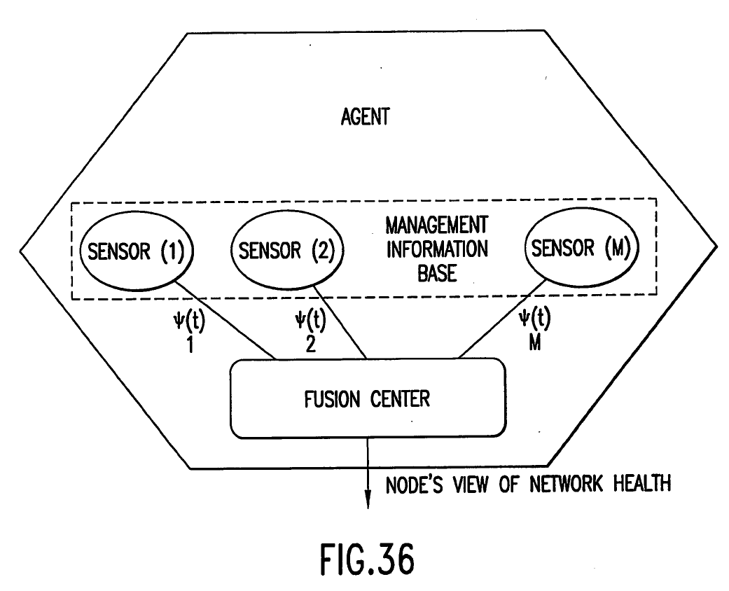

Using this approach, a measure of the likelihood of abnormality for each of the MIB variables 9 as the output of the individual sensors 11 is obtained. These indicators 15, which are functions of system time, are updated every N, lags. The indicators 15 provided by the sensors 11 form the abnormality vector which is fed into the fusion center 13 as shown in FIG. 36. The abnormality\vec{ψ}(t)tor is composed of elemenψᵢ(t) where,

ψᵢ(t)=η

for the ith MIB variable.

Study of Residuals

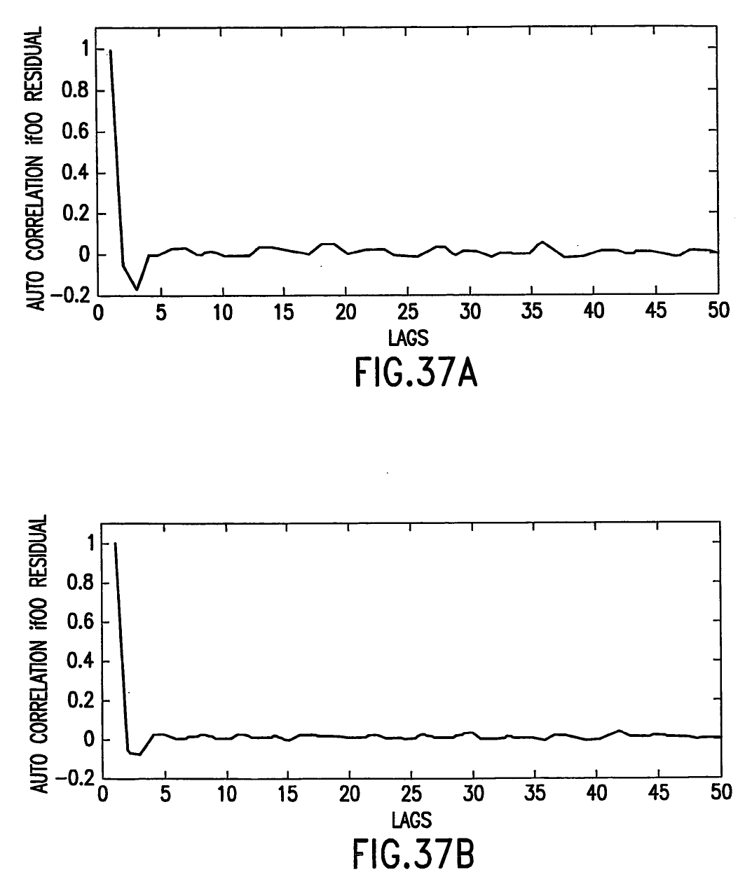

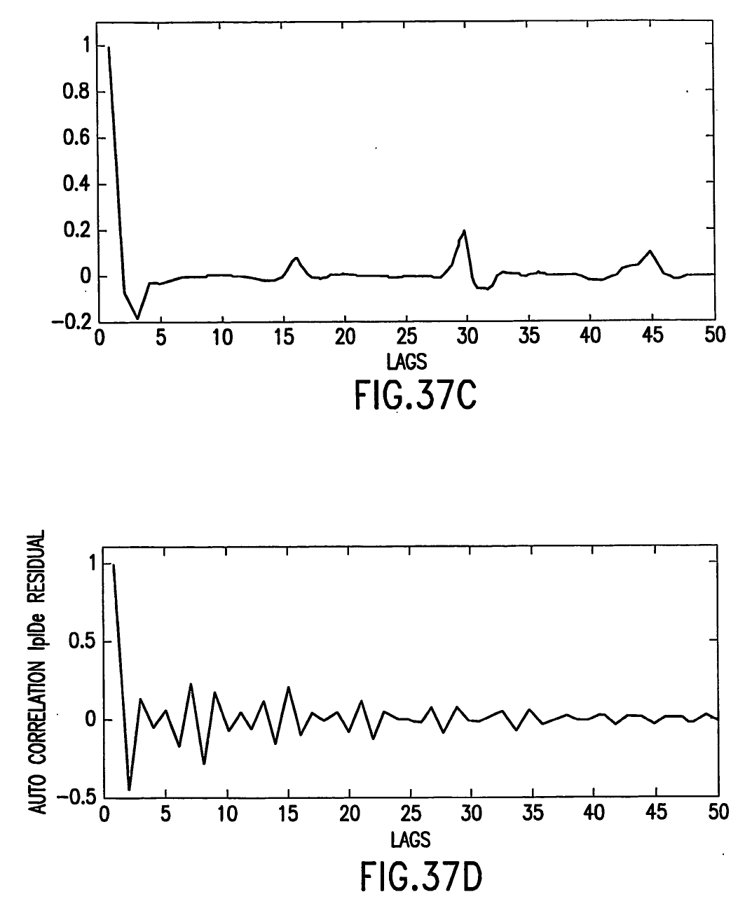

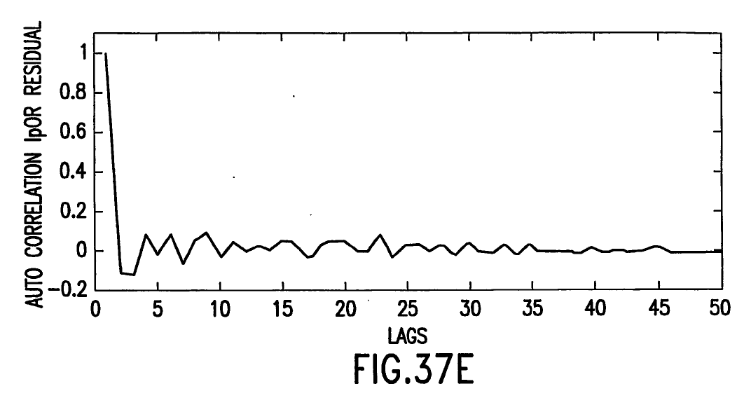

Network traffic has been shown to exhibit long-range dependence. Therefore, it is necessary to explore the time lagged properties of the residuals of the piecewise stationary segments obtained from the traffic-related MIB data. The correlation function of a typical residual signal obtained from the different MIB variables is shown in FIG. 37. The correlogram is obtained over 50 time lags (approx 12.5 mins). Each time lag corresponds to 15 seconds. Note that there is no significant correlation after 10 lags (2.5 mins).

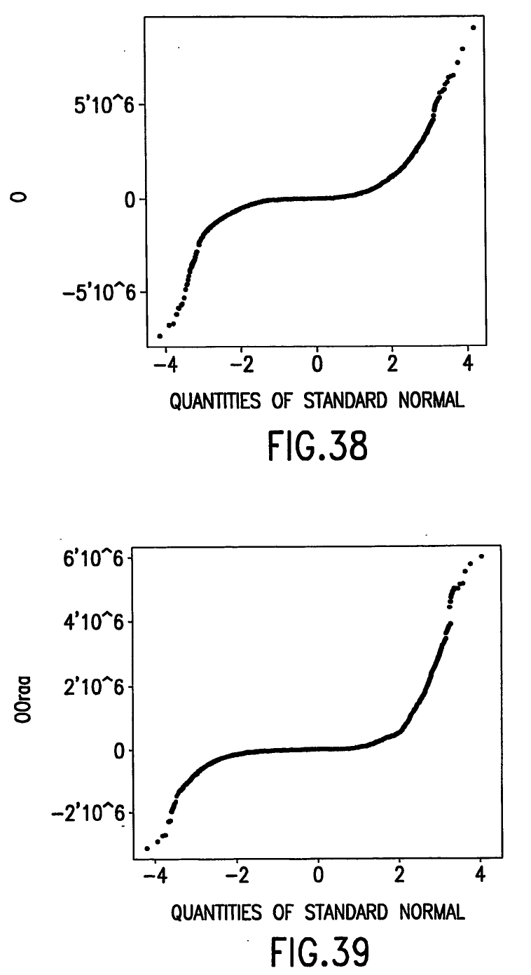

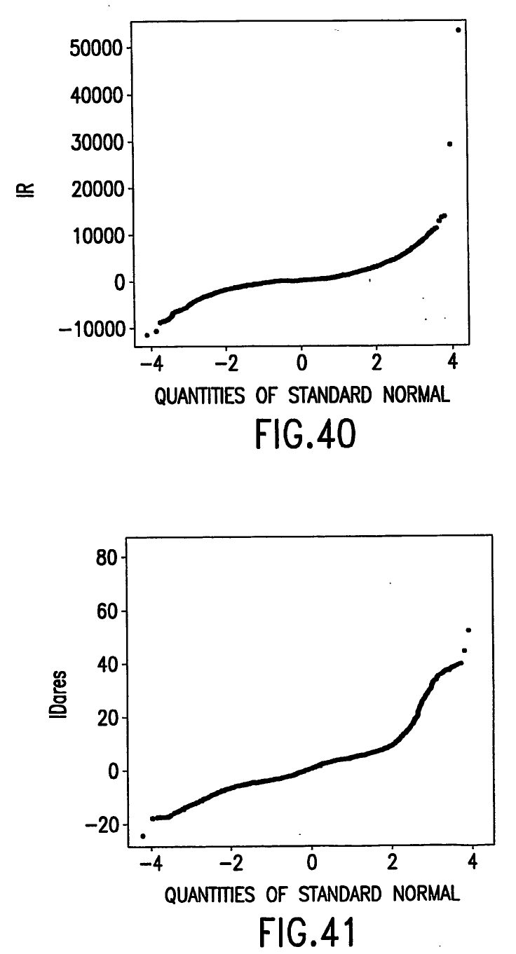

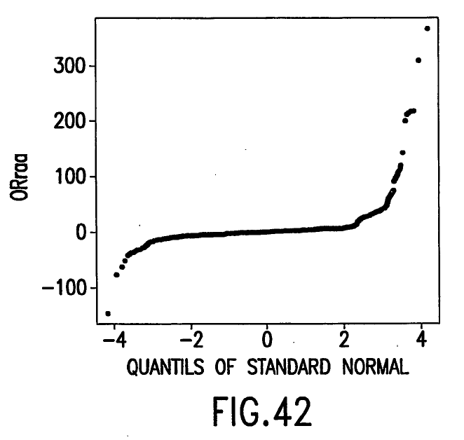

The quantile distribution of the residuals of the MIB variables are plotted against the quantiles of a standard normal distribution in FIGS. 38 through 42. When there is a noticeable ‘S’ shape in the quantile-quantile plot the residuals slightly differ from a standard normal distribution in that the former have a longer tail. Therefore as seen from the figures, the if variables can be better approximated as Gaussian random variables than the if variables. However, since only the first two moments of the residual time series is concerned, the Gaussian approximation for the residual error distribution of all the variables is utilized.

Implementation

The implementation of the change detection algorithm depends on the choice of the window size N_{L} for the learning window and Nₛ for the test window as well as p, the order of the AR process. A higher order of the AR process will model the data in the window more accurately but will require a large window size due to the requirement that a minimum number of samples are necessary to be able to estimate the AR parameters accurately. An increase in window size will result in a delay in the prediction of an impending fault. Subject to these constraints, we choose the test window size N_{S}=20 samples (5 min). The length of the learning window N_{L} is experimentally optimized for the different MIB variable. The ipIR, ifIO, and ifOO variables require a learning window N_{L} of 20 samples (5 mns at 15 sec polling). In the case of the campus network the variables ipIDe and ipOR have an optimal learning window N_{L} of 480 samples (120 mins at 15 sec polling). In the case of the enterprise network it was found that the variables ipIDe and ipOR were more bursty and therefore N_{L} was reduced to 120 samples (30 mins at 15 sec polling). The system implies that when the learning window is increased beyond the optimal window size, no changes are detected. The difference in the learning window sizes for the different MIB variables can be attributed to the bursty behavior of the first set of variables.

Adequate representation of the signal and parsimonious modeling are competing requirements. Hence, a trade off between these two issues is necessary. The accuracy of the model is measured in terms of Akaike's Final Prediction Error (FPE) criterion. The order corresponding to a minimum prediction error is the one that best models the signal. However due to singularity issues there is a constraint on the order p, expressed as:

0≦p≦0.1N

where N is the length of the sample window. In order to compare the residuals from the learning and the test windows, it is necessary to use the same AR order to model the data in both these windows. Hence the value of N is constrained by the length of the test window N_{S}=20 samples. The appropriate order for p is chosen to be 1 since it minimizes the FPE subject to the constraints of the problem.

Results

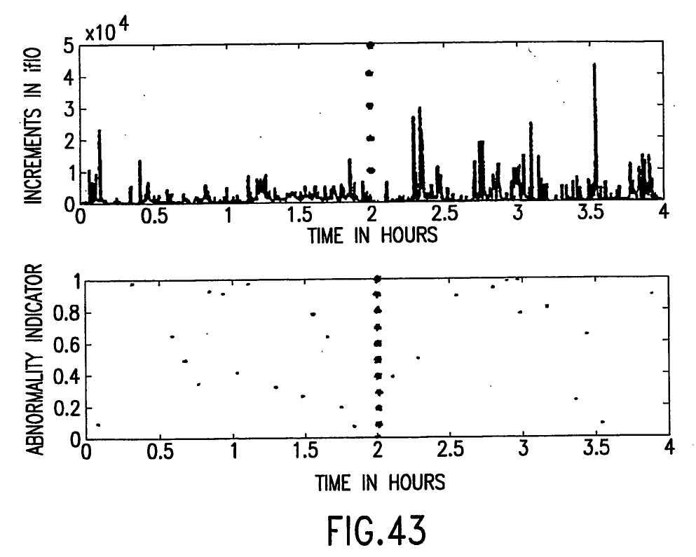

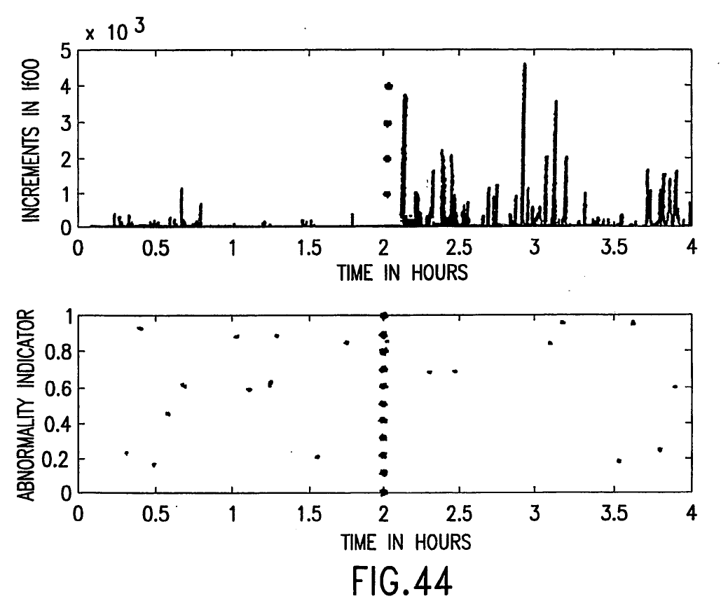

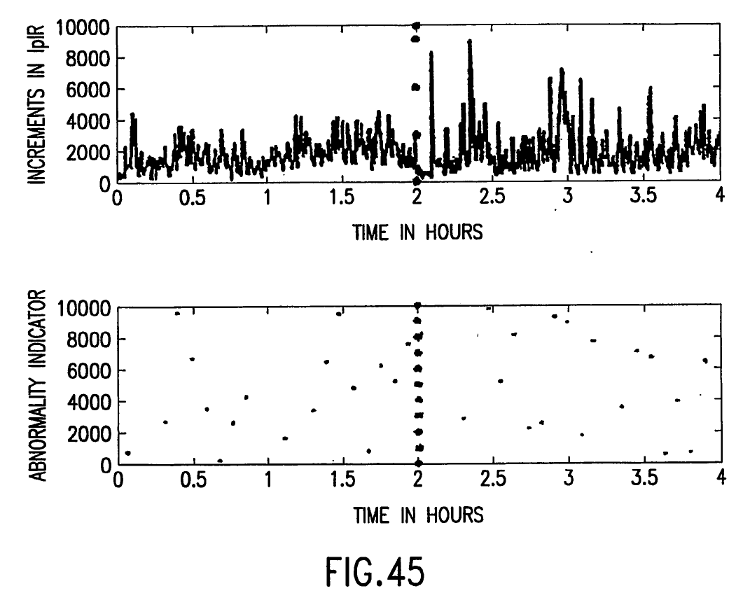

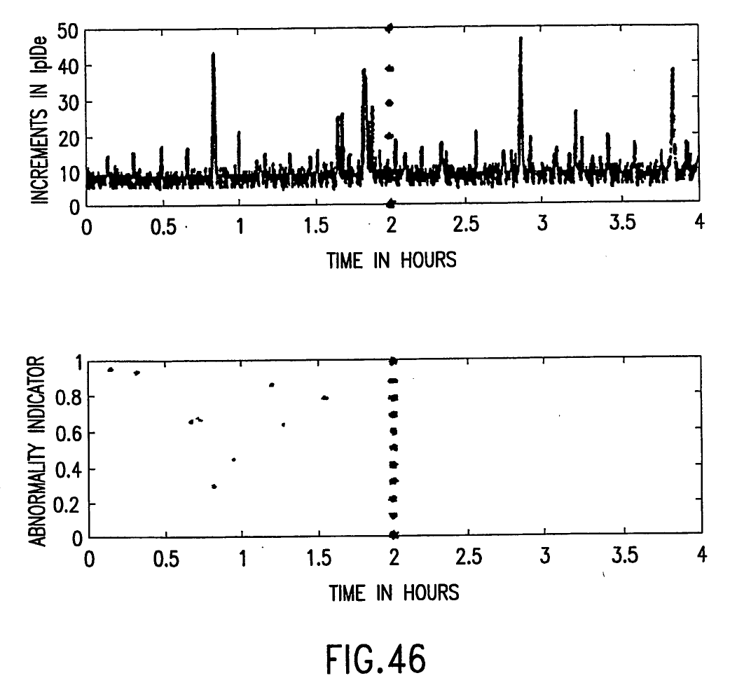

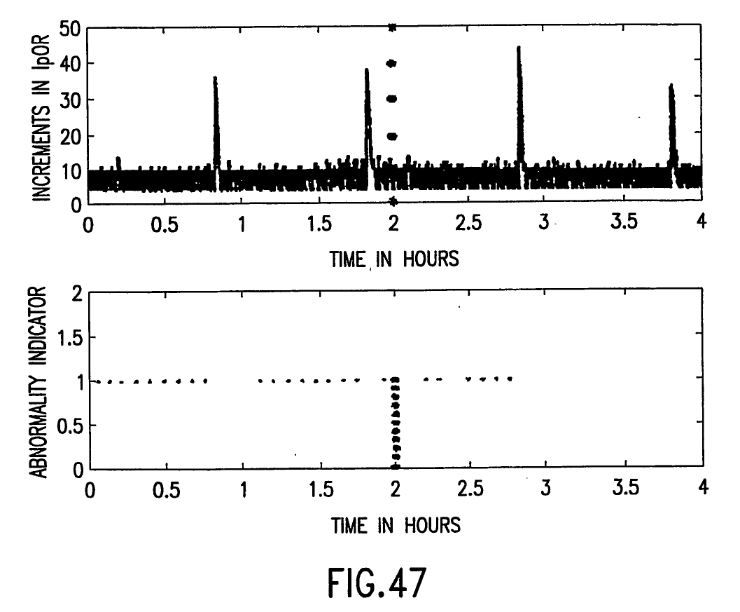

Examples of the change detection algorithm applied to the five MIB varables in one typical fault case is shown in FIGS. 43 through 47. The MIB variable data is plotted alongside the output abnormality indicators. The trace corresponds to a 4 hour period. The fault region is denoted using asterisks. The abnormality indicators in general rise prior to the fault event. However, there are times when the abnormality indicator for a single variable rises high in the absence of a fault. These situations contribute to some of the false alarms generated by the agent. Note, that there are relatively higher number of such alarms in the variables ifIO, ifOO, and ipIR. It is proposed that this is due to the bursty nature of these variables and the inability of the single time scale algorithm to learn the normal behavior accurately.

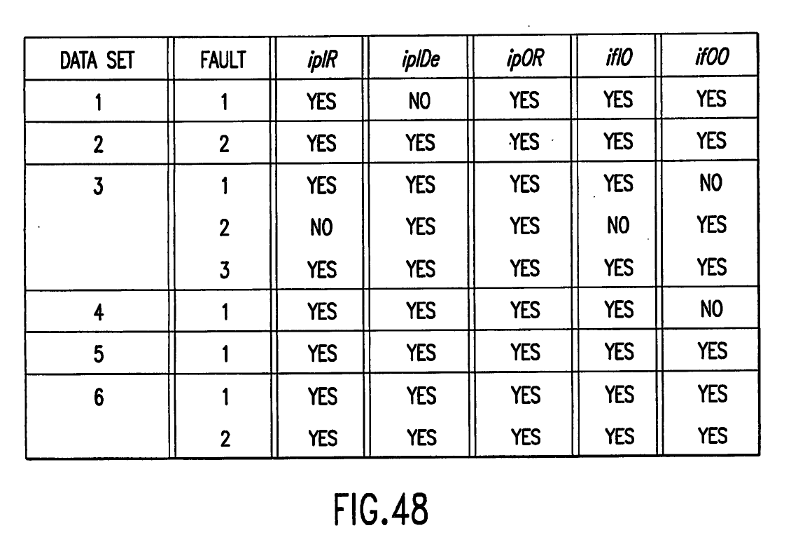

The results of the change detection algorithm are summarized in FIG. 48. In FIG. 48, it is concluded that the ipOR variable is a good indicator of network anomalies since changes corresponding to all the faults were detected in the indicator for this variable. Furthermore, in accordance with the proposed fault model, the abrupt changes associated with a network fault can be distinguished only if the changes occurrence correlated fashion among the different MIB variables. Under normal conditions the abrupt changes are less correlated between the different MIB variables. Therefore all the five variables are needed to predict network faults. Furthermore, using more than one variable will help reduce the occurrence of false alarms. This motivated the need to combine the information obtained from the individual sensors (associated with the different MIB variables) at the fusion center.

Combination of Sensor Information: Fusion Center

Although alarms obtained at tie sensors for each variable can indicate some problematic behavior, they contain only partial and noisy information about a potential network problem. Therefore to reduce the false alarms generated at the variable level, it is necessary to combine the information from the sensors. Even though the MIB variables are dependent, the sensor outputs are obtained by treating the MIB variables independently. Therefore the outputs of the sensors need to be combined to take into account these dependencies.

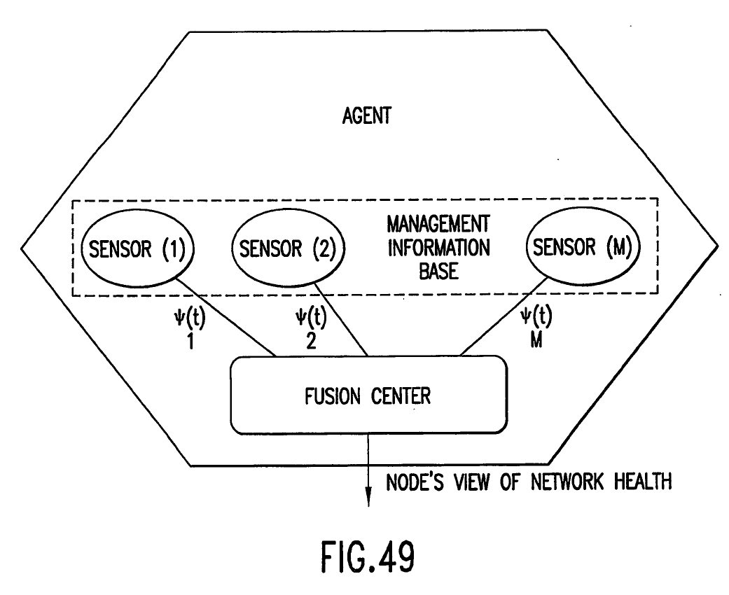

In accordance with the present model for network faults, a method for identifying correlated changes in the MIB variables 9 must be developed. This task is accomplished using a fusion center 13. The fusion center 13 is used to incorporate these spatial dependencies into the time correlated variable-level abnormality indicators 15. The output of the fusion center 13 is a single continuous scalar indicator 15 of network level abnormality as perceived by the node level agent (see FIG. 49). The system employs two different methods at the fusion center 15: a duration filter approach and an approach using a linear operator. The linear operator method is found to be more amenable to online implementation and is able to combine the variable-level information in a more straightforward manner than the duration filter.

Duration Filter

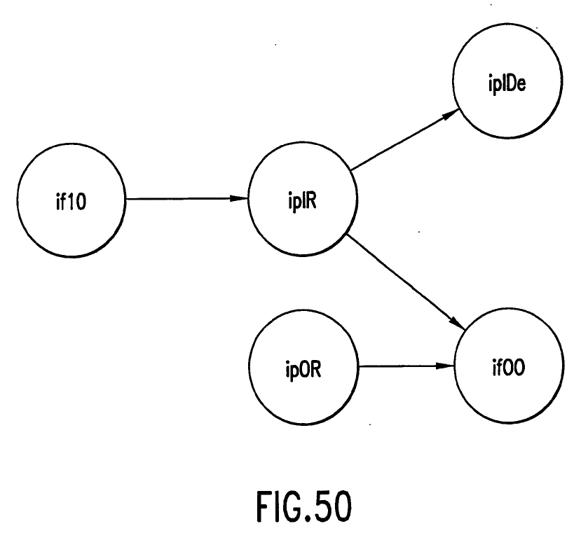

In the combination scheme, the sensor level output is combined using a duration filter. The duration filter is implemented on the premise that a change observed in a particular variable should propagate into another variable that is higher up in the protocol stack. For example, in the case of the ifIO variable, the flow of traffic is towards the ipIR variable and therefore an abrupt change in the ifIO variable should propagate to the ipIR variable. Using the relationships from the Case diagram representation shown in FIG. 4, all possible transitions between the chosen variables are determined (see FIG. 50). The duration filter is designed to detect all four transition types. The time interval between transitions represents the duration filter. The length of the duration filter for each transition is experimentally determined. Transitions that occur within the same protocol layer (ipIR to ipIDe) require a duration filter of length 15 seconds which is the sampling rate of the MIBs. However, for transitions that occur between the if and the ip, layers a significantly longer duration filter of 20 to 30 min is required. The duration filter generates a single alarm that corresponds to both the interface (if) and the network (ip) layer. Hence, no new scheme is required to combine the information obtained from the different protocol layers to provide a single node level alarm. However, the disadvantage is that the estimation of the values of the transition times between the different variables is difficult, especially in the case of transitions between protocol layers. This resulted in the use of larger values for duration filter sizes to ensure the detection of different faults, which generated more false alarms. Furthermore, the alarms generated by the agent are of binary nature (0 or 1), thus obscuring the trends in abnormality. Trends are essential in order to provide a confidence measure to the declared alarms before potential recovery schemes are deployed.

The Linear Operator: A and the Quadratic Functional ƒ(\vec{ψ}(t))

We hypothesize that the spatial dependencies in the abnormality vector \vec{ψ}(t) can be captured using a linear operator A at the fusion center. In analogy to quantum mechanics the observable of this operator is interpreted as the abnormality indicator and the expectation of the observable is the scalar quantity λ used to indicate the average abnormality of the network as perceived by the agent.

Analogy of Quantum Mechanics

In quantum mechanics, measurable quantities are described by an operator A acting on a vector in a state space. The measurable quantity is also referred to as an observable. An example of an operator is the Hamiltonian H, which operates on a vector \vec{ψ} in the state space to return the observable, which is the total energy in the system. In this case, the state space is spanned by the set of eigenvectors \vec{φ} of the operator H. The eigenvectors \vec{φ} of H satisfy the equation:

[symbol]

Eᵢ is the energy of the eigenstate \vec{φ}ᵢ. In general the state vector \vec{ψ}1 may not be an eigenvector. In this case \vec{ψ} can be expressed as its spectral decomposition onto the eigenvector basis:

$$\vec{ψ \vert} = {\sum }_{i}^{} {c}_{i} {\vec{φ}}_{i}$$

Then the operation of H can be expressed as follows:

$$\begin{matrix}H \vec{ψ \vert} = H {\sum }_{i}^{} {c}_{i} {\vec{φ}}_{i} \\ = {\sum }^{} {c}_{i} {E}_{i} {\vec{φ}}_{i}\end{matrix}$$

In this equation, Eᵢ is the eigenvalue corresponding to the eigenvector \vec{φ}ᵢ Notice that in the above equation, the quantity H \vec{ψ}1 can no longer be equated with a term E\vec{ψ}1 since \vec{ψ}1 is in general not an eigenvector. In this case, although there is no exact value of the energy E, we can extract an expectation for the energy.

In quantum mechanics, the outcome of an experiment cannot be known with certainly. All that can be known is, the probability of measuring an energy Eᵢ, when the operator H acts on the state \vec{ψ}1. This probability is defined as follows:

$$\begin{matrix}p ( {E}_{i} ) = {\vert ⟨ {\vec{φ}}_{i} \cdot \vec{ψ} ⟩ \vert}^{2} \\ = {\vert ⟨ {\vec{φ}}_{i} \cdot {\sum }_{j} {c}_{j} {\vec{φ}}_{j} ⟩ \vert}^{2} \\ = {\vert ⟨ {\sum }_{j} {c}_{j} {\vec{φ}}_{i} \cdot {\vec{φ}}_{j} ⟩ \vert}^{2} \\ = {\vert ⟨ {c}_{j} {δ}_{ij} ⟩ \vert}^{2} \\ = {\vert {c}_{i} \vert}^{2}\end{matrix}$$

After a large number of measurements H are performed on a system in a particular state \vec{ψ}1, the probability of measuring Eᵢ would be:

$$p ( {E}_{i} ) = \frac{number of measurements {E}_{i}}{total number of measurements}$$

that is,

$$\frac{N ( {E}_{i} )}{N} {\to }^{N \to ∞} P ( {E}_{i} )$$

Therefore, the expectation of the observable quantity E can be calculated as follows:

$$\begin{matrix}⟨ E ⟩ = \vec{ψ} H {ϕ}^{\dot{\to }} \\ = {\sum }_{i} {c}_{i} {\vec{φ}}_{i} {\sum }_{j} {c}_{j} {E}_{j} {\vec{φ}}_{j} \\ = {\sum }_{i , j} {c}_{i} {c}_{j} {E}_{j} {δ}_{ij} \\ = {\sum }_{i} {c}_{i}^{2} {E}_{i} \\ = {\sum }_{i} {E}_{i} p ( {E}_{i} )\end{matrix}$$

Here, the observable that represents network abnormality as perceived by the node. In the fault model, network abnormality is defined as correlated abrupt changes in the MIB variables. Thus an operator matrix A to measure the degree of correlation in the input abnormality vectors is designed. The state space is composed of abnormality vectors formed from the variable-level abnormality indicators. The eigenvalues measure the magnitude of abnormality associated with a given eigenvector. Thus based on the magnitude of the eigenvalues, the corresponding eigenvectors are classified as fault or non-fault vectors.

Design of the Operator Matrix

First a (1×m) input vector \vec{ψ}(t) is constructed with components:

\vec{ψ}(t)=[ψ₁(t) . . . ψₘ(t)]

Each component of this vector corresponds to the probability of abnormality associated with each of the MIB variables as obtained from the sensors. In order to complete the basis set so that all possible states of the system are included, an additional component ψ₀(t) that corresponds to the probability of normal functioning of the network is created. The final component allows for proper normalization of the input vector. The new input vector, \vec{ψ}(t),

\vec{ψ}(t)=α[ψ₁(t) . . . ψₘ(t)ψ₀(t)]

is normalized with a as the normalization constant. By normalizing the input vectors the expectation of the observable of the operator can be constrained to lie between 0 and 1.

Consider the case where M sensor outputs are fed into the fusion center. The appropriate operator matrix A will be (M+1)×(M+1). We design the operator matrix to be Hermitian in order to have an eigenvector basis. Taking the normal state to be un coupled to the abnormal states we get a block diagonal matrix with an M×M upper block Aupper and a 1×1 lower block:

$$A = [ \begin{matrix}{a}_{11} & {a}_{12} & . & . & {a}_{1 ( M - 1 )} & {a}_{1 M} & 0 \\ {a}_{21} & {a}_{22} & . & . & {a}_{2 ( M - 1 )} & {a}_{2 M} & 0 \\ . & . & . & . & . & . & 0 \\ . & . & . & . & . & . & 0 \\ {a}_{M1} & {a}_{M2} & {a}_{M3} & {a}_{M .} & {a}_{M ( M - 1 )} & {a}_{MM} & 0 \\ 0 & 0 & 0 & 0 & 0 & 0 & {a}_{( M + 1 ) ( M + 1 )}\end{matrix} ]$$

The a_{(M+1)(M+1)} element indicates the contribution of the healthy state to the indicator of abnormality for the network node. Since the healthy state should not contribute of the abnormality indicator, we assigned a_{(M+1)(M+1}=0. Therefore for the purpose of detecting faults, only the upper block of the matrix Aᵤₚₚₑᵣ, is considered.

The elements of the upper block of the operator matrix Aᵤₚₚₑᵣ are obtained as follows: When i≠j,

$$\begin{matrix}{A}_{upper} ( i , j ) = \vert ⟨ {ψ}_{i} ( t ) , {ψ}_{j} ( t ) ⟩ \vert \\ = \frac{1}{T} \vert {\sum }_{t = 1}^{T} {ψ}_{i} ( t ) {ψ}_{j} ( t ) \vert\end{matrix}$$

which is the the ensemble average of the two point spatial cross-correlation of the abnormality vectors estimated over a time interval T. For i=j we have,

$${A}_{upper} ( i , i ) = 1 - {\sum }_{j \neq i} A ( i , j )$$

Using this transformation ensures that the maximum eigenvalue of the matrix Aᵤₚₚₑᵣ is 1. The entries of the matrix describe how the operator causes the components of the input abnormality vector to mix with each other. The matrix Aᵤₚₚₑᵣ is symmetric, real and the elements are non-negative and hence the solution to the characteristic equation:

Aᵤₚₚₑᵣ\vec{Φ}=λ\vec{Φ}

consists of orthogonal eigenvectors {\vec{φ}ᵢ}^{M}ᵢ₋₁ with eigenvalues {λᵢ}^{M}ᵢ₋₁. The eigenvectors obtained are normalized to form an orthonormal basis set and we can decompose any given input abnormality vector as:

$${\vec{ψ}}^{′} ( t ) = {\sum }_{i = 1}^{M} {c}_{i} {\vec{φ}}_{i}$$

where \vec{ψ}¹(t) is the transpose of the vector \vec{ψ}(t). Incorporating the spatial dependencies through the operator transforms the abnormality vector \vec{ψ}(t) as:

$${A}_{upper} {\vec{ψ}}^{′} ( t ) = {\sum }_{i = 1}^{M} {c}_{i} {λ}_{i} {\vec{φ}}_{i}$$

Here cᵢ measures the degree to which a given abnormality vector falls along the ith eigenvector. This value c, can be interpreted as a probability amplitude and c₁² as the probability of being in the ith eigenstate.

A subset of the eigenvectors {\vec{φ}ᵢ}^{M}ᵢ₋₁ where R≦M is called the fault vector set and can be used to define a faulty region. The fault vectors are chosen based on the magnitude of the components of the eigenvector. The eigenvector that has the components [1 1 1] is identified as the most faulty vector since it corresponds to maximum abnormality in all its components as defined in our fault model. In the fault model, high abnormality means abrupt changes as measured by the individual MIB sensors, and the [1 1 1] vector signifies the correlation of these variable level changes.

If a given input abnormality vector can be completely expressed as a linear combination of the fault vectors;

$${\vec{ψ}}^{′} ( t ) = {\sum }_{r = i}^{R} {c}_{r} {\vec{φ}}_{r}$$

then we say that the abnormality vector falls in the fault domain. The extent to which any given abnormality vector lies in the fault domain can be obtained in the following manner: Since any general abnormality vector \vec{ψ}(t) is normalized, the following condition is present,

$${\sum }_{i = 1}^{M} {c}_{i}^{2} = 1$$

As there are M different values for cᵢ, an average scalar measure of the transformation in the input abnormality vector is obtained by using the quadratic functional,

ƒ(\vec{ψ}(t))=\vec{ψ}(t)A\vec{ψ}¹(t).

The properties of this functional are described in the following section. Using the above equation and the Kronecker delta, we have:

$$\vec{ψ} ( t ) A \vec{ψ} ( t ) = {\sum }_{i = 1}^{M} {c}_{i}^{2} {λ}_{r} \\ = E ( λ )$$

The measure E(λ) is the indicator of the average abnormality in the network as perceived by the node. Now consider an input abnormality vector in the fault domain. Hence, we obtain a bound for E(λ) as:

$${min}_{r ∈ R} ( {λ}_{r} ) \leq E ( λ ) \leq {max}_{r ∈ R} ( {λ}_{r} )$$

where λᵣ are the eigenvalues corresponding to the set of R fault vectors. Thus using these bounds on the functional ƒ(\vec{ψ}(t)) an alarm is declared when

$$E ( λ ) > {min}_{r ∈ R} ( {λ}_{r} )$$

The maximum eigenvalue of Aᵤₚₚₑᵣ is 1, and it is by design associated with the most faulty eigenvector. In the following discussion, min_{rεR}(λᵣ)=λ_{ƒmin} and max_{rεR}(λᵣ)=λ_{ƒmax}.

Properties of the Quadratic Functional

Consider the case of M=3. We have the operator matrix A and the input abnormality vector as shown:

$$A = [ \begin{matrix}{a}_{11} & {a}_{12} & {a}_{13} & 0 \\ {a}_{21} & {a}_{22} & {a}_{23} & 0 \\ {a}_{31} & {a}_{32} & {a}_{33} & 0 \\ 0 & 0 & 0 & {a}_{44}\end{matrix} ]$$

$$\vec{ψ} ( t ) = α ⌊ \begin{matrix}{ψ}_{1} ( t ) & {ψ}_{2} ( t ) & {ψ}_{3} ( t ) & {ψ}_{0} ( t ) ]\end{matrix}$$

Here |aᵢⱼ|≦1 for all i and j and α is the normalization constant. As discussed in the previous section, since there is no interaction between the abnormal and normal states, only the upper block of the operator matrix is considered. Hence:

$${A}_{upper} = [ \begin{matrix}1 - {a}_{12} - {a}_{13} & {a}_{12} & {a}_{13} \\ {a}_{21} & 1 - {a}_{21} - {a}_{23} & {a}_{23} \\ {a}_{31} & {a}_{32} & 1 - {a}_{31} - {a}_{32}\end{matrix} ]$$

A few examples will be presented to demonstrate the properties of the functional ƒ(\vec{ψ}(t)). In the event of a fault (extreme case), according to the present fault model, correlated changes occur in the abnormality indicators. These changes would result in a fault vector of the following form:

\vec{ψ}(t)=α[1110]

Then we have,

$${A}_{upper} {\vec{ψ}}^{′} ( t ) = α [ \begin{matrix}1 \\ 1 \\ 1\end{matrix} ]$$

The quadratic functional ƒ(\vec{ψ}(t))=\vec{ψ}(t)A\vec{ψ}¹(t). becomes,

\vec{ψ}(t)A\vec{ψ}=α²3.

By normalization, α=1/3^{-1/2}, therefore ƒ(\vec{ψ}(t))=1. Note that in this case, the magnitude of the fault vector and the value of the functional are the same.

Now consider the case in which a random uncorrelated change occurs in only one of the abnormality indicators. In this case the input abnormality vector would be,

\vec{ψ}(t)=1/3^{-1/2}[1 0 0 2^{-1/2]}

The fourth component of this vector contains the normal component which is required to normalize the input abnormality vector. Now we have

$${A}_{upper} {\vec{ψ}}^{′} ( t ) = \frac{1}{\sqrt{3}} [ \begin{matrix}{a}_{11} \\ {a}_{21} \\ {a}_{31}\end{matrix} ]$$

$$f ( {\vec{ψ}}^{′} ( t ) ) = \begin{matrix}\frac{{a}_{11}}{3} \\ < \frac{1}{3} \\ ⪡ \vec{ψ} ( t ) \cdot \vec{ψ} ( t )\end{matrix}$$

Note α₁₁=1−α12−α13. Hence, in the event of an uncorrelated random change, the value of the functional is much smaller than the magnitude of the input vector.

Therefore using the functional ƒ(\vec{ψ}(t)) we obtain a scalar quantity with the following properties:

(1) The value of the functional ranges from 0 to 1.

(2) In the event of correlated changes the value of the functional goes to 1.

(3) In the event of random uncorrelated changes the functional has a value much smaller than 1.

Thus the quadratic functional has the required properties to identify faults as described by our model by enhancing the correlated changes and deemphasizing the uncorrelated changes associated with the normal functions of the network.

Operator for the Network Level Agent: Aᵢₚ

In order to design an operator for the network level agent we assume that the correlation under normal situations indicate the correlation at fault times as well. Therefore we can use the correlation matrix to design the operator. At the router three variables (viz) ipIR, ipIDe, and ipOR are considered. Including the normal probability, a 1×4 input vector was required:

\vec{ψ}ᵢₚ(t)=α_{R}[ψ_{IR}(t)ψ_{IDe}(t)ψ_{OR}(t)ψᵢₚ_{ₙₒᵣₘₐₗ}(t)].

The input vector corresponding to a completely faulty state is \vec{ψ}=α_{R}[1 1 1 0]

The fourth component is 0₁ since the system is completely faulty. Using this vector the normalization constant α_{R} for the router was calculated to be ⅓^{-1/2}.

The appropriate operator matrix Aᵢₚ will be 4×4. Taking the normal state to be un coupled to the abnormal states we get a block diagonal matrix with a 3×3 upper block Aᵢₚᵤₚₚₑᵣ and a 1×1 lower block:

$${A}_{ip} = [ \begin{matrix}{a}_{11} & {a}_{12} & {a}_{13} & 0 \\ {a}_{21} & {a}_{22} & {a}_{23} & 0 \\ {a}_{31} & {a}_{32} & {a}_{33} & 0 \\ 0 & 0 & 0 & {a}_{44}\end{matrix} ]$$

The α₄₄ element indicates the contribution of the healthy state to the indicator of abnormality for the network node (E[λ]). Since the healthy state should not contribute to the abnormality indicator, we assigned α₄₄=0. The elements aₘₙ of Aᵢₚᵤₚₚₑᵣ are estimated based on the spatial correlation between the abnormality indicators. The coupling for the ipIR variable with ipOR and ipIDe variables (a₁₂ and a₁₃) are estimated as 0.08 and 0.05, respectively This weak correlation can be explained because the majority of packets received by the router are forwarded at the ip layer and not sent to the higher layers. The coupling between ipIDe and ipOR (a₂₃) is significantly higher since both variables relate to router processing which is performed at the higher layers. By symmetry: a₂₁=a₁₂, a₃₁=₁₃ and a₂₃−=a₃₂. The main diagonal terms are assigned such that the rows and columns sum to 1. Thus, Aᵢₚᵤₚₚₑᵣ matrix becomes:

$${A}_{{ip}_{upper}} = [ \begin{matrix}0.87 & 0.08 & 0.05 \\ 0.08 & 0.6 & 0.32 \\ 0.05 & 0.32 & 0.63\end{matrix} ]$$

The elements of the matrix are calculated according the above equations and using an 8 hour data trace from the campus network. (The values obtained for the enterprise network data were the same as those for the campus network). Note, that the lower block does not affect the indicator of network abnormality. Hence the computation only uses the upper block. Therefore, the above equation becomes:

E[λ]=\vec{ψ}ᵤₚₚₑᵣ(t)Aᵢₚ_{ᵤₚₚₑᵣ}\vec{ψ}ᵤₚₚₑᵣ(t)

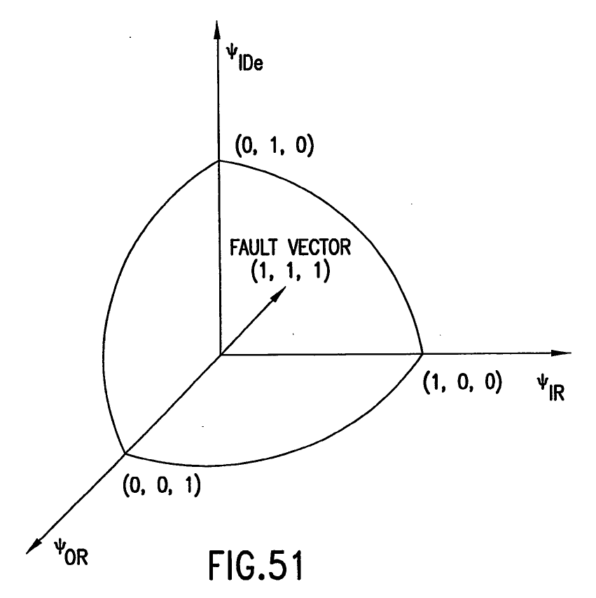

The eigenvalues of the upper block matrix are Aᵢₚᵤₚₚₑᵣ are λ₁=0.2937, λ₂=0.8063, and λ₃=1. The corresponding eigenvectors are \vec{φ}₁=[−0.0414 0.7169 −0.6855]. \vec{φ} ₂.=[0.8154 −0.3718 −0.4436], and \vec{φ}₃.=[0.5774 0.5774 0.5774]. The fourth eigenvector, which is not shown is \vec{φ} ₄.=[0 0 0 1] with eigenvalue λ₄=0. The portion of the sphere shown in the first sector of the three dimensional space in FIG. 51 represents the problem domain. This is because the input variables to the fusion center range from 0 to 1. The eigenvector ₃. corresponds to the total fault vector (all components abnormal) and is present at the center of the problem domain. Eigenvectors ₁. and ₂. are necessarily outside the problem domain since they must be orthogonal to ₃. Thus in the present problem, unlike in Quantum Mechanics, two of the eigenvectors are outside the problem domain: however projections of the input abnormality vector onto ₁ and ₂ are allowed. The eigenvectors ₂ and ₃ are used to define the faulty region of the space. The vector ₂ is chosen since it has the highest value in the first component. This component represents the I . pIR abnormality indicator. Since the system studied is a router, the ipIR variable samples the majority of the traffic passing through the router.

A fault is declared when E[λ] falls between λ₂=0.8063 and λ₃=1. Note that input vectors which are not composed exclusively by \vec{φ}₂ and/or \vec{φ}₃ could still yield an E[λ]>λ₂, but these vectors would necessarily have large projections on \vec{φ}₂ and/or \vec{φ}₃. The abnormal region is defined as: E[λ]=\vec{ψ}ᵤₚₚₑᵣ(t)Aᵢₚ_{ᵤₚₚₑᵣ}\vec{ψ}ᵤₚₚₑᵣ(t)

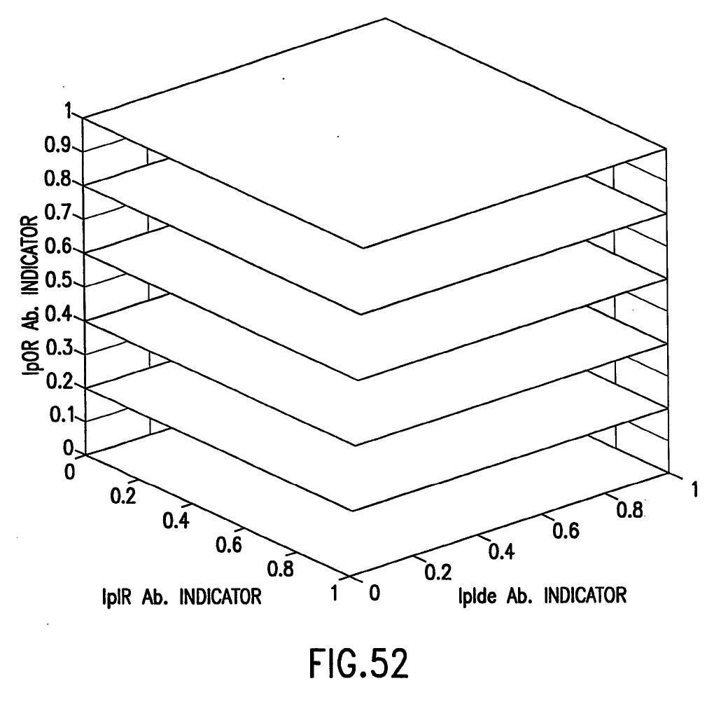

FIG. 52 shows the range of the average abnormality in the system by the variation in color. When all the components of the input abnormality vector \vec{ψ}(t) (viz, ψ_{IR}(t), ψ_{IDe} and ψ_{OR}(t)), and are 1, ((i.e.) for maximum correlation of abnormality indicators), the average abnormality corresponds to the maximum eigenvalue 1. This maximum value is depicted by the dark red color. Note that as the values of the abnormality indicators decrease in their correlations and/or magnitude the red hue decreases.

Operator for the Interface Level Agent: A_{if}

At the interface we consider two variables (viz) ifIO, and ifOO. Therefore, including the normal state, the input vector is 1×3.

\vec{ψ}_{if}(t)=α₁[ψ_{IO}(t)ψ_{OO}(t)ψ_{if}_{ₙₒᵣₘₐₗ}(t)]

The input vector that corresponds to the maximum abnormality is \vec{ψ}_{if}(t)=α₁[1 1 0]. Therefore the normalization constant α_{I} for the interface agent is operator matrix Aif is designed as explained in the case of a router but now, we have a 3×3 matrix.

$${A}_{if} = [ \begin{matrix}0.99 & 0.01 & 0 \\ 0.01 & 0.99 & 0 \\ 0 & 0 & 0\end{matrix} ]$$

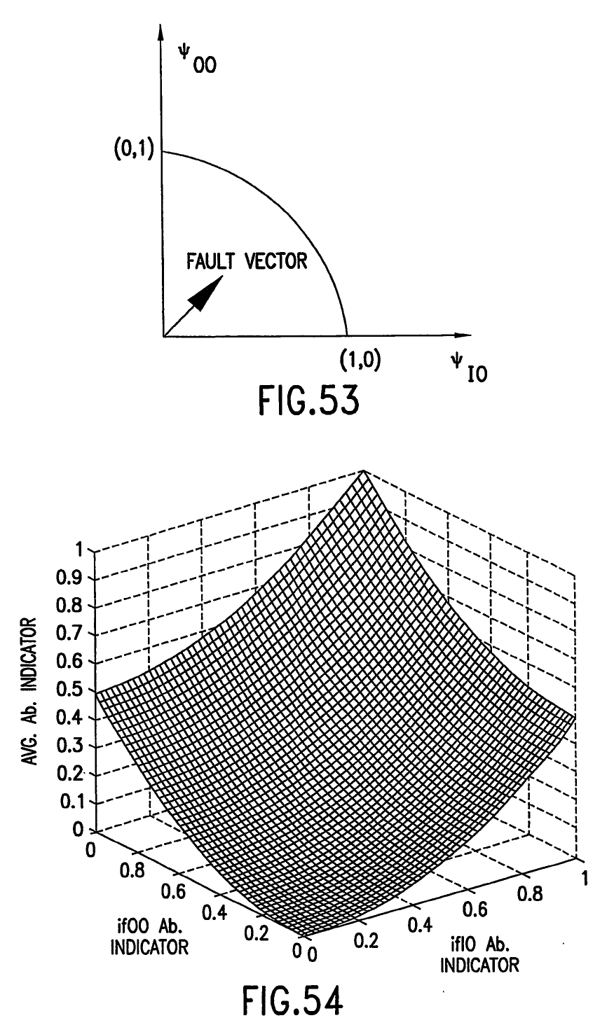

The elements of the operator matrix have been estimated in a manner analogous to the method used for Aᵢₚ. However the two variables considered here are not highly coupled since they correspond to the number of octets that come into and go out of a particular interface. The eigenvalues of the upper block matrix A_{ifupper} are λ₁=0.98, and λ₂=1. The corresponding eigenvectors of the upper block are \vec{φ}₁[0.7071 −0.7071], and \vec{φ}₂=[0.7071 0.7071]. The third eigenvector is \vec{φ}₃=[0 0 1] with eigenvalue λ₃=0. The sector shown in the first quadrant of the two dimensional space in FIG. 53 is the problem domain and the fault vectors are \vec{φ}₁ and \vec{φ}₂. The corresponding abnormality domain equation is:

λ₁t<E[λ]≦λ₂ [symbol] abnormal region

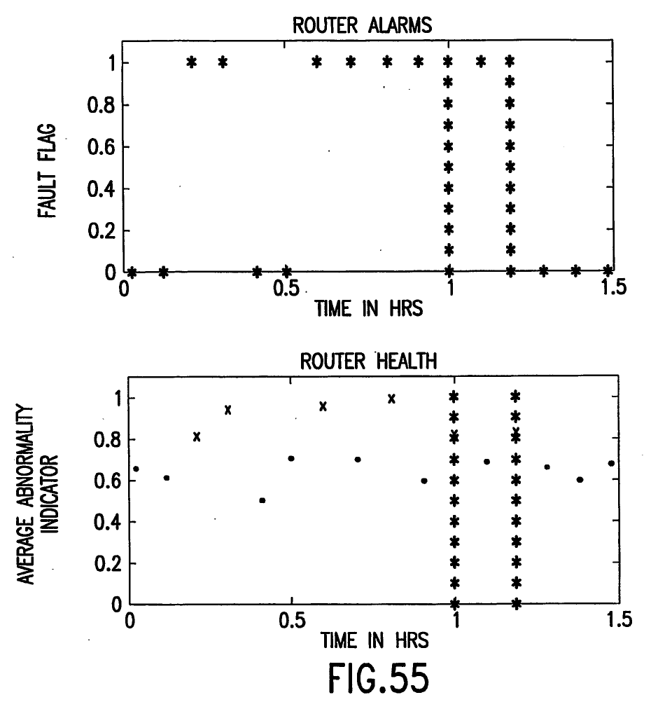

In FIG. 54, the average abnormality values for the entire problem domain for the if layer are shown. When both the input components of the abnormality vector are 1 we have a maximum for the average abnormality indicator.

Combining Severity and Persistence of Alarms

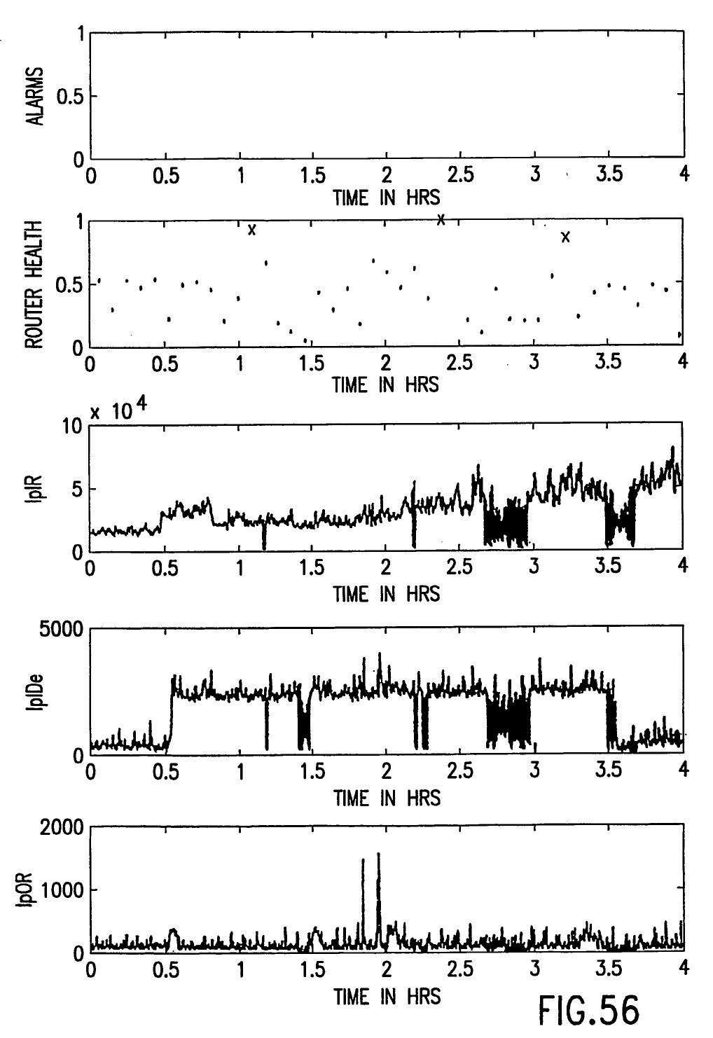

It is observed that prior to fault situations the average abnormality indicator or the correlated abrupt changes exhibited a persistent abnormal behavior. On the contrary, at no fault situations, there is a lack of persistence. Persistence is defined as, given an instance of high average abnormality or alarm condition, a second instance of an alarm occurs within a specified interval of (τ−1) lags. This persistence behavior can be taken advantage of to declare alarms corresponding to network fault situations. By incorporating persistence, we a-re able to significantly reduce the number of false alarms. As seen from the FIG. 55, there exists a persistence in the alarms just prior to the fault situation denoted by the asterisks. However in FIG. 56 the alarms obtained are not persistent and there was no fault situation recorded at this time. Note, that the router health does show some potential alarms due to the correlated changes in the traffic patterns across the different MIB variables. However, the correlated change in traffic patterns do not persist for more than a single instant. Thus by incorporating persistence a large number of false alarms can be filtered.

Experimental Results

Initially, the issues involved in the data collection process are discussed. Analytical and experimental results on the impact of the data collection processes on the performance of the network is provided. Four case studies of faults detected by the agent on two different networks is provided: one from a campus LAN network and three from an enterprise network.

Data Collection

Preliminary studies on the data collection mechanism have been done at Renselaer Polytechnic Institute (RPI). The impact of the data collection mechanism on two important aspects of the network, CPU utilization and network load were evaluated. This is a crucial step to ensure that the monitoring of the network is done in an unobstrusive manner. The experimental results are compared with analytic results. It is shown that the analytic results provide an upper bound and can be safely used to conservatively estimate the impact of the data collection on the CPU in any generic environment. The experimental set up and the details of the results are presented.

Fxperimental Setup

The data collection was performed on a local network 200 (shown in FIG. 57) at the Networks Lab at RPI. The SNMP daemon was installed on the internal router (Poisson in FIG. 57) in the lab. Poisson 17 is a Sun Ultra SPARC station running Solaris. The data collection mechanism consists of software which runs on another machine 19 (Erlang in FIG. 57) and queries the MIB database at regular intervals of τ seconds. The query is done using the “snmget” function that is provided along with the SNMP manager software. The experiment was run for polling intervals of τ=1, 10, 15, 30, and 60 s. Each experiment was run for durations of 2400 s (50 min) and 7200 s (2 hrs) for each polling interval τ.

CPU Utilization

One of the most important concerns in querying a database at a router is the impact on the router's CPU. For a generic machine the CPU utilization can be computed using the below equation.

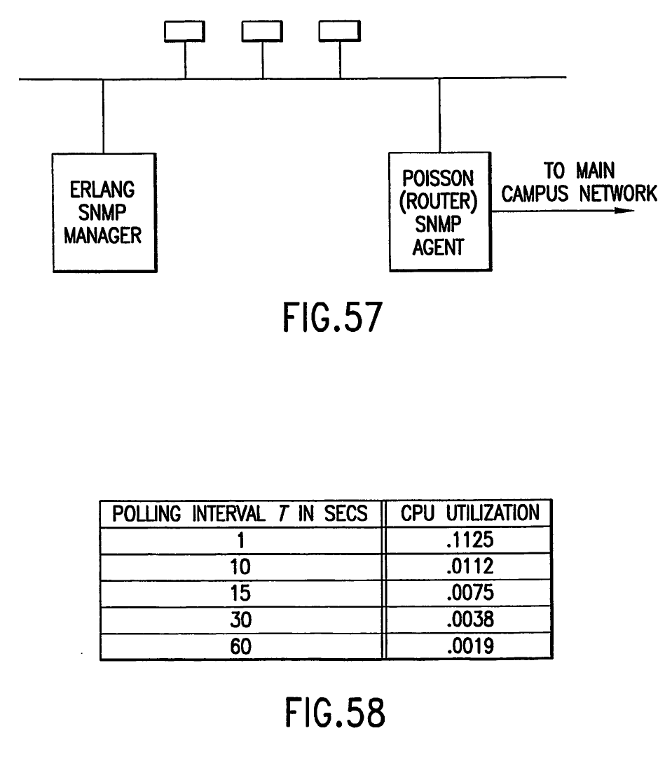

CPU utilization=n*d/T

where n=number of agents polled, d=max{dᵢ} where dᵢ=time required to process the required request/response for the ith agent, and T=polling interval in seconds. The analytical results were evaluated using n=1, since only one agent is polled. The results are tabulated in FIG. 58. Note: The value of d was experimentally determined to be 0.1125 s. This was the maximum time taken by the CPU to process one query on the single agent at which the data was collected. Using the maximum value of d provides a conservative bound on the CPU utilization.

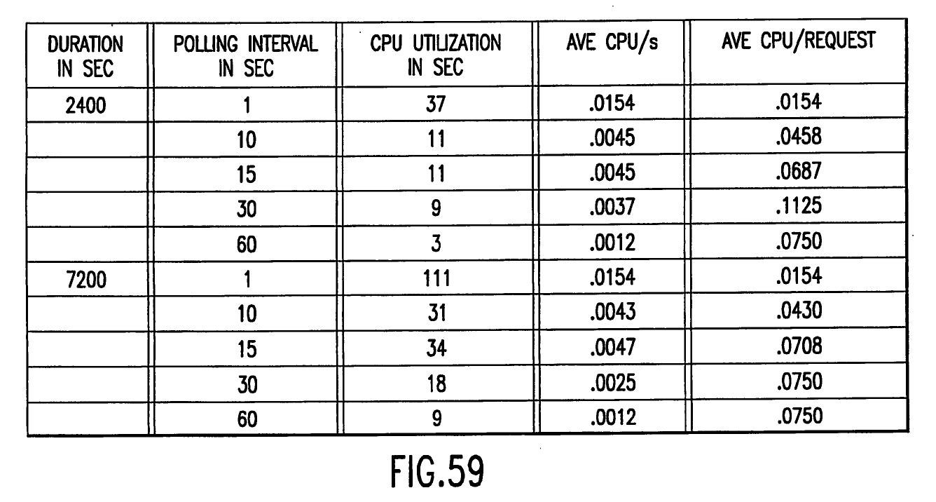

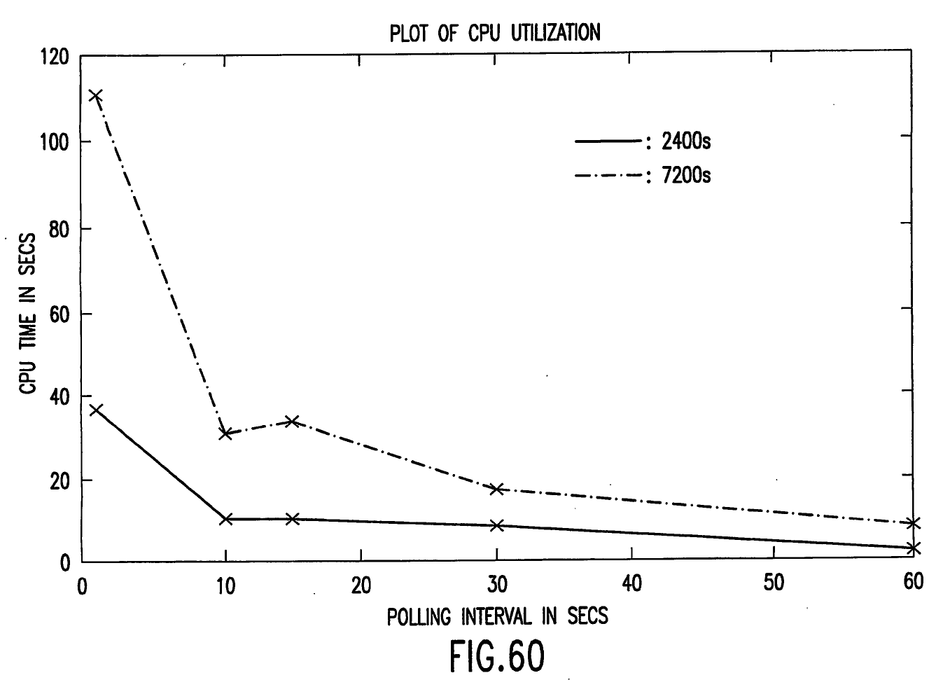

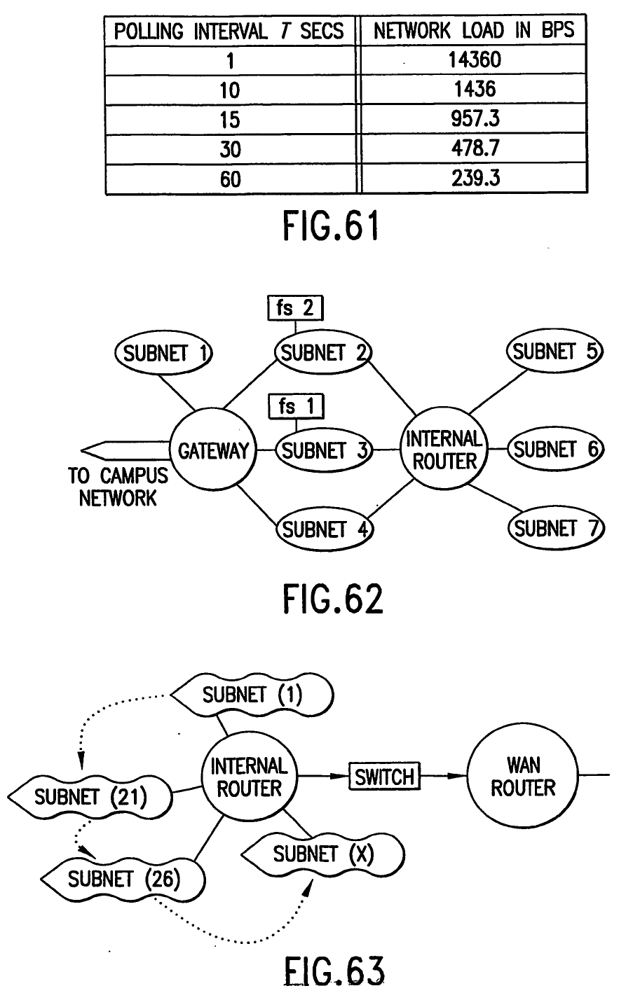

The experimental results are tabulated in FIG. 59. The CPU utilization was obtained using the “Ps” command on the UNIX. The average CPU utilization per second and the average CPU utilization per request are also tabulated. The CPU utilization for the different polling intervals is shown in FIG. 60. It is observed that page faults played a role in the performance. Although the average CPU utilization/s tends to go down as the polling interval gets longer, the average CPU utilization/request goes up, since the longer the interval the longer is the setup time to get up the daemon back into memory. Since 10 and 15 seconds are rather dose to one another we see very dose results and they are near the gap between frequently paging and mostly paging. This is also due to the fact that only one second resolution is present. It is assumed that almost never paging generates an average CPU utilization of 0.154 s and always paging generates an average CPU utilization of 0.0750 s. It is seen that at a 10 second interval paging is performed about 43% of the time and at a 15 second interval paging is performed about 86% of the time. Thus, in all the cases, the analytic values upper bound the experimental results.

Network Load

The network utilization can be computed using the following equation:

Network load=(RQ+RS)*8/T

where RQ=size of a request in bytes, RS=size of a response in bytes, and T=polling interval in seconds. The values used in the computation of network load are RQ=849 bytes and RS=946 bytes. The values of RQ and RS were experimentally obtained using the application “tcpdump-e”. Here all the request messages were 849 bytes and all response messages were 946 bytes. Unlike the bounding results obtained in the case of CPU utilization, the results for network load are exact.

Summary on Data Collection

From the experiments conducted and the analysis performed the following conclusions are made:

1. The analytical results provide an upper bound on the CPU utilization.

2. The load on the network is very minimal at polling intervals of 10 or more seconds.

3. The average CPU utilization is approximately 1% or less.

All these above observations provide sound justification that the data collection mechanism will not seriously impact network performance.

Field Testing of the Agent

The intelligent agent has been tested on two different production networks: (1) a campus network and (2) an enterprise network. The two networks differ significantly in terms of their traffic patterns and also the topology and size of their network. In this section the characteristics of each of these networks are described.

Campus LAN Network

The experiments were conducted on the Local Area Network (LAN) of the Computer Science (CS) Department at Rensselaer Polytechnic Institute. The network topology is as shown in FIG. 62. The CS network forms one subnet of the main campus network. The network implements the IEEE 802.3 standard. Within the CS network there are seven smaller subnets 7a-7g and two routers 1a, 1b. All of the subnets 7a-7g use some form of CSMA (Caxrier Sense Multiple Access) for transmission. The routers 1a, 1b implement a version of the Dijkstra's algorithm. One router (shown as router 1b in FIG. 62) is used for internal routing and the other serves mainly as a gateway (shown as router 1a) to the campus backbone. The external router or gateway also provides some limited amount of internal routing. These syslog messages were used to identify network problems. One of the most common network problems was NFS server not responding. Possible reasons for this problem are unavailability of network path or that the server was down. The syslog messages only reported that the file server was not responding after the server had crashed. Although not all problems could be associated with syslog messages, those problems which were identified by syslog messages were accurately correlated with fault incidents.

Enterprise Network

The topology of the enterprise network 300 is as shown in FIG. 63. This network 300 was significantly larger than the campus network. Each individual subnet was connected by the internal router 16 which also hosts an SNMP agent. Data was collected from the interface of subnet 26 and subnet 21 with the internal router and at the router itself. The existing network management scheme consisted of a trouble ticketing system which contained problem descriptions as reported by the end users. Syslog messages were also reported.

Implementation Specifications

The parameters of the algorithm that are obtained for this design are:

p: the order of the AR process

N_{L} and N_{τ}: learning and test window sizes

Aᵢₚ and A_{if}: operator matrices for the ip and if level agents.

τ: the persistence time.

The parameter obtained through online learning are:

α₁: the AR parameter.

Case Studies of Typical Faults

In this section one specific fault of the different types of faults observed in the two networks are described.

Case Study (1): File Server Failures

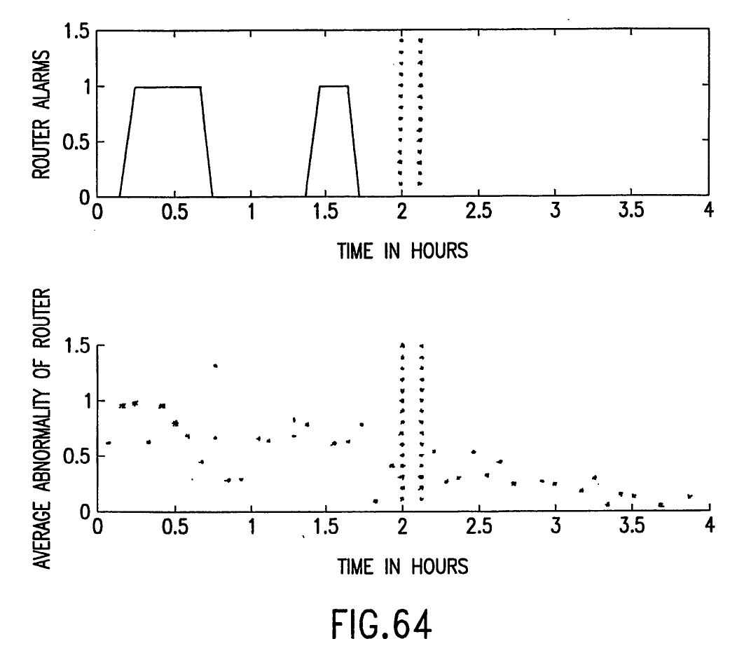

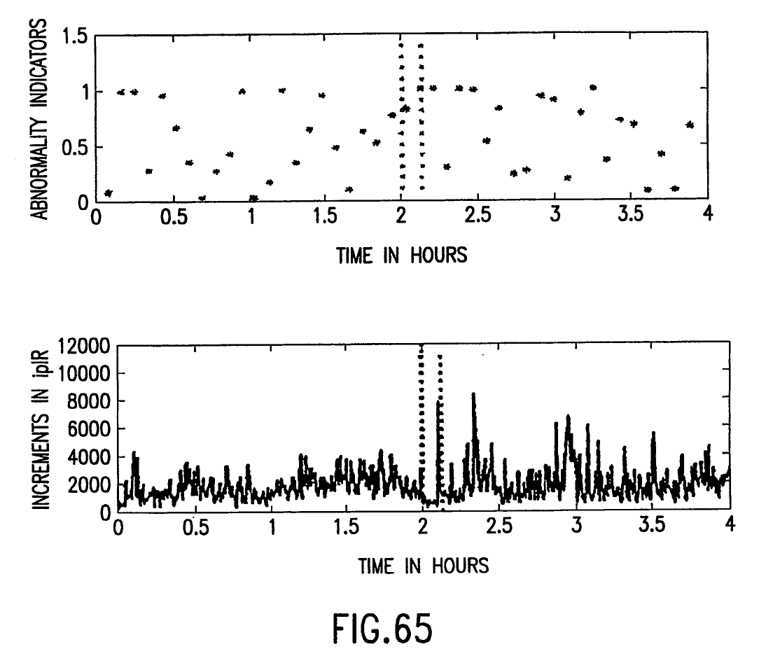

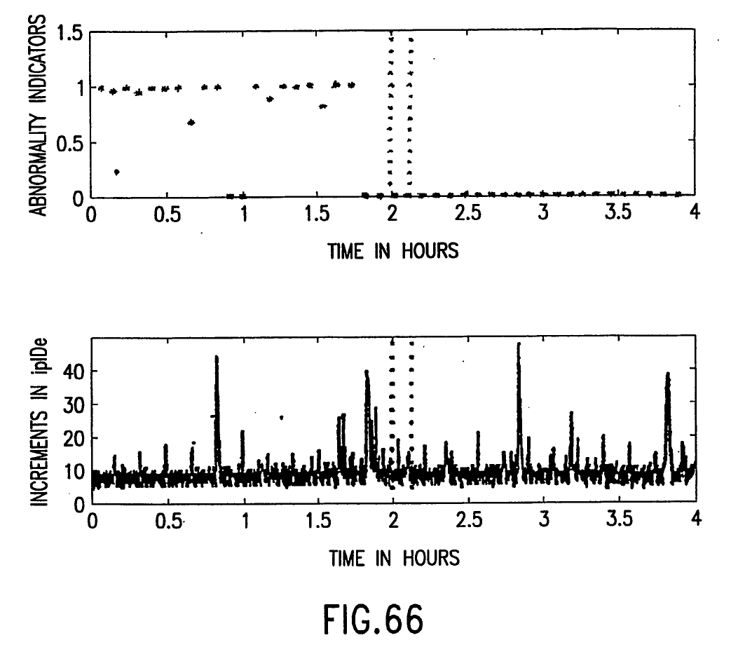

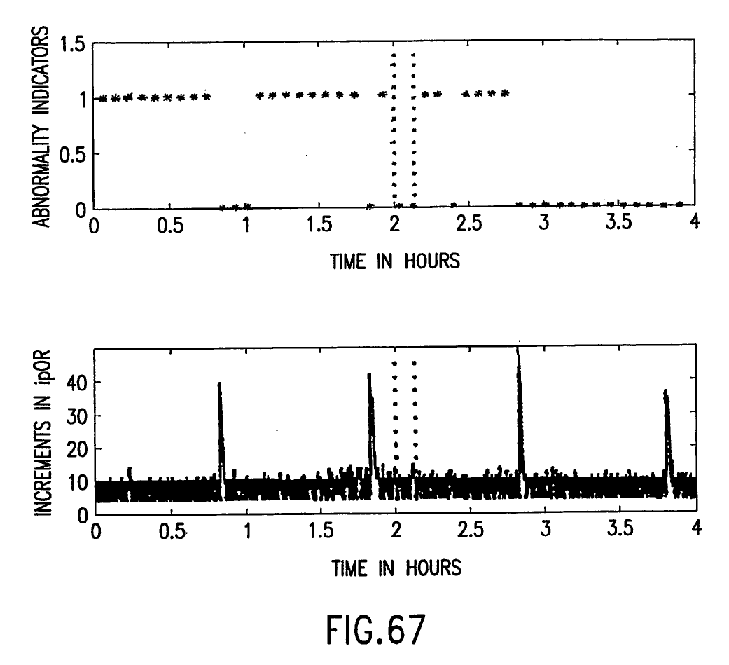

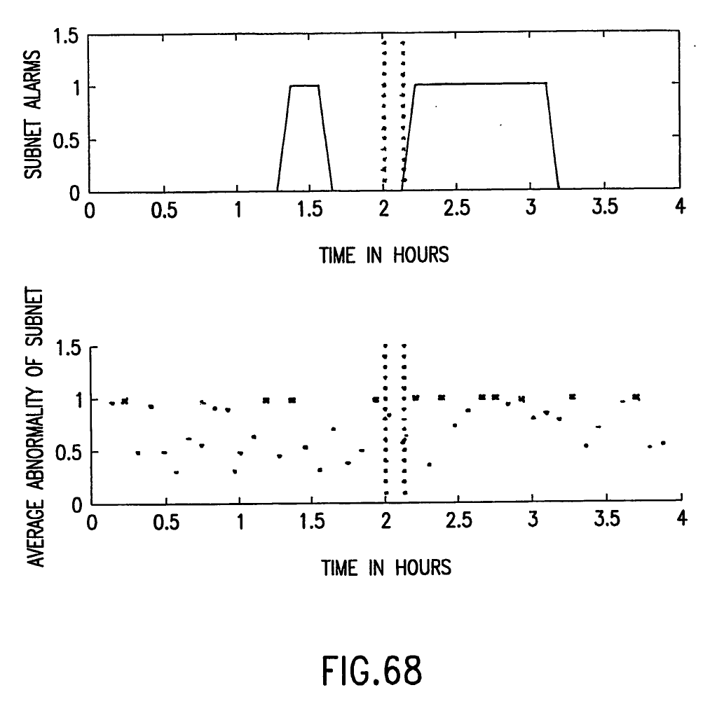

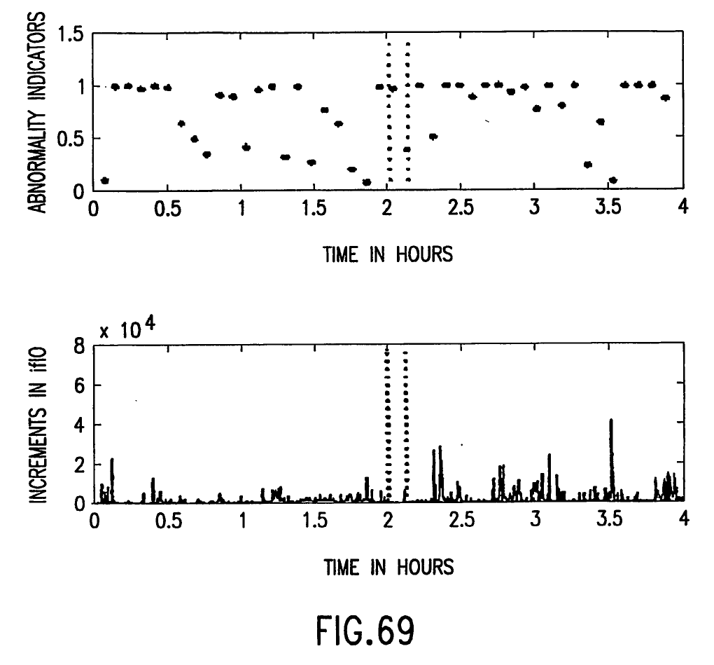

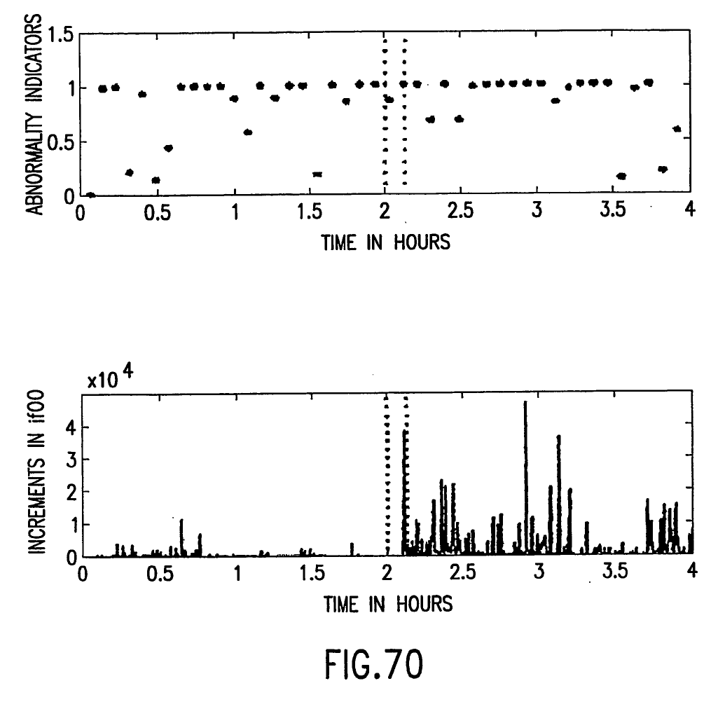

In this case study a fault scenario corresponding to a file server failure on subnet 2 of the campus network is described. This case represents a predictable network problem where the traffic related MIB variables show signs of abnormality before the occurrence of the failure. 12 machines on subnet 2 and 24 machines outside subnet 2 reported the problem via syslog messages. The duration of the fault was from 11:10 am to 11:17 am (7 mins) on Dec. 5, 1995 as determined by the syslog messages. The cause of the fault was confirmed to be excessive number of ftp requests to the specific file server. FIGS. 64 through 67 show the output of the intelligent agent at the router and at the ip layer variable level. Note that there is a drop in the mean level of the traffic in the ipIR variable prior to the fault. The indicators provide the trends in abnormality. The fault period is shown by the vertical dotted lines. In FIG. 64 for router health, the ‘x’ denotes the alarms that correspond to input vectors that are faulty. Note that there are very few such alarms at the router level. The fault was predicted 21 mins before the crash occurred. The mean time between false alarms in this case was found to be 1032 mins (approx 17 hrs). The persistence in the abnormal behavior of the router is also captured by the indicator. The on-off nature of the ipIDE and ipOR indicators was attributed to the less bursty behavior of those variables. The alarms generated at the interface level along with the variable-level abnormality indicators are shown in FIGS. 68 through 70. In both the if level variables we observe a significant drop in the mean traffic prior to the fault. The fault was predicted 27 mins before the file server crashed and the mean time between false alarms was 100 mins (approx 1.5 hrs). The bursty behavior of both the if variables results in an excessive number of false alarms generated at the output of the if agent. The fault was first predicted at the interface level (about 6 mins) prior to the router level. The alarms obtained approximately an hour and a half before the fault could also be associated with the same fault but there is no way to confirm. Thus the results obtained at the if agent can be used to confirm the alarms declared at the ip agent. Note, also that the subnet shows abnormal behavior soon after the fault. This was attributed to the hysteresis of the fault. In the present scheme, no measures are taken to combat this effect.

Case Study (2): Protocol Implementation Errors

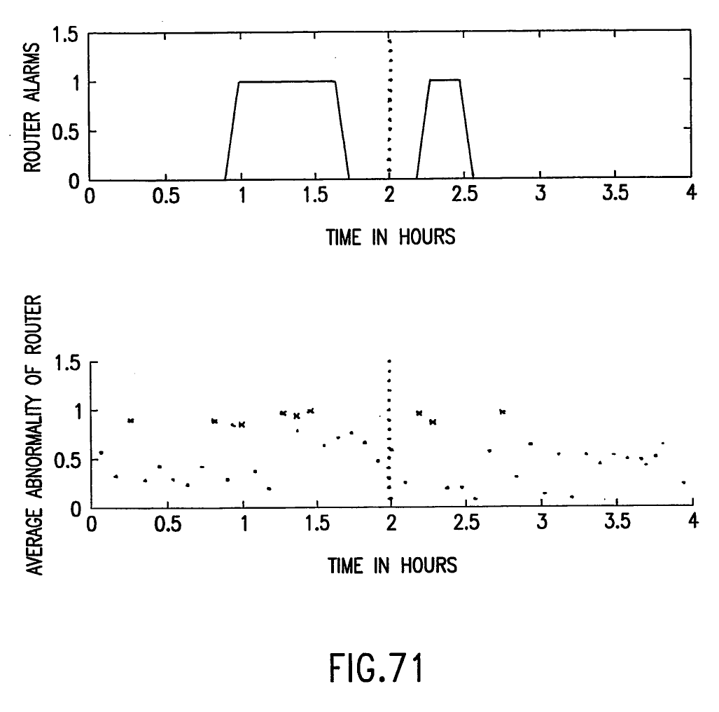

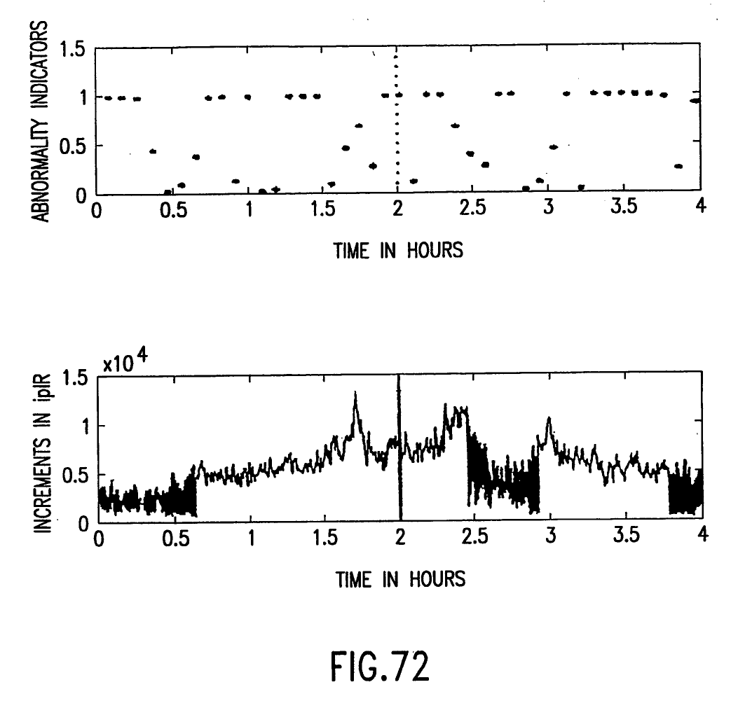

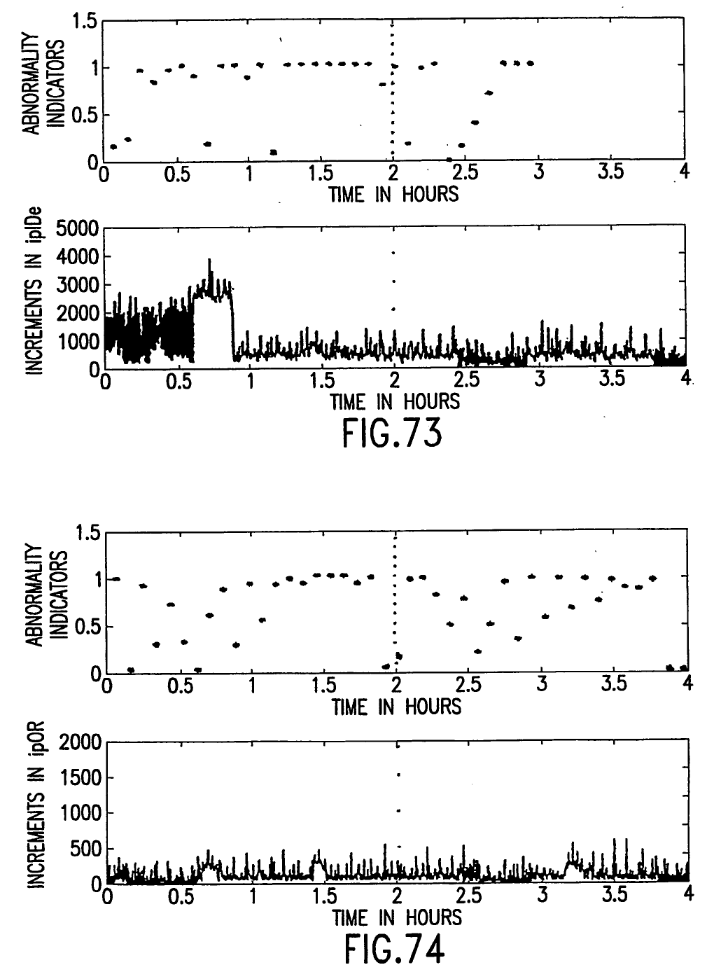

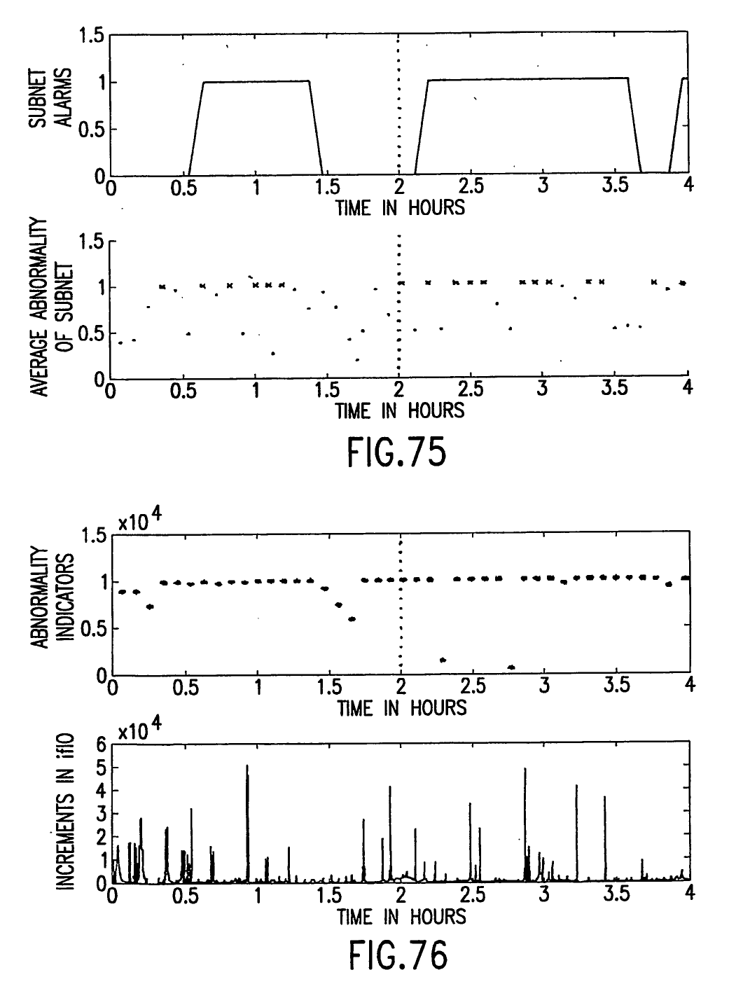

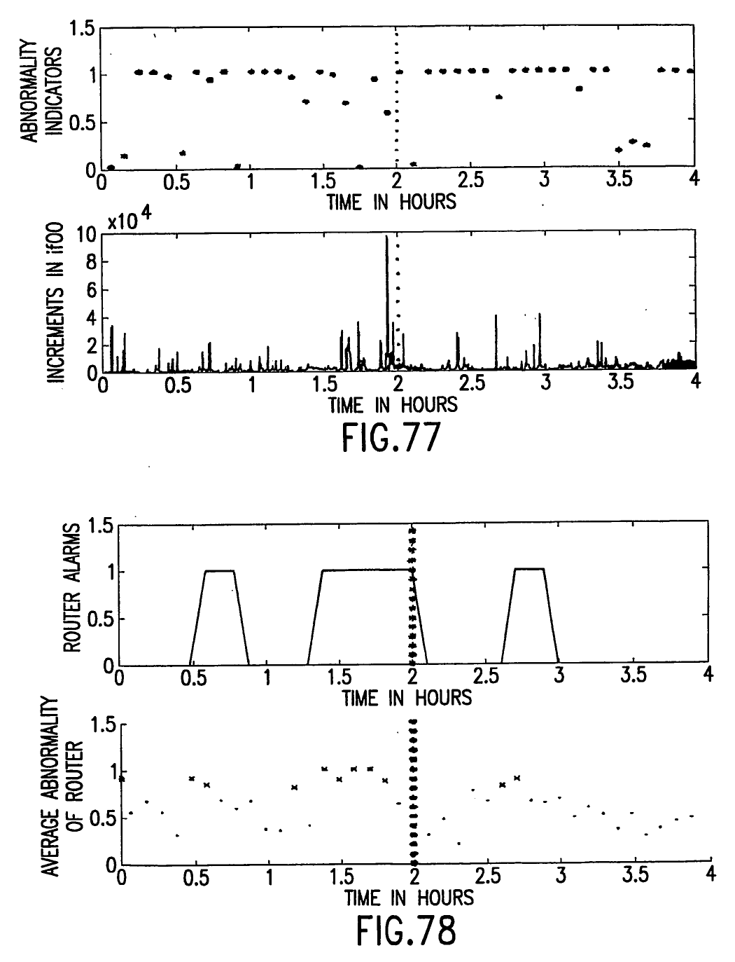

This fault case is one where the fault is not predictable but the symptoms of the fault can be observed. One of the faults detected on the enterprise network was a super server inetd protocol error. The super server is the server that listens for incoming requests for various network servers thus serving as a single daemon that handles all server requests from the clients. The existence of the fault was confirmed by syslog messages and trouble tickets. The syslog messages reported the inetd error. In addition to the inetd error other faulty daemon process messages were also reported during this time. Presumably these faulty daemon messages are related to the super server protocol error. The trouble tickets also reported problems at the time of the super server protocol error. These problems were the inability to connect to the web server, send mail, print on the network printer and also difficulty in logging onto the network. The super server protocol problem is of considerable interest since it affected the overall performance of the network for an extended period of time. The detection scheme performed well on this type of error. FIGS. 71 through 74 show the alarms generated at the router level. The prediction time (with respect to the syslog messages) was 15 mins with respect to the existing management schemes. The existing trouble ticketing scheme only responds to the fault situation and there is no adaptive learning capability. There were no false alarms reported in this data set. Persistent alarms were observed just before the fault. FIGS. 75 through 77 show the alarms generated at the subnet level (subnet 21), The prediction time was 32 mins. There was hysteresis effect observed soon after the fault. The mean time between false alarms was 116 mins. The alarms at the subnet occur in advance of those observed at the router suggesting a possible problem resolution to the subnet level. The fault may be presumed to have originated at the subnet and then propagated through the network. The origin of the fault in this case is the location of the super server, which we may infer based on the alarm sequences obtained to have been located on the subnet being monitored. This inference was confirmed to be true by consulting with the system administrator. The propagation through the network is the consequence of more and more clients trying to access applications that depend on the super server to

Case Study (3): Network Access Problems

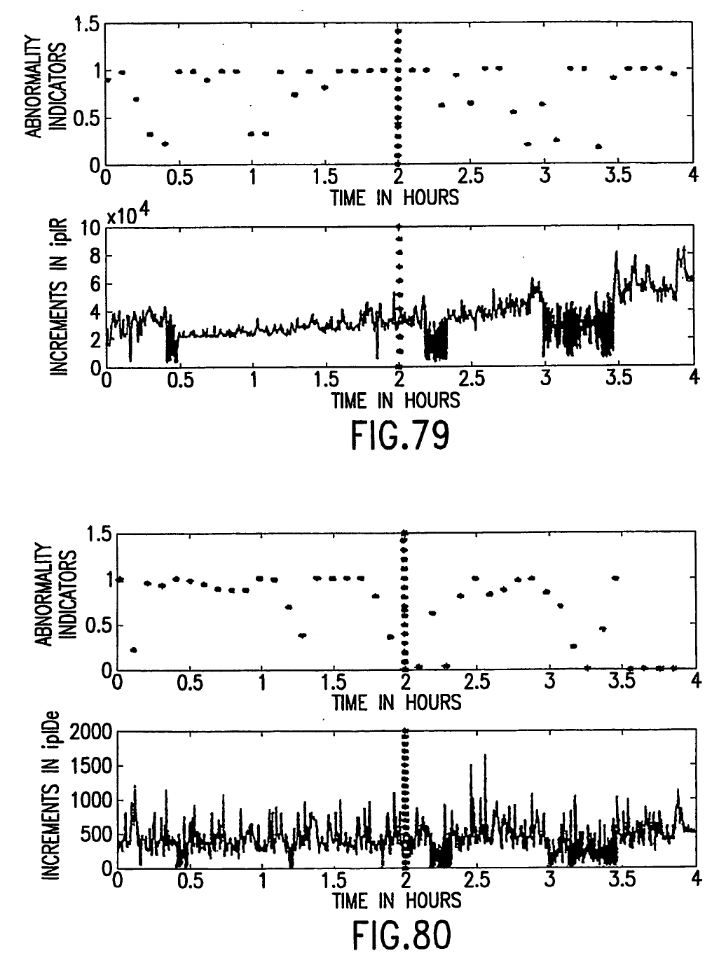

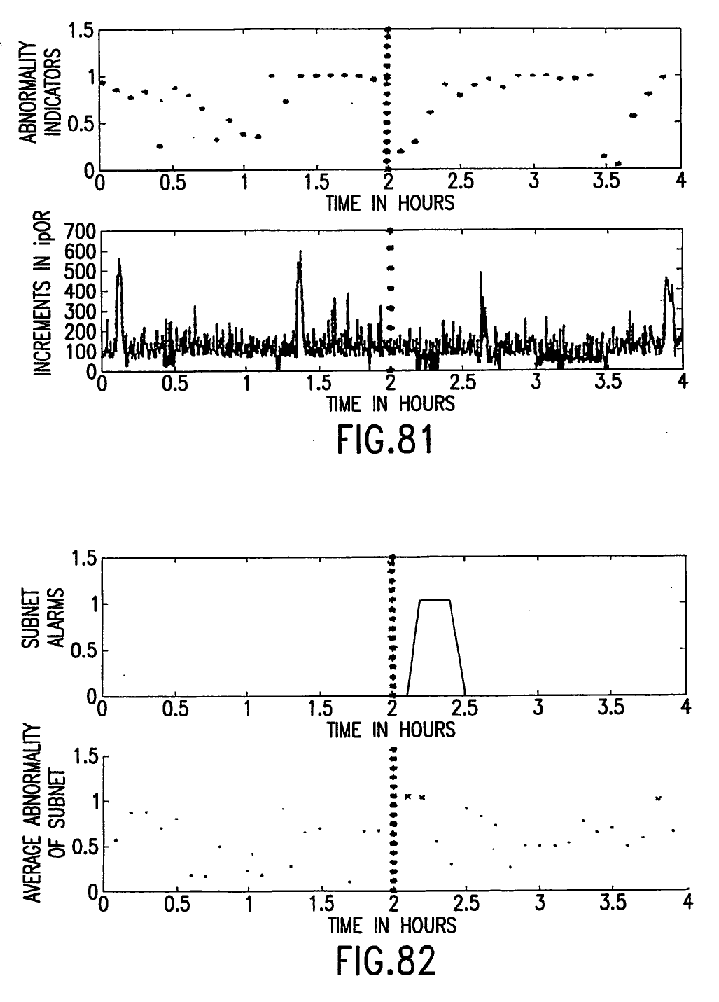

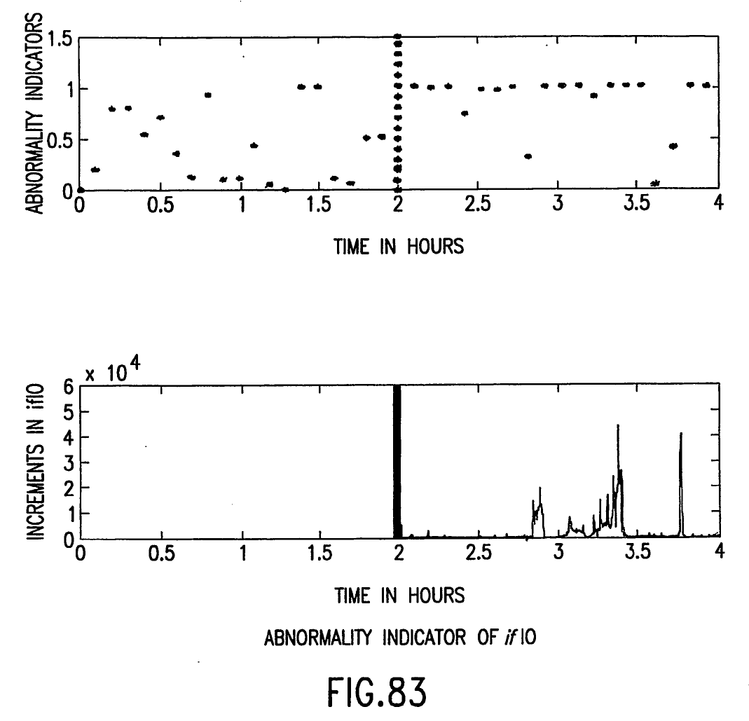

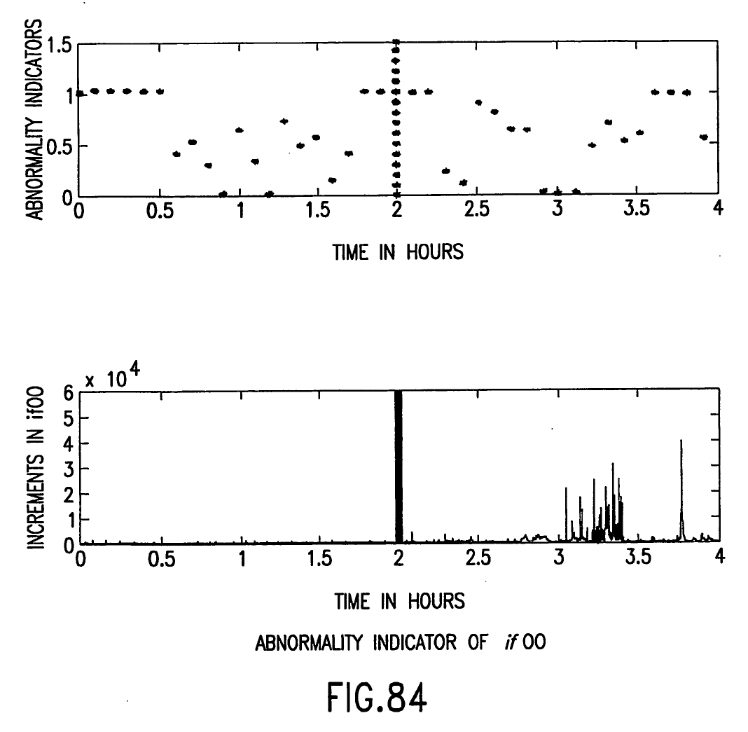

Network access problems are predictable. These problems were reported primarily in the trouble tickets. These faults were often not reported by the syslog messages. Due to the inherent reactive nature of trouble tickets, it is hard to determine the exact time when the problem occurred. The trouble reports received ranged from the network being slow to the inaccessibility of an entire network domain. FIGS. 78 through 81 show the alarms obtained at the router level. The prediction time was 6 mins. The mean time between false alarms was 286 mins. FIGS. 82 through 84 show the alarms obtained at the subnet 26 of the router. In this case the alarms were obtained 12 mins after the fault report was received. The mean time between false alarms was 269 mins.

Case Study (4): Runaway Processes

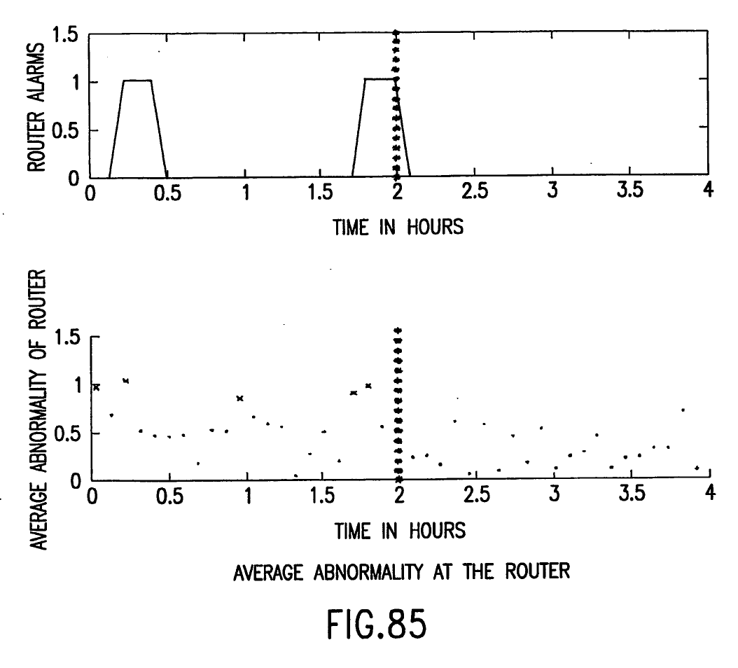

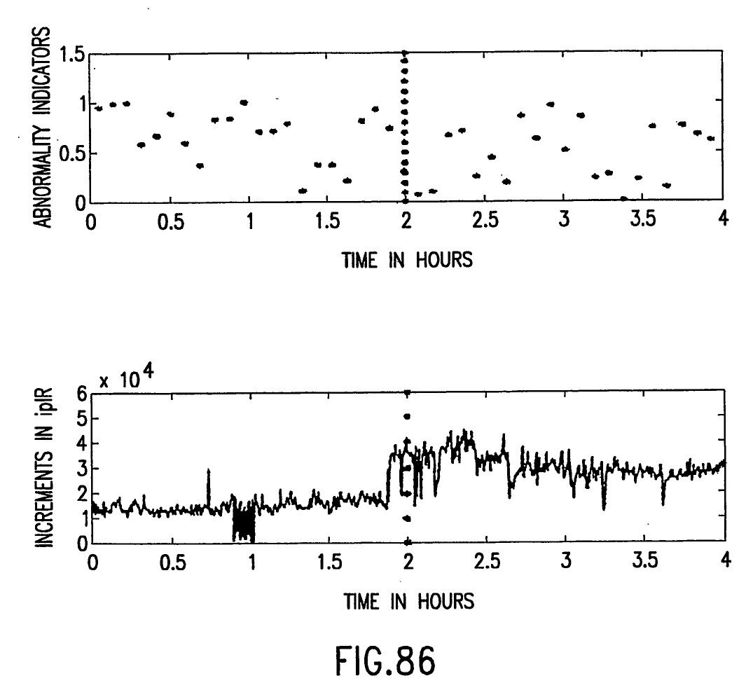

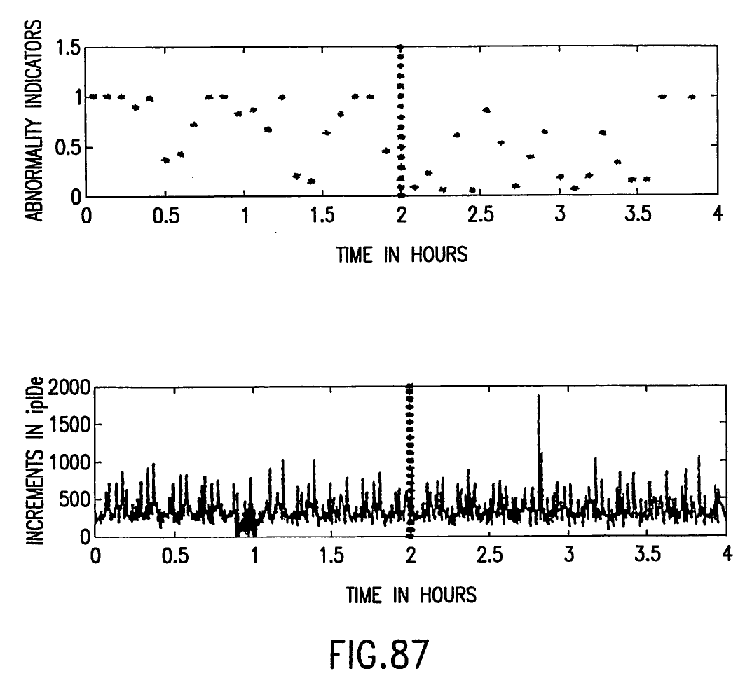

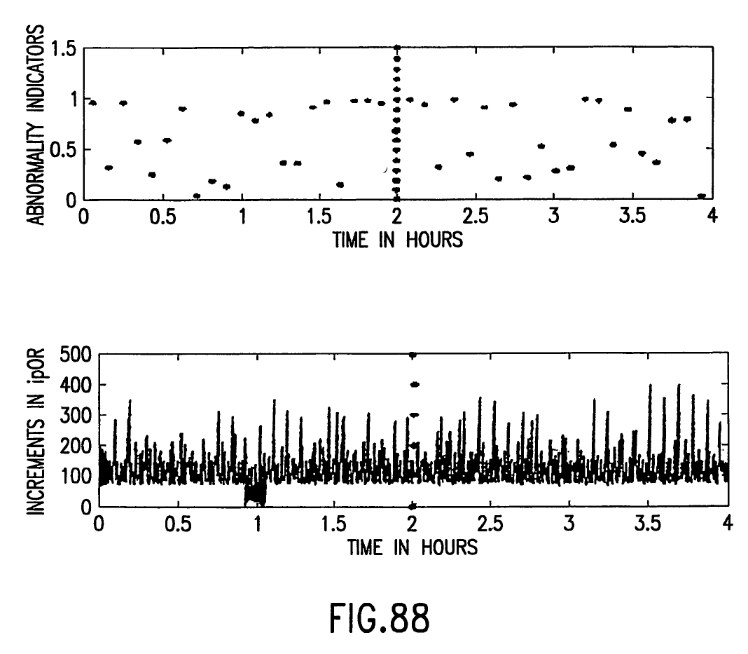

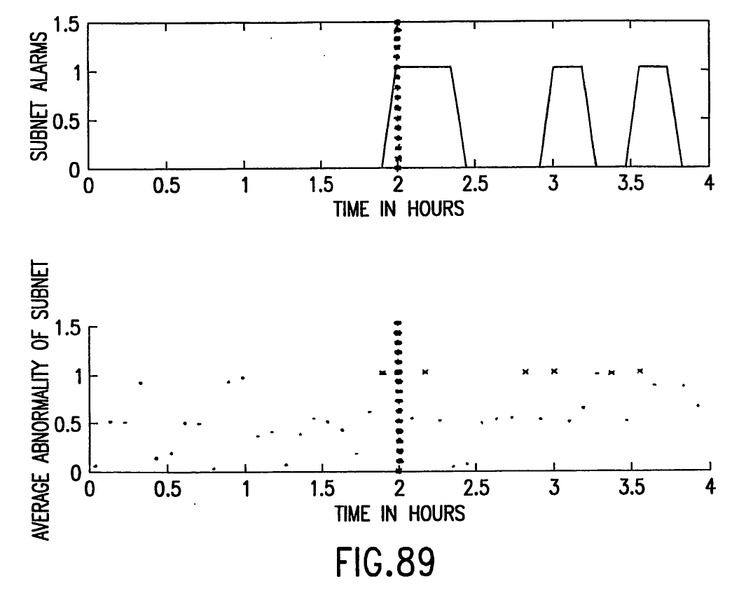

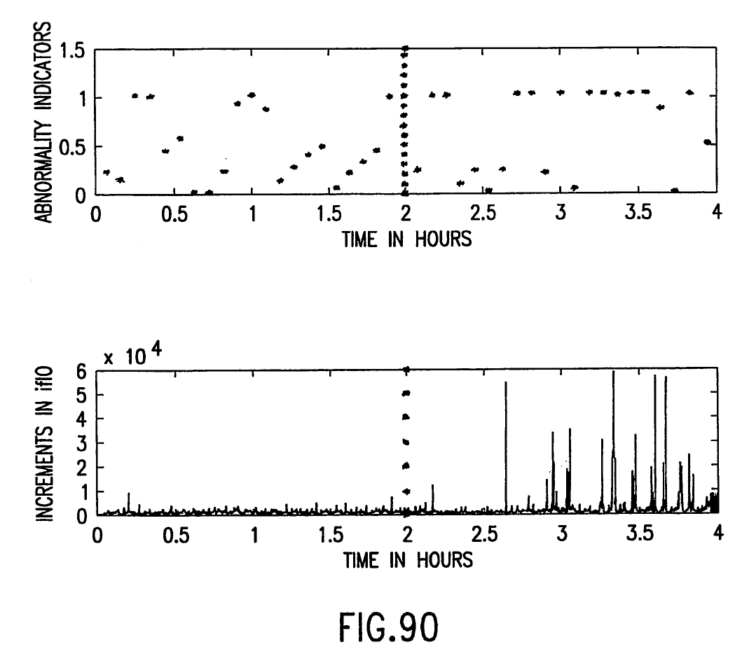

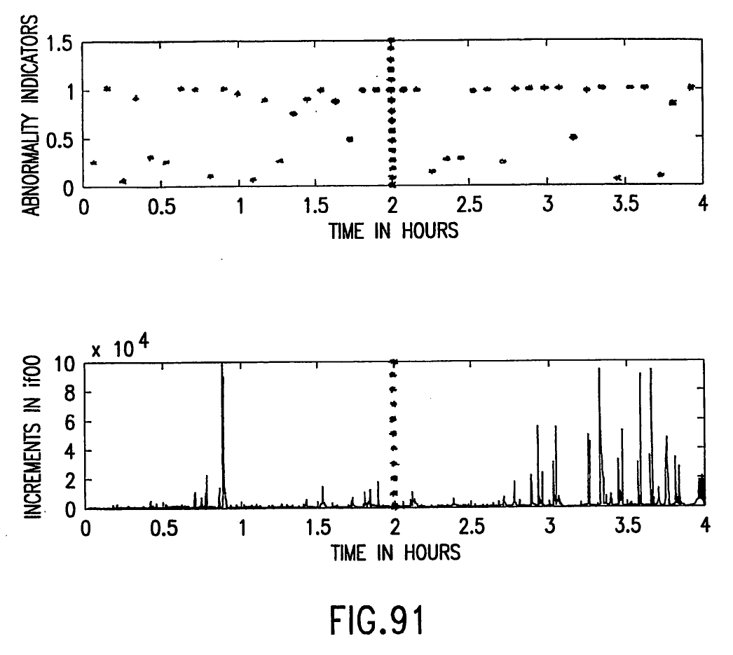

A runaway process is an example of high network utilization by some culprit user that affects network availability to other users on the network. Runaway process is an example of an unpredictable fault but whose symptoms can be used to detect an impending failure. This is a commonly occurring problem in most computation oriented network environments. Runaway processes are known to be a security risk to the network. This faulty was reported by the trouble tickets but much after the network had run out of the process identification numbers. In spite of having a large number of syslog messages generated during this period there was no clear indicator that a problem had occurred. FIGS. 85 through 88 show the performance of the agent in the detection of the runaway process. The prediction time was 1 min and the mean time between false alarms was 235 mins. FIGS. 89 through 91 show the alarms obtained at subnet 26 of the router. The alarms were obtained at the same time as when the system reported a lack of process identification numbers. The mean time between false alarms was 433 mins.

Summary of Experiments

Thus far the agent has been successful in identifying four different types of faults, file server failures, network access problems, runaway processes and a protocol implementation error. The agent detected/predicted 8/9 file server failures on the campus network and 15 file server failures on the enterprise network. It also detected/predicted 8 instances of network access problems, 1 protocol implementation error and 1 instance of runaway process on the enterprise network. In all these cases the effects of the faults were observed in the chosen traffic-related MIB variables. Also, the changes associated with these fault events occurred in a correlated fashion, thus resulting in their detection by the agent.

Performance of the Intelligent Agent and Composite Results

The performance of an online detection/prediction scheme is measured in terms of the mean time between false alarms, and the mean prediction time. Here, these metrics are described and are tabulated for the intelligent agent. The complexity for the algorithm is provided along with an implementation flow chart. Composite results obtained for the different types of faults predicted/detected both on the campus and the enterprise network are provided. A discussion on the limitations of this approach and the occurrence of false alarms is included.

Performance Measures for the Agent

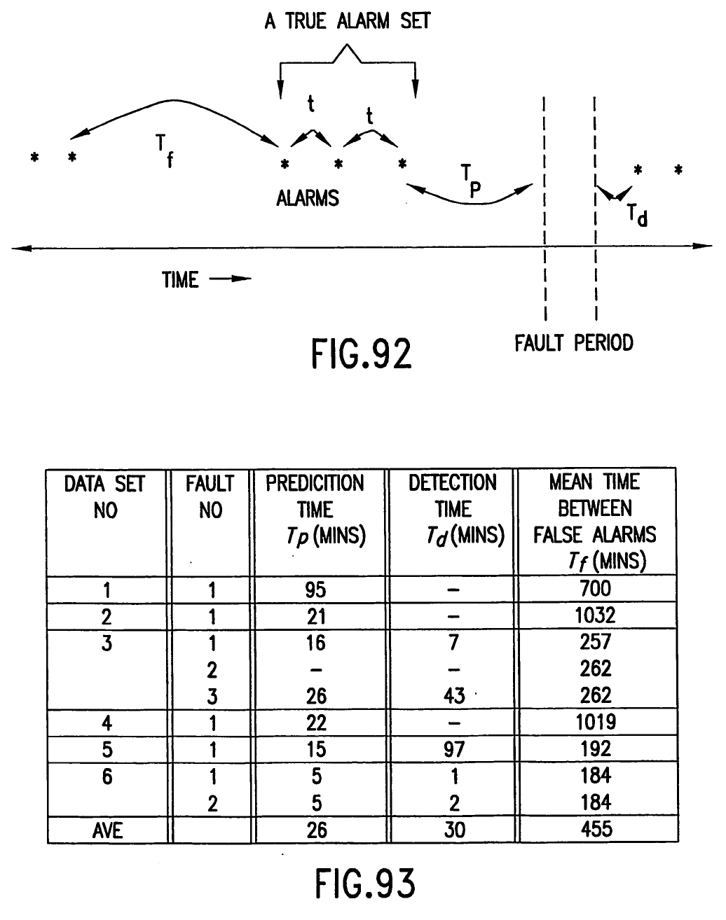

The performance of the algorithm is expressed in terms of the prediction time Tₚ, and the mean time false alarms T_{f}. Prediction time is the time to the fault from the nearest alarm proceeding it. A true fault prediction is identified by a fault declaration which is correlated with an accurate fault label from an independent source such as syslog messages and/or trouble tickets. Therefore, fault prediction implies two situations; (a) in the case of predictable faults such as file server failures and network access problems, true prediction is possible by observing the abnormalities in the MIB data and, (b) in the case of unpredictable faults such as protocol implementation errors, early detection is possible as compared to the existing mechanisms such as syslog messages and trouble reports. Any fault declaration which did not coincide with a label was declared a false alarm. The quantities used in studying the performance of the agent are depicted in FIG. 92. τ is the number of lags used to incorporate the persistence criteria in order to declare alarms corresponding to fault situations. In some cases alarms are obtained only after the fault has occurred. In these instances, we only detect the problem. The time for the detection T_{d} is measured as the time elapsed between the occurrence of the fault and the declaration of the alarm. There are some instances where alarms were obtained both preceding and after the fault. The alarms that follow the fault in these cases are attributed to the hysteresis effect of the fault.

The mean time between false alarms provided an indication of the performance of the algorithm. For a router in the campus network the average number of alarms obtained was 1 alarm per 24 hrs and in the enterprise network there were 4 alarms per 24 hrs. The average prediction time for both the campus and the enterprise network was 26 mins.

Composite Results and the Capability of the Agent

Campus Network Data

The only type of failure observed in this network were file server failures.

File Server Failures

The composite results for the alarms obtained from the internal router in the case of file server failures are complied in FIG. 93. The average prediction time with a persistence criteria of r=3 was 26 mins which is much less than half the mean time between false alarms, 455 mins (approx. 7.5 hrs). The time scale of prediction is large enough to allow time for potential corrective measures. Eight out of nine faults are predicted.

In data set 3, fault was reported by only two machines on the same subnet on which the faulty file server was located. This suggests that for this fault there was minimal impact on the ip level traffic. Furthermore, the fault occurred in the early morning hours (1.23 am-1:25 am). All these reasons contributed to the fault not being predicted. However, for this fault case, an alarm approximately 93 mins prior to fault was observed. This could very well be due to the increase in traffic caused by the daily backup on the system which occurs around midnight. Therefore, it is concluded that in this case where the fault was localized within the subnet and did not affect the router variables. Both faults in subnet 3 were predicted since they affected the router variables. This is corroborated by the fact that machines on both subnet 2 and subnet 4 reported the fault.

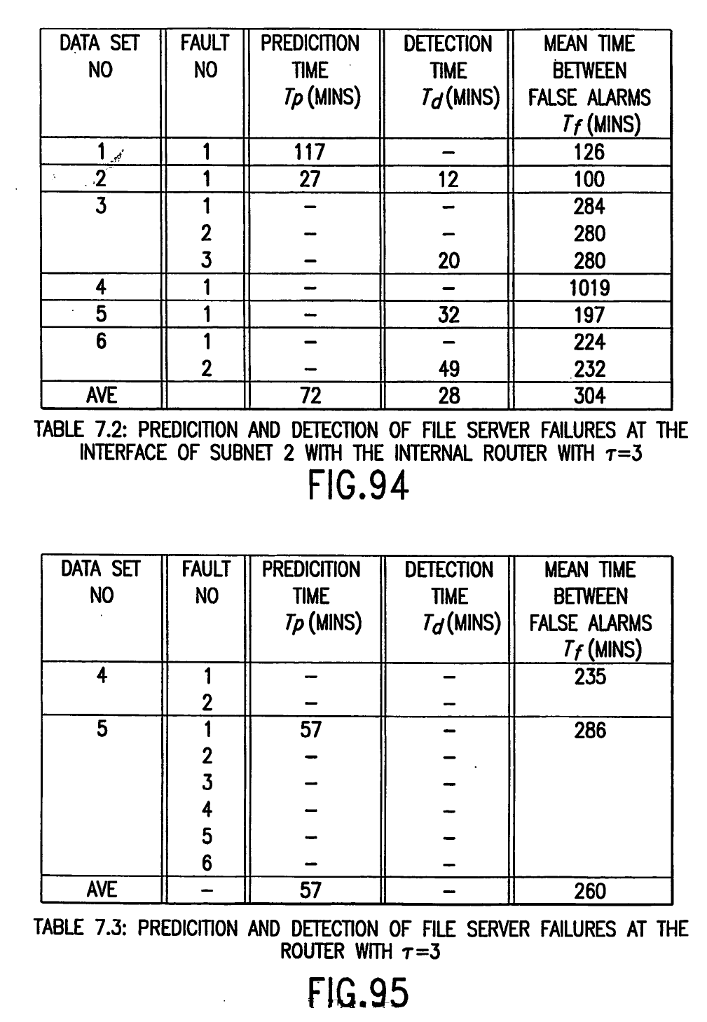

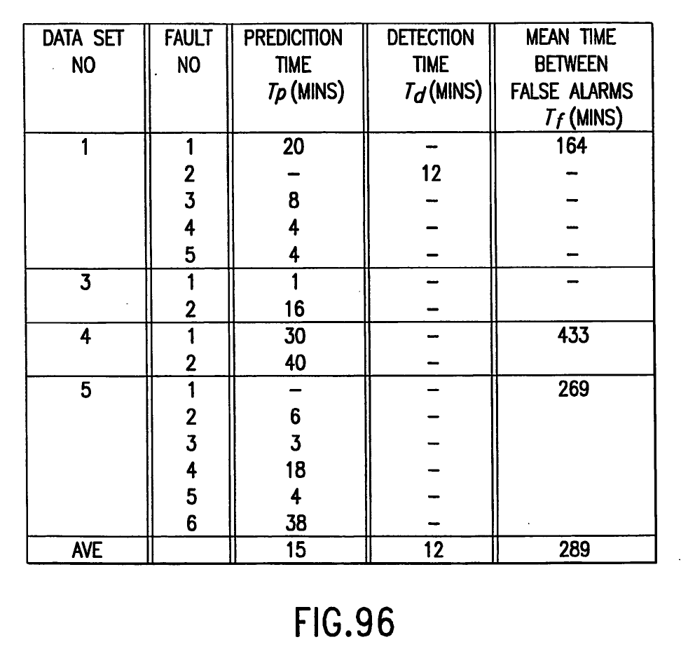

The results for the ifagent in the case of file server failures on the campus network are tabulated in FIG. 94. The if agent did not perform as well as the ip agent. This is due to the bursty nature of both the iflevel variables. The mean prediction time Tₚ was 72 mins and the mean detection time was 28 mins. The mean time between false alarms was 304 mins (approx. 5 hrs.). Only 2 out of the nine faults were predicted. Three others were detected. Fault 2 in data set 3 could not have been predicted or detected since only 2 machines on the same subnet as the faulty server reported the problem. Thus, the fault could not have affected the Ifof the ip variables. Despite the lack of information from the if variables of subnet 3 (data set 6) the system algorithm was able to detect one of the two faults on the subnet. Therefore having data from all interfaces will improve prediction.

The system algorithm was capable of detecting faults that occurred at different times of the day. Regardless of the number of machines that are affected outside the subnet, the agent is able to predict the problem as long as there is sufficient traffic that affects the network layer (ip) and the interface if level variables.

Enterprise Network Data

On the enterprise network, three different types of faults were encountered. One accept protocol implementation error on a super server, one runaway process and 15 file server failures.

File Server Failures

The composite results for the detection of file server failures obtained at the router level on the enterprise network are tabulated in FIG. 95. Note that unlike the campus network majority of the file server failure were not detected at the router. The inability of the router level traffic to detect simple file server failures is attributed to the presence of switched that contain the traffic within a particular subnet. Only when the failure affects machines outside the subnet under consideration will be detected by the router level indicators. The detection results obtained at the interface level have been tabulated in FIG. 95. It is observed that almost all the file server failures were predicted at the interface level. The traffic at the interface level provided indicators related to faults local to a given subnet. Thus, having traffic data from multiple interfaces will help to isolate the problem to a subnet level.

Network Access Problems

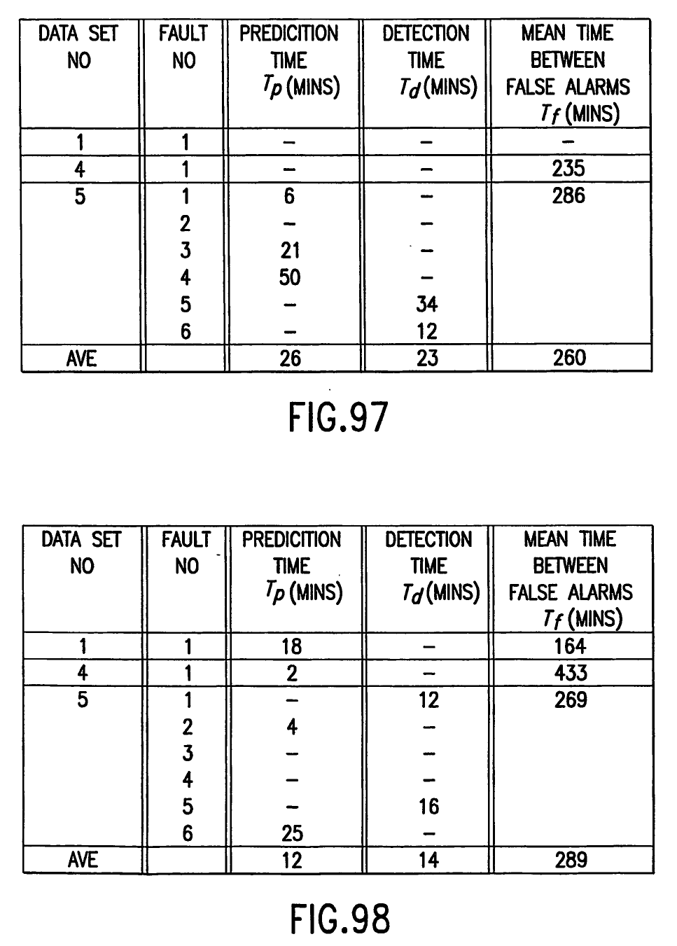

The alarms obtained under this category of network problems are indicative of performance problems. The abnormality indicator obtained in this scenario can also be interpreted as a QoS measure for the network in the absence of drastic network failures. The detection results for network access failures are tabulated in FIG. 97. The detection results at the interface level are shown in FIG. 98. It was found that both the router level and subnet level indicators were capable of detecting network access problems. In some cases, only one of the indicators was capable of indicating the existence of a problem. This example also suggests the need to have both the router and subnet level information for comprehensive management.

Protocol Implementation Error

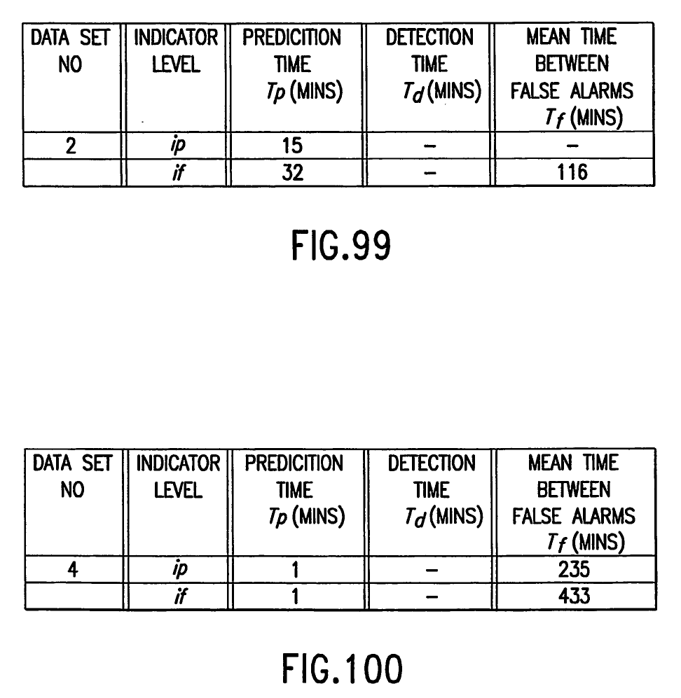

There was only one protocol implementation error that was observed and the results obtained for both the router and the subnet are provided in FIG. 99. This type of failure can in general be considered as a software implementation error.

Runaway Process

One occurrence of a runaway process was also detected by the agent and the results are tabulated in FIG. 100. The detection obtained at the subnet level coincided with label of the fault as can be seen in the Figures of case study 3.

Flow Chart for the Implementation of the Algorithm

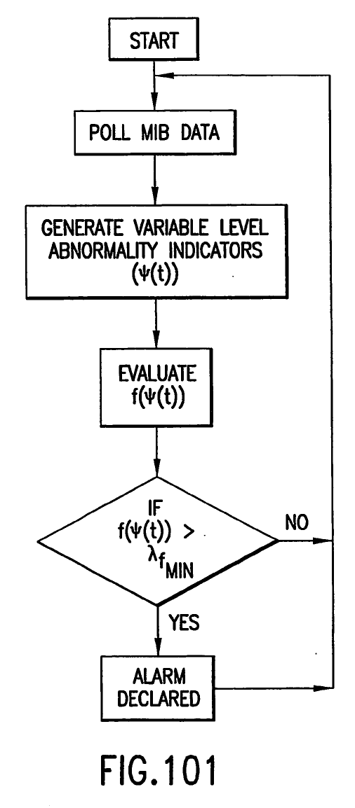

As shown in FIG. 101, a flow chart to describe the algorithm used to obtain the average abnormality indicator by both the if and the ip agent is provided. The process starts at step S1. Next, at step S2, the MIB data is polled. Then, at step S3, the variable level abnormality indicators arc generated. These indicators are next evaluated at step S4. If the alarms thus obtained satisfy the persistence criteria at step S5, then a fault situation is declared at step S6. If not, then the process starts over again at step S2.

Complexity of the Agent Algorithm

The detection scheme for the agent is based on a linear model, rendering it feasible for online implementation. The complexity of the detection scheme as a function of the number of model parameters is O(M), where M is the number of input MIB variables. The four model parameters for each MIB variable are the mean and variance for the residual signals, the learning window and the test window sizes. The order of complexity increase linearly, and thus the method is scalable to a large number of nodes. For a given router with K interfaces the ip level agent requires 12 model parameters and the if level agent requires 8 parameters per interface. Thus, making the total number of model parameters for the router 8K+12. Therefore, the agent is of sufficiently low order of complexity to enable its implementation on wide area routers.

A Discussion on False Alarms

Not all false alarms encountered in the present system can be positively identified as false alarms due to the inadequate methods available to confirm fault situations. The two labeling schemes used to confirm alarms as correlated with fault events are the syslog messages and the trouble tickets. Syslog messages are only sent in response to a particular fault situation such as when a user or a process accesses a faulty server. In the event when there are no users accessing the system there are no relevant syslog messages sent, and for this reason the fault situation may not be observed in the syslog messages. So, although a fault situation may exist, and the system algorithm is detecting this situation, since no corroborating syslog messages exist, the veracity of the alarm cannot be determined. Alarms of this kind are counted as false. The trouble tickets are emails that are sent by users on the network in response to some difficulty encountered on the network. These messages suffer from the lack of accuracy in the problem report and are reactive. The inaccuracy causes certain predictive alarms to be declared as false. Reactive implies that the alarms were received in response to an already existing fault situation.

There are several known sources that give rise to false alarms that are system specific. Such false alarms can be avoided by fine tuning the algorithm to a specific network. One such common false alarm is system backup which occurs at a set time for a given network. For example in the campus network, at system backup time, a large change is generated abruptly in a correlated fashion at the subnet level. This results in a detection by the agent although no fault exist. This problem can be alleviated if the system backup time is known. Once a network fault occurs the network required time to return to normal functioning. This period is also detected as correlated change points, although they do not necessarily correspond to a fault. Alarms that are generated at these time can be avoided by allowing a renewal time immediately after a fault has been detected. Thus the addition of hystersis will help reduce the false alarms. It was observed that at the if layer the false alarm rate of the agent is much higher than at the ip layer. This has been attributed to the burstiness in both the if level variables. Increasing the order of the AR model may help in reducing the false alarm rate but there is a trade off in detection time that needs to be contended with. Preliminary results indicate a lower false alarm rate for the enterprise network over the campus network.

Summary

Hence, the present invention provides an online network fault detection algorithm. This was achieved by designing an intelligent agent. Network faults can be modeled as correlated transient changes in the traffic-related MIB variables. This model is independent of specific fault descriptions. The network model was elucidated from a few of the known file server faults observed on one network. The model was found to fit several other file server failures on the same network and also on a completely different network. The model was also found to be good in the case of protocol implementation errors. By characterizing network fault behavior as transient short lived signals, the requirement of accurate traffic models for normal network behavior was circumvented.

The fault model developed also provides a first step towards the characterization and classification of network faults based on their statistical properties. Since network faults are modeled as correlated transient abrupt changes, the type of abrupt changes is used to distinguish between the different classes of network faults. For example, as shown in FIG. 102, the fault space 400 can be roughly divided into traffic-related faults 23 and faults related to protocol implementation errors 21. Within these larger groups based on the type of abrupt change, the class of AR detectable faults 25 is provided. By this we mean that the abrupt changes can be described by the AR model. Furthermore, based on the order of AR required to detect the abrupt changes the class of AR order 1 (AR(1)) 27 is provided. Using this classification scheme, it is possible to develop very specific tools to deal with a large class of faults. For example, some faults may only be captured using higher orders of AR while others may require a small order. In each of these cases the polling frequency or the rate of acquisition of data may differ based on the constraint of having sufficient number of sample to obtain accurate estimate of the AR parameters. Thus, optionally polling the MIBs will help reduce the total bandwidth required to do fault management.

In the case of traffic-related faults, that can be detected at a router, just three variable were required (ipIR, ipIDe, IPOR). To obtain a finer resolution upto the subnet level required two more variables per interface (ifIO, ifOO). This choice of variables greatly reduces the dimensionality of the problem without significant compromise in the resolution of network faults.

Based on the network fault model proposed, a fault detection scheme is designed. The detection algorithm was developed with the vision to implement it in a distributed framework. This allows the implementation to be scalable for large networks. The algorithm is implemented in an online fashion to enable the real-time mechanisms such as balancing or flow control. Since the trend in abnormality of the network is captured by the agent it allows for confirming the existence of faulty conditions before recovery is undertaken. Furthermore, the prediction time scale is in the order of minutes and is sufficient time to perform any further verification before deciding on the course of recovery to be implemented.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. Accordingly, the invention is not limited by the foregoing description or drawings, but is only limited by the scope of the appended claims. What is claimed as new and desired to be protected by Letters Patent of the United States is:

1. A method for predictive fault detection in network traffic, comprising the steps of:
choosing a set of Management Information Base (MIB) variables related to said fault detection;
sensing a change point observed in each said MIB variable in said network traffic;
generating a variable level alarm corresponding to said change point; and
combining said variable level alarm to produce a node level alarm.

2. The method of claim 1 wherein said MIB variables are interfaces (if) and Internal Protocols (ip).

3. The method of claim 2 wherein said interfaces (if) further comprise variables ifIO (In Octets) and ifOO.

4. The method of claim 2 wherein said Internal Protocol (ip) further comprise variables ipIR (In Receives), ipIDE (In Delivers) and ipOR (Out Requests).

5. The method of claim 1 wherein said generating step further comprise the step of linearly modeling said MIB variables using a first order auto-regressive (AR) process to generate said variable level alarm.

6. The method of claim 5 further comprising the step of performing a sequential hypothesis test utilizing a Generalized Likelihood Ratio (GLR) on said linear model to generate said variable alarm.

7. The method of claim 1 wherein said combining step further comprise the step of correlating spatial and temporal information from said MIB variables.

8. The method of claim 7 wherein said step of correlating is performed utilizing a linear operator.

9. The method of claim 1 wherein said fault detection is applied as the definition of Quality of Service (QoS).

10. The method of claim 1 wherein said MIB variables are maintained by an Simple Network Management Protocol (SNMP).

11. The method of claim 1 wherein said network is a local area network.

12. The method of claim 1 wherein said network is a local area network.

13. The method of claim 1 wherein said fault comprise predictable and non-predictable faults.

14. A method for predictive fault detection in a network, comprising the steps of:
generating variable level alarms corresponding to abrupt changes observed in each selected MIB variable; and
correlating spatial and temporal information from said MIB variables utilizing a linear operator to produce a node level alarm.

15. The method of claim 14 wherein said MIB variables are interfaces (if and Internal Protocols (ip).

16. The method of claim 15 wherein said interfaces (if) further comprise variables ifIO (In Octets) and ifOO.

17. The method of claim 15 wherein said Internal Protocol (i) further comprise variables ipIR (In Receives), ipIDE (In Delivers) and ipOR (Out Requests).

18. The method of claim 14 wherein said step of generating further comprise the step of linearly modeling said MIB variables using a first order auto-regressive (AR) process to generate said variable level alarm.

19. The method of claim 18 further comprising the step of performing a sequential hypothesis test utilizing a Generalized Likelihood Ratio (GLR) on said linear model to generate said variable alarm.

20. The method of claim 14 wherein said fault detection is applied in the definition of Quality of Service (QoS).

21. The method of claim 14 wherein said MIB variables are maintained by an Simple Network Management Protocol (SNMP).

22. The method of claim 14 wherein said network is a local area network.

23. The method of claim 14 wherein said network is a local area network.

24. The method of claim 14 wherein said fault comprise predictable and non-predictable faults.

25. A method for predictive fault detection in a network, comprising the steps of:
sensing network traffic and generating variable level alarms corresponding to changes in said traffic; and
correlating spatial and temporal information from MIB variables related to said fault detection utilizing a linear operator to produce a node level alarm.

26. The method of claim 25 wherein said MIB variables are interfaces (if) and Internal Protocols (ip).

27. The method of claim 26 wherein said interfaces (if) further comprise variables ipIO (In Octets) and ifOO.

28. The method of claim 26 wherein said Internal Protocol (ip) further comprise variables ipIR (In Receives), ipIDE (In Delivers) and ipOR (Out Requests).

29. The method of claim 25 wherein said step of generating further comprise the step of linearly modeling said MIB variables using a first order auto-regressive (AR) process to generate said variable level alarm.

30. The method of claim 29 further comprising the step of performing a sequential hypothesis test utilizing a Generalized Likelihood Ratio (GLR) on said linear model to generate said variable alarm.

31. The method of claim 25 wherein said fault detection is applied in the definition of Quality of Service (QoS).

32. The method of claim 25 wherein said MIB variables are maintained by an Simple Network Management Protocol (SNMP).

33. The method of claim 25 wherein said network is a local area network.

34. The method of claim 25 wherein said network is a local area network.

35. The method of claim 25 wherein said fault comprise predictable and non-predictable faults.

36. A system for detecting fault in a network traffic, comprising:
a data processing unit for choosing a set of Management Information Base (MIB) variables related to said fault detection;
a sensor for sensing a change point observed in each said MIB variable in said network traffic and generating a variable level alarm corresponding to said change point; and
a fusion center for combining said variable level alarm to produce a node level alarm.

37. The system of claim 36 wherein said MIB variables are interfaces (if) and Internal Protocols (ip).

38. The system of claim 37 wherein said interfaces (if) further comprise variables ifIO (In Octets) and ifOO.

39. The system of claim 37 wherein said Internal Protocol (ip) further comprise variables ipIR (In Receives), ipIDE (In Delivers) and ipOR (Out Requests).

40. The system of claim 36 wherein said sensor linearly models said MIB variables using a first order auto-regressive (AR) process to generate said variable level alarm.

41. The system of claim 40 wherein said sensor performs a sequential hypothesis test utilizing a Generalized Likelihood Ratio (GLR) on said linear model to generate said variable alarm.

42. The system of claim 36 wherein said fusion center correlates spatial and temporal information from said MIB variables.

43. The system of claim 42 wherein said correlating is performed utilizing a linear operator.

44. The system of claim 36 wherein said fault detection is applied in the definition of Quality of Service (QoS).

45. The system of claim 36 wherein said MIB variables are maintained by an Simple Network Management Protocol (SNMP).

46. The system of claim 36 wherein said network is a local area network.

47. The system of claim 36 wherein said network is a local area network.

48. The system of claim 36 wherein said fault comprise predictable and non-predictable faults.

49. A system for predictive fault detection in a network comprising:
at least one sensor for generating variable level alarms corresponding to a change observed in a selected MIB variable; and
a fusion center for correlating spatial and temporal information from said MIB variables utilizing a linear operator to produce a node level alarm.

50. The system of claim 49 wherein said MIB variables are interfaces (if) and Internal Protocols (ip).

51. The system of claim 50 wherein said interfaces (if) further comprise variables ifIO (In Octets) and ifOO.

52. The system of claim 50 wherein said Internal Protocol (i) further comprise variables ipIR (In Receives), ipIDE (In Delivers) and ipOR (Out Requests).

53. The system of claim 49 wherein said sensor linearly models said MIB variables using a first order auto-regressive (AR) process to generate said variable level alarm.

54. The system of claim 53 wherein said sensor performs a sequential hypothesis test utilizing a Generalized Likelihood Ratio (GLR) on said linear model to generate said variable alarm.

55. The system of claim 49 wherein said fault detection is applied in the definition of Quality of Service (QoS).

56. The system of claim 49 wherein said MIB variables are maintained by an Simple Network Management Protocol (SNMP).

57. The system of claim 49 wherein said network is a local area network.

58. The system of claim 49 wherein said network is a local area network.

59. The system of claim 49 wherein said fault comprise predictable and non-predictable faults.

60. A system for monitoring network traffic for predictive fault detection, comprising:
at least one sensor for generating a variable level alarm corresponding to a change in said traffic; and
a fusion center for correlating spatial and temporal information from MIB variables related to said fault detection utilizing a linear operator to produce a node level alarm.

61. The system of claim 60 wherein said MIB variables are interfaces (if) and Internal Protocols (ip).

62. The system of claim 61 wherein said interfaces (if) further comprise variables ifIO (In Octets) and ifOO.

63. The system of claim 61 wherein said Internal Protocol (ip) further comprise variables ipIR (In Receives), ipIDE (In Delivers) and ipOR (Out Requests).

64. The system of claim 60 wherein said sensor linearly models said MIB variables using a first order auto-regressive (AR) process to generate said variable level alarm.

65. The system of claim 64 wherein said sensor performs a sequential hypothesis test utilizing a Generalized Likelihood Ratio (GLR) on said linear model to generate said variable alarm.

66. The system of claim 60 wherein said fault detection is applied in the definition of Quality of Service (QoS).

67. The system of claim 60 wherein said MIB variables are maintained by an Simple Network Management Protocol (SNMP).

68. The system of claim 60 wherein said network is a local area network.

69. The system of claim 60 wherein said network is a local area network.

70. The system of claim 60 wherein said fault comprise predictable and non-predictable faults.
